(19) United States
(12) Patent Application Publication
(10) Pub. No.: US 2022/0332158 A1
(43) Pub. Date: Oct. 20, 2022

(54) AUTOMATED CONNECTION BETWEEN TOWING VEHICLE AND TRAILER

(71) Applicant: Electrans Technologies Ltd., Oakville (CA)

(72) Inventors: Brian LAYFIELD, Oakville (CA); Brian FAN, Oakville (CA); Andrew CONSTANTINESCU, Oakville (CA); Mitchell PHILLIPS, Oakville (CA); Anthony IGHOMUAYE, Oakville (CA); Abhinav DHAR, Oakville (CA); Kaiwen LIAO, Oakville (CA)

(21) Appl. No.: 17/724,101

(22) Filed: Apr. 19, 2022

Related U.S. Application Data
(60) Provisional application No. 63/176,642, filed on Apr. 19, 2021.
(60) Provisional application No. 63/179,258, filed on Apr. 24, 2021.
(60) Provisional application No. 63/271,576, filed on Oct. 25, 2021.

(51) Int. Cl. B60D 1/64; B60D 1/36

(52) U.S. Cl. CPC B60D 1/64; B60D 1/36

(57) ABSTRACT

Disclosed herein is a towing vehicle, comprising a towing vehicle-defined connection counterpart, and a fixture configured for releasably coupling with the towing vehicle-defined connection counterpart. The towing vehicle-defined connection counterpart is configured for connection to a trailer-defined connection counterpart of a trailer, the trailer further including a guide. While: (i) the towing vehicle-defined connection counterpart is coupled to the fixture, (ii) the towing vehicle-defined connection counterpart and the trailer-defined connection counterpart are misaligned, and (iii) the fixture is disposed in a guiding-effective relationship with the guide: an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart for establishing connection between the towing vehicle-defined connection counterpart and the trailer-defined connection counterpart

### FIELD

This disclosure relates generally to the road transportation industry. More specifically, the disclosure is directed at an automated connection between a towing vehicle and a trailer.

### BACKGROUND

To transport a trailer by a towing vehicle, pneumatic air and electrical connections between the towing vehicle and the trailer are to be established for the pneumatic air system and the electrical system of the trailer, for example, service brakes, parking brakes, the ABS brakes, and turn signals. Currently, establishment of such connections are done manually, wherein an operator of the towing vehicle exits the vehicle to connect the air and electrical lines from the towing vehicle to the trailer.

### SUMMARY

In one aspect there is provided a towing vehicle, comprising: a towing vehicle-defined connection counterpart; and a fixture configured for releasably coupling with the towing vehicle-defined connection counterpart; wherein: the towing vehicle-defined connection counterpart is configured for connection to a trailer-defined connection counterpart of a trailer, the trailer further including a guide; and the towing vehicle is configured to co-operate with trailer such that: while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide: an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

In another aspect, there is provided a trailer comprising: a guide; and a trailer-defined connection counterpart; wherein: the trailer-defined connection counterpart is configured for connection to a towing vehicle-defined connection counterpart of a towing vehicle, with effect that communication between the towing vehicle and the trailer is established for actuating a vehicular operation; the towing vehicle further includes: a fixture configured for releasably coupling with the towing vehicle-defined connection counterpart; the towing vehicle is configured to co-operate with trailer such that: the guide is configured for guiding displacement of the fixture relative to the frame; and while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide: an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

In another aspect, there is provided a kit for modifying a towing vehicle and a trailer, comprising: towing vehicle adaptor components including: a towing vehicle-defined connection counterpart; and a fixture configured for releasably coupling with the towing vehicle-defined connection counterpart; trailer adaptor components including: a trailer-defined connection counterpart; and a guide; wherein: while: (i) the towing vehicle adaptor components are installed within a towing vehicle, with effect that a modified towing vehicle is established, such that the modified towing vehicle includes the towing vehicle-defined connection counterpart and the fixture, and (ii) the trailer adaptor components are installed within a trailer with effect that a modified trailer is established, such that the modified trailer includes the trailer-defined connection counterpart and the guide: the towing vehicle-defined connection counterpart is connectible to the trailer-defined connection counterpart; and the modified towing vehicle and the modified trailer are configured to co-operate such that while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide: an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

In another aspect, there is provided a system comprising: a towing vehicle including: a towing vehicle-defined connection counterpart; and a fixture configured for releasably coupling with the towing vehicle-defined connection counterpart; a trailer including: a trailer-defined connection counterpart; and a guide; wherein: the towing vehicle-defined connection counterpart is connectible to the trailer-defined connection counterpart; and the towing vehicle and the trailer are configured to co-operate such that while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of connection between the towing vehicle-defined connection counterpart and the trailer-defined connection counterpart, and (iii) the fixture is disposed in a guiding-effective relationship with the guide: an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

Other aspects will be apparent from the description and drawings provided herein.

### BRIEF DESCRIPTION OF DRAWINGS

In the figures, which illustrate example embodiments,

FIG. 1 is a perspective view of a towing vehicle coupled to a trailer;

FIG. 1A is a perspective view of a first adapter counterpart of an adapter;

FIG. 1B is a perspective view of a second adapter counterpart of an adapter;

FIG. 10 is a perspective view of the first and second adapter counterparts of FIG. 1A and FIG. 1B;

FIG. 2 is a block diagram of an example embodiment of an apparatus for connecting a trailer communicator of a towing vehicle to a towing vehicle communicator of a trailer;

FIG. 3 is a perspective view of an embodiment of an apparatus for connecting a first adapter counterpart to a second adapter counterpart, with the first adapter counterpart coupled to an end effector of the apparatus, the apparatus in the retracted position;

FIG. 4 is a perspective view of the apparatus of FIG. 3, the apparatus displacing the first adapter counterpart towards the second adapter counterpart;

FIG. 5 is a perspective view of the apparatus of FIG. 3, the apparatus coupling the first adapter counterpart and the second adapter counterpart;

FIG. 6 is a perspective view of the apparatus of FIG. 3, the apparatus in the retracted position after coupling the first adapter counterpart and the second adapter counterpart;

FIG. 7 is a perspective view of an alternate embodiment of an apparatus for connecting a first adapter counterpart to a second adapter counterpart, with the first adapter counterpart coupled to an end effector of the apparatus, the apparatus in the retracted position;

FIG. 8 is a perspective view of the apparatus of FIG. 7, the apparatus coupling the first adapter counterpart and the second adapter counterpart;

FIG. 9 is a side view of the apparatus of FIG. 7, the apparatus in the retracted position after coupling the first adapter counterpart and the second adapter counterpart;

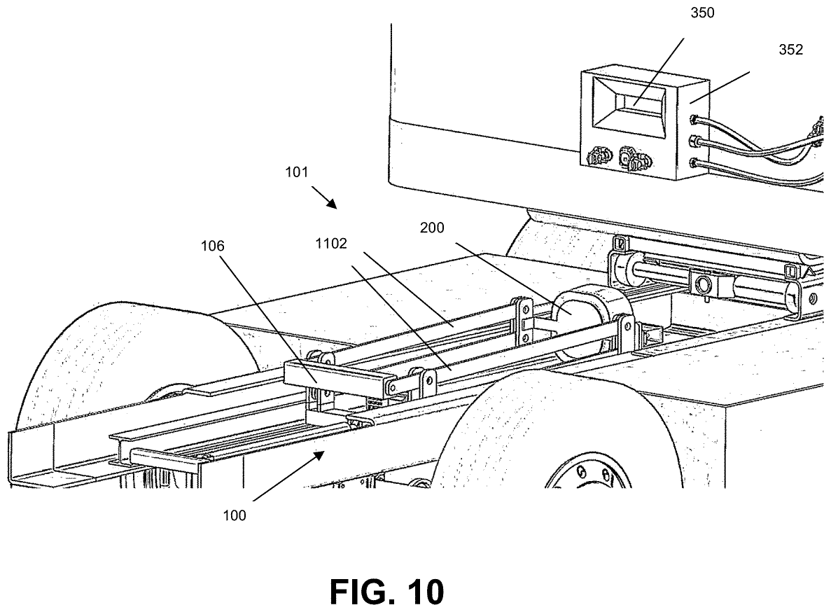

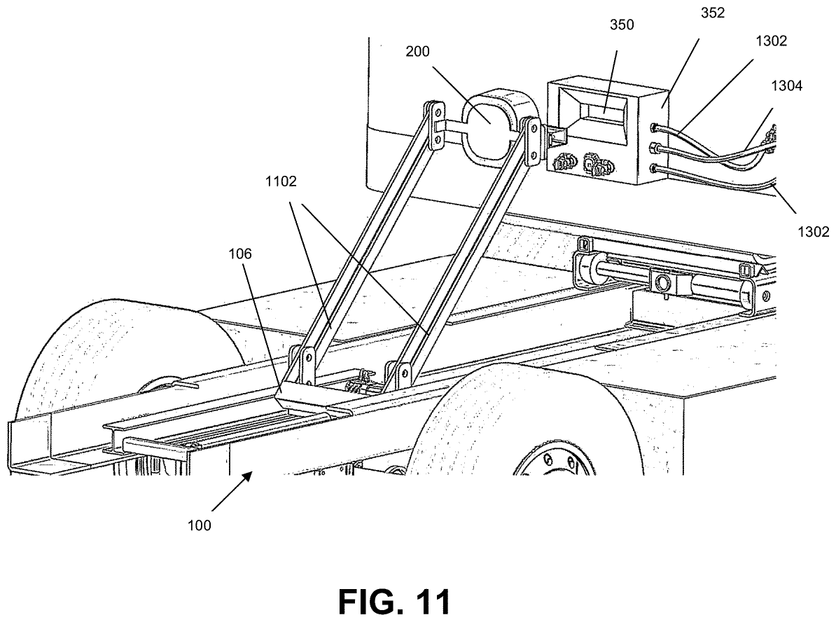

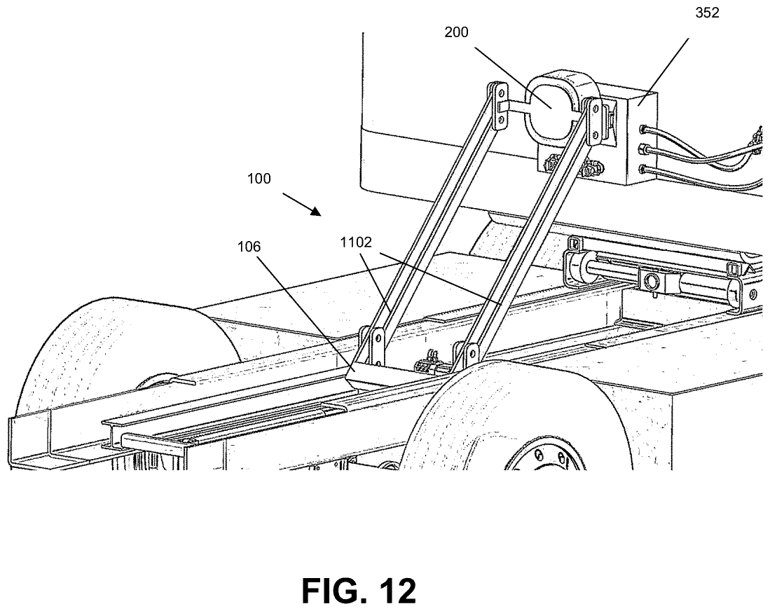

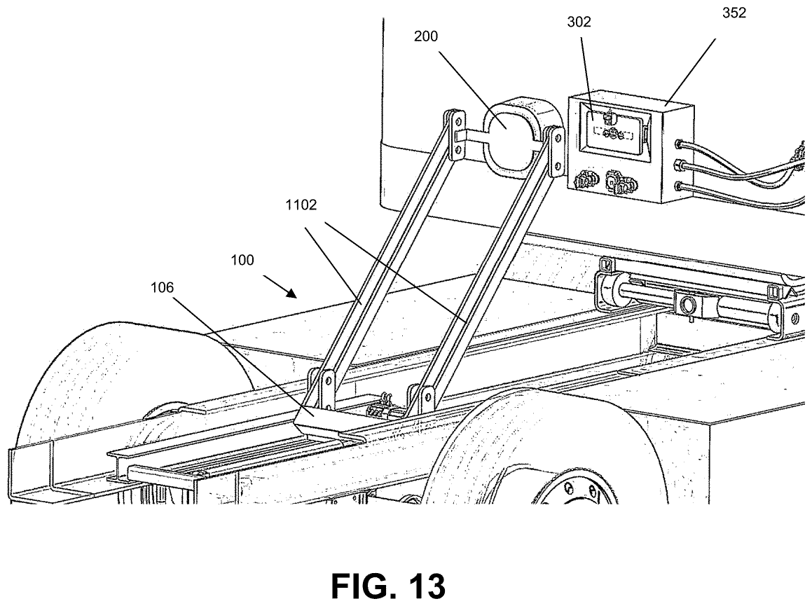

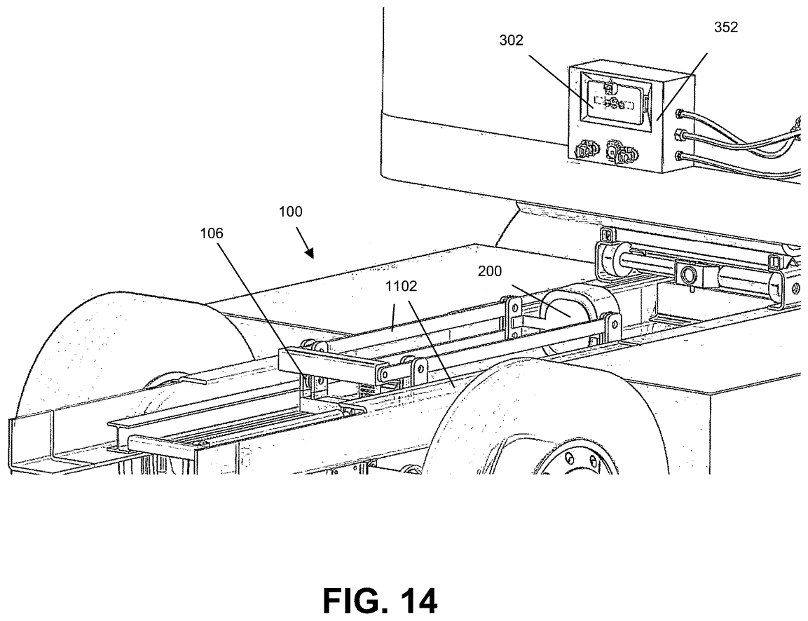

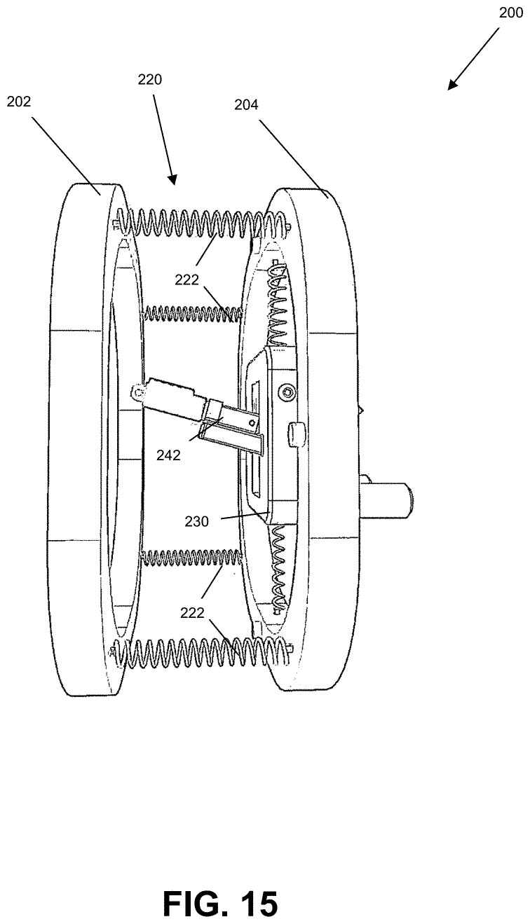

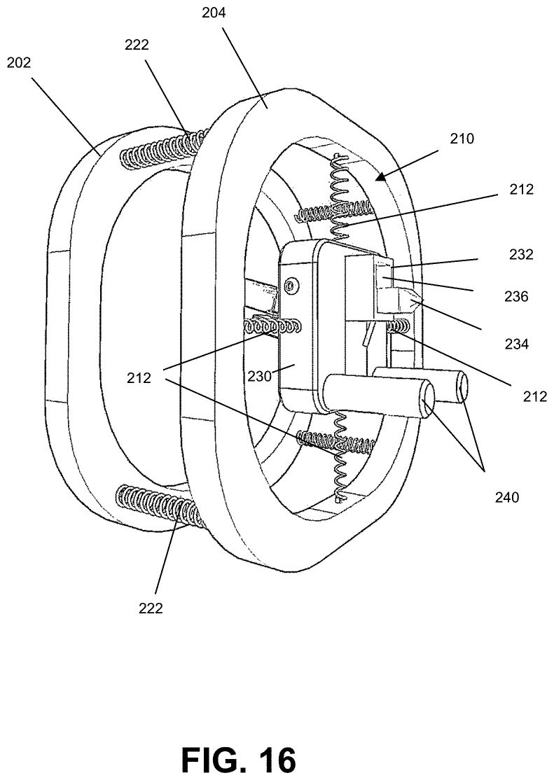

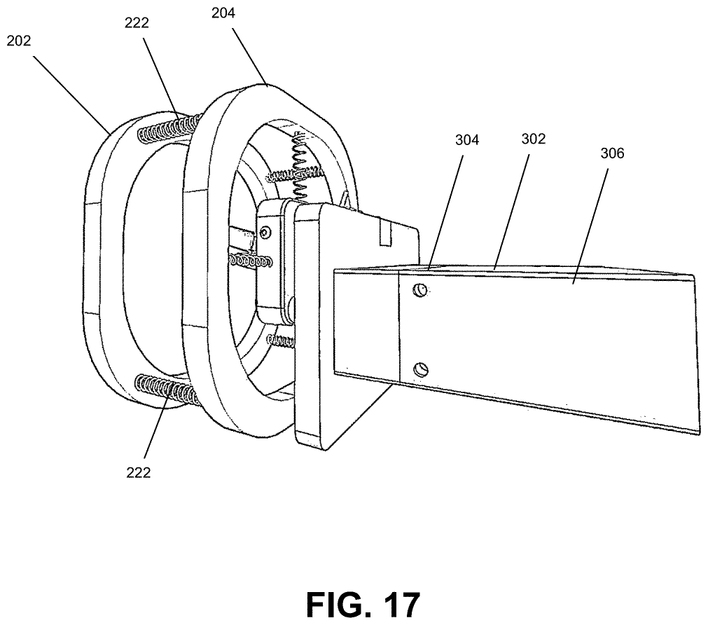

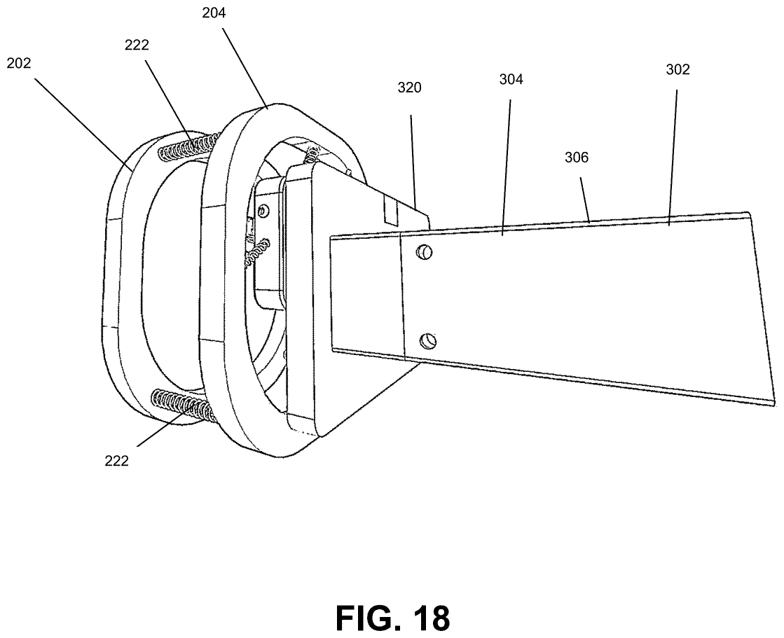

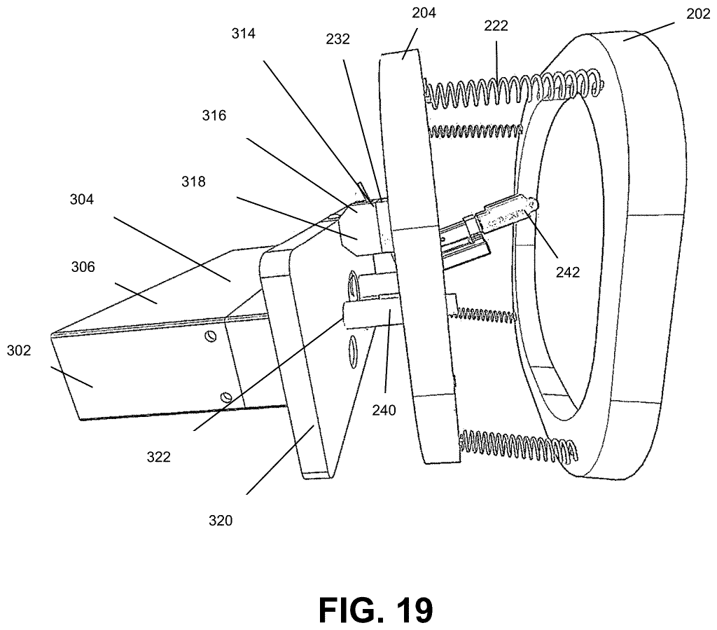

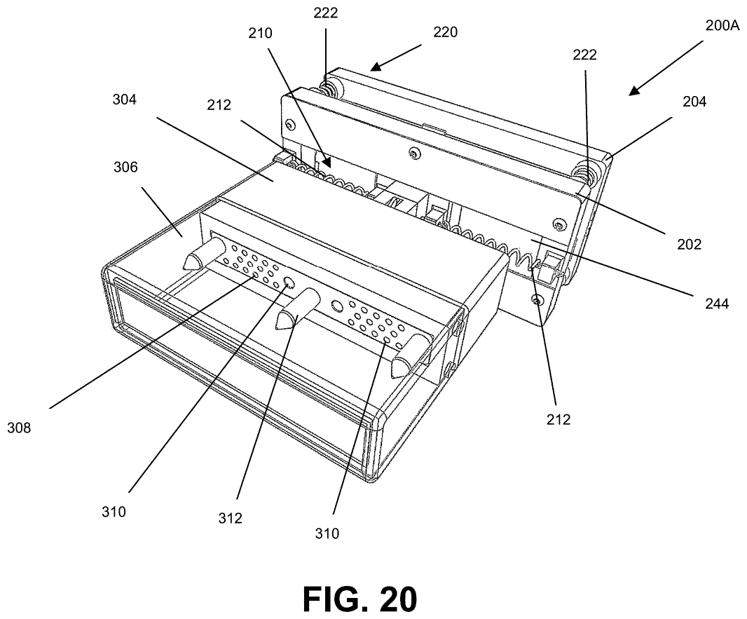

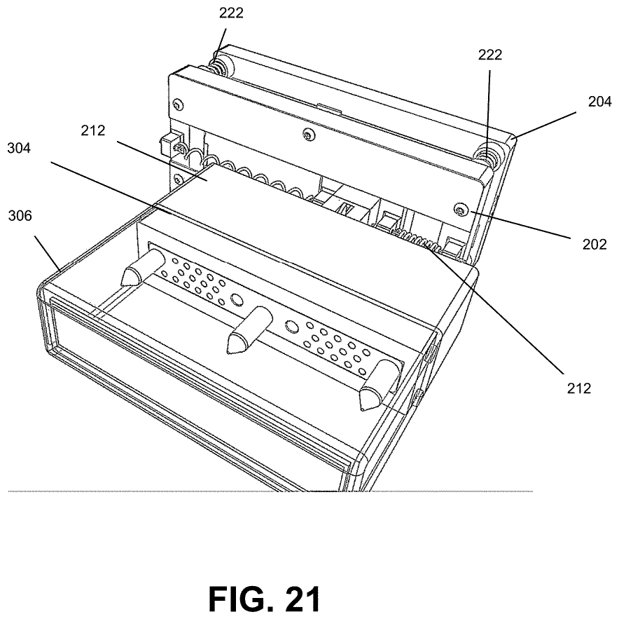

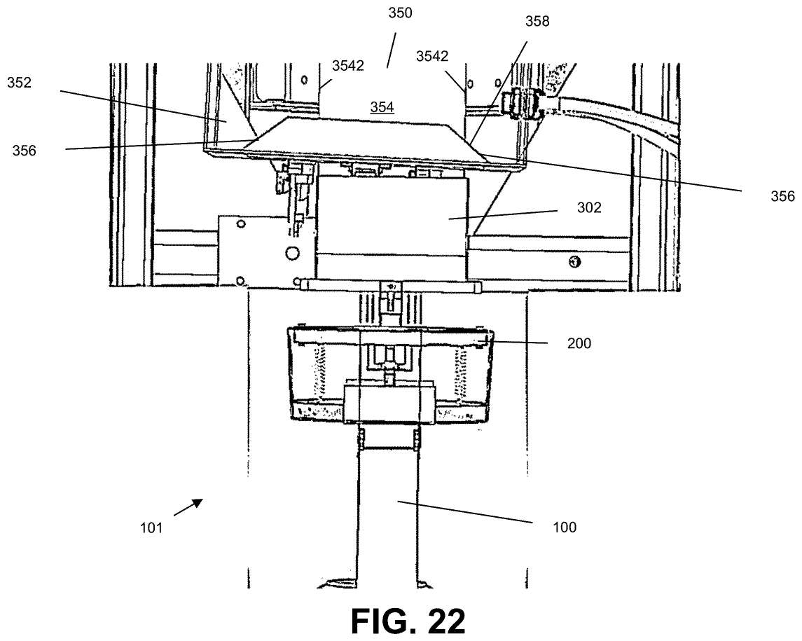

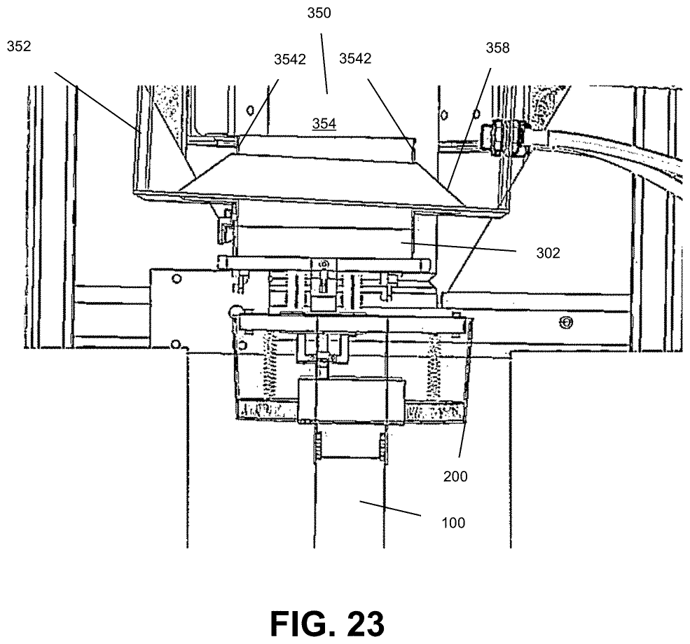

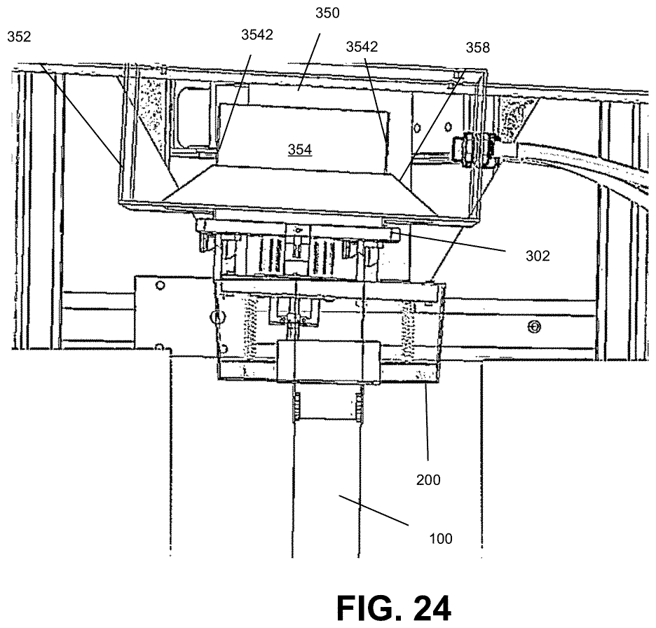

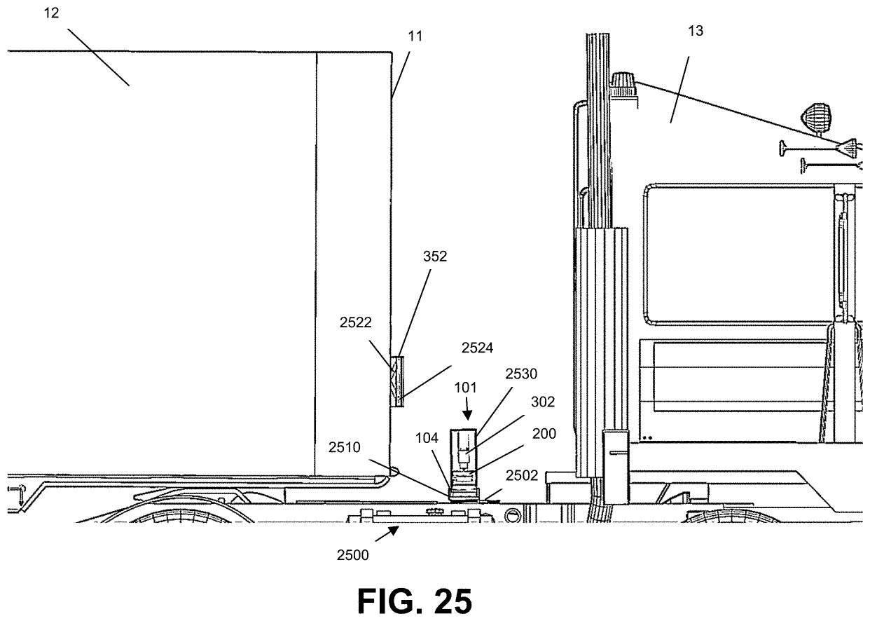

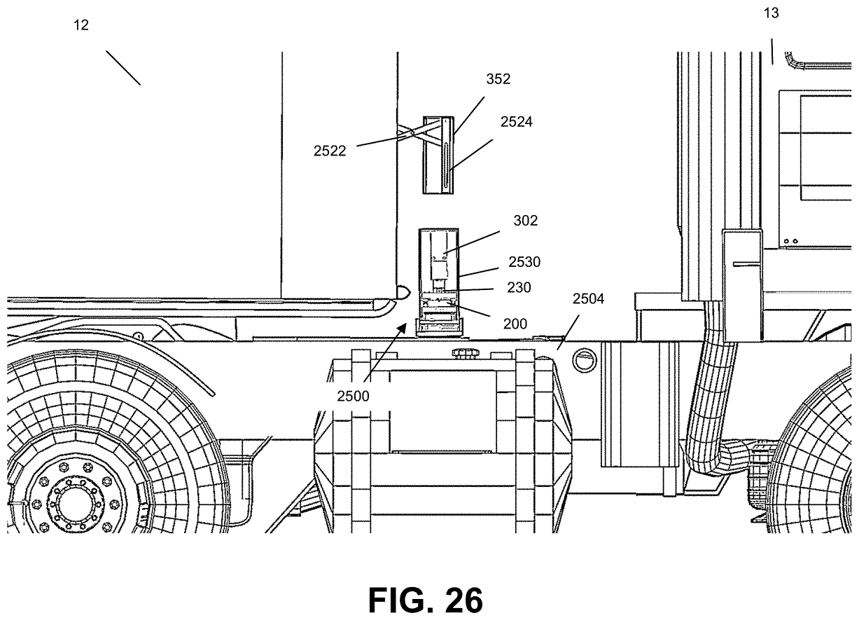

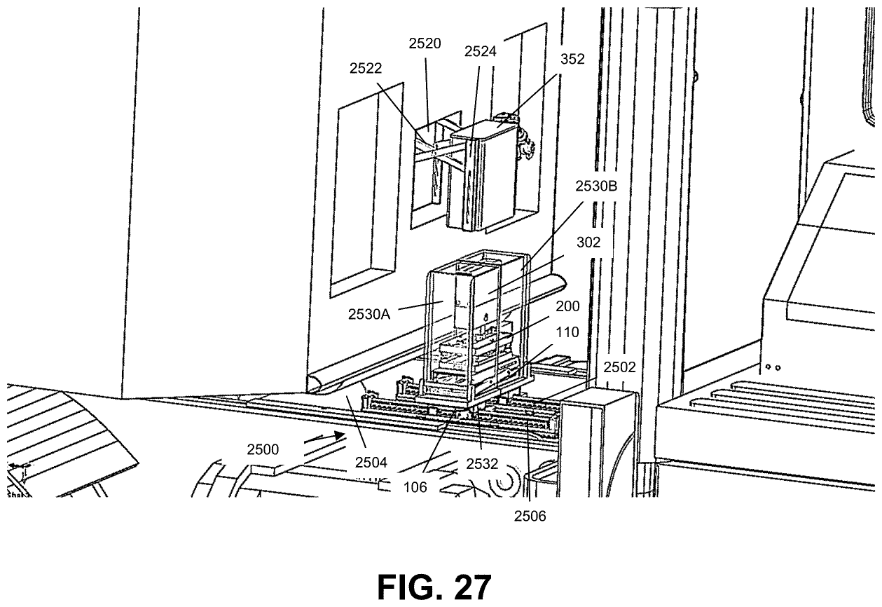

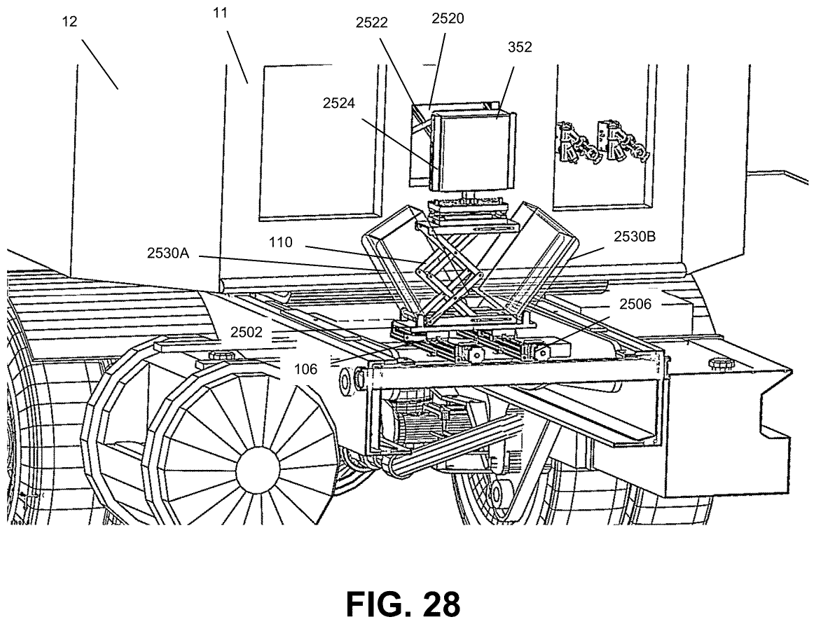

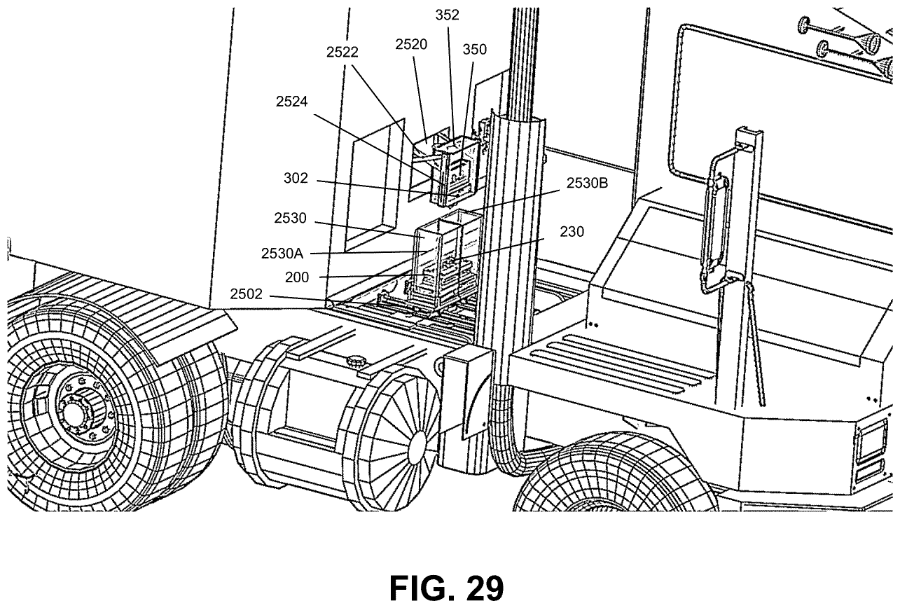

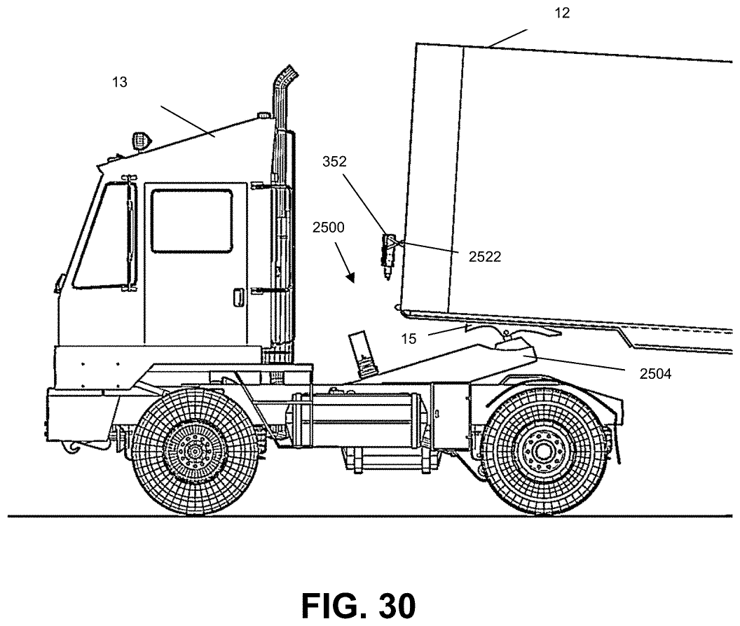

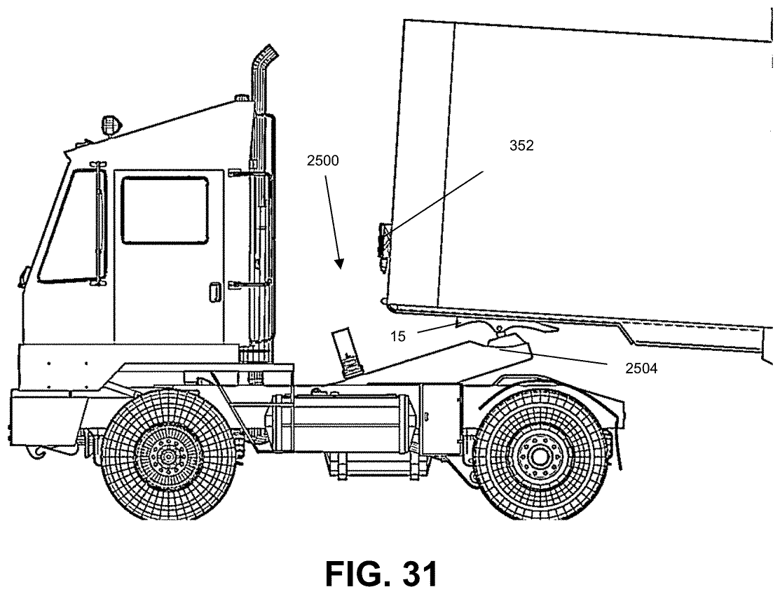

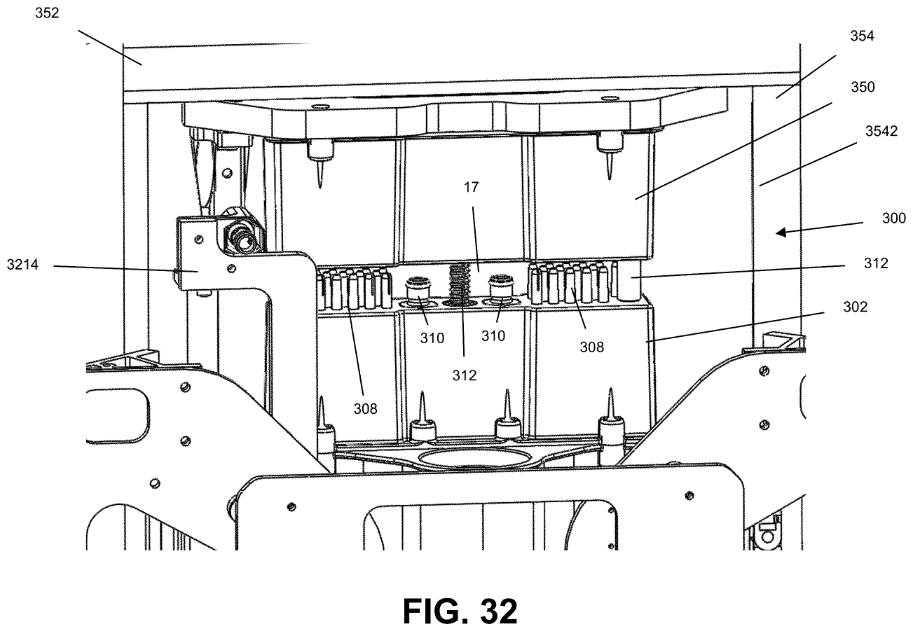

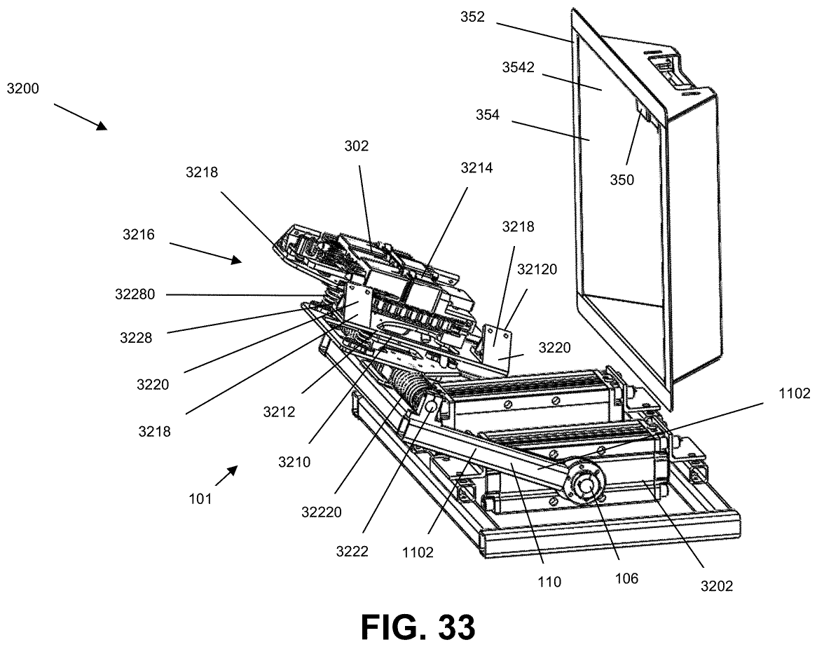

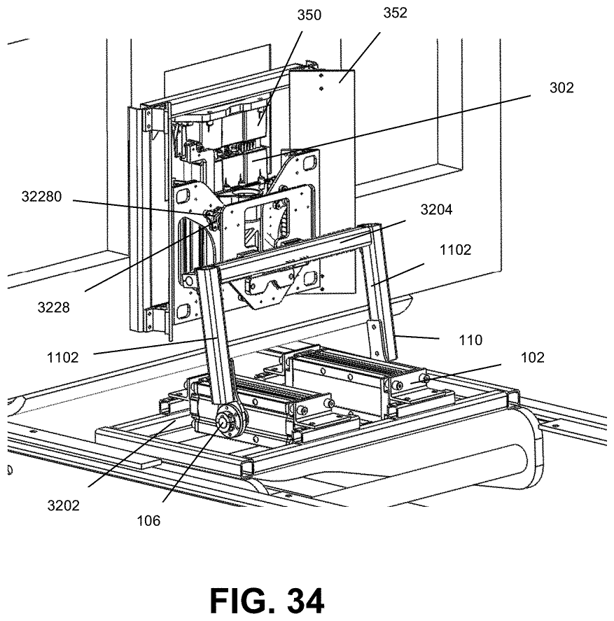

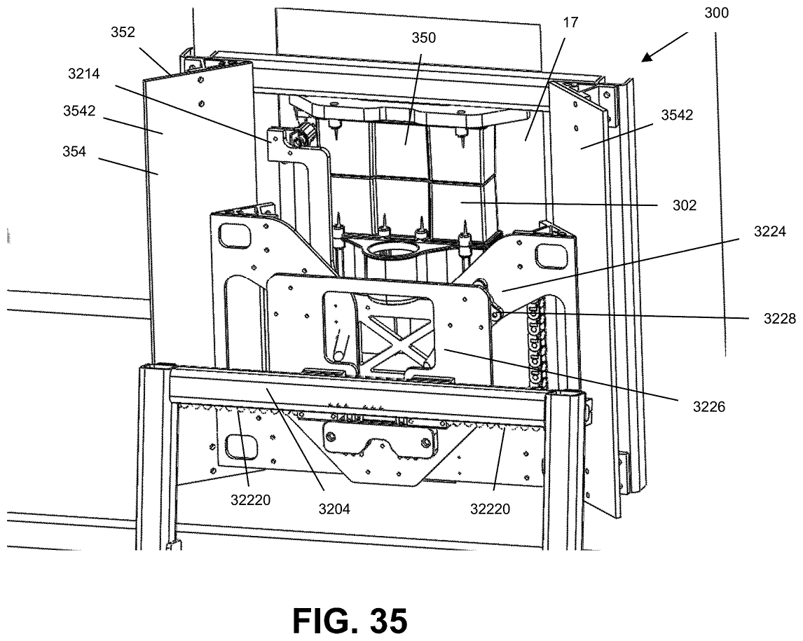

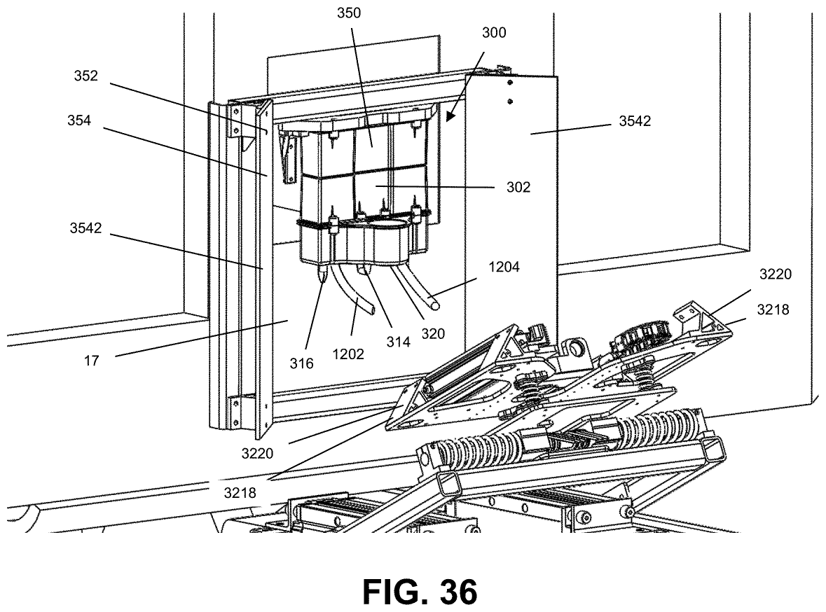

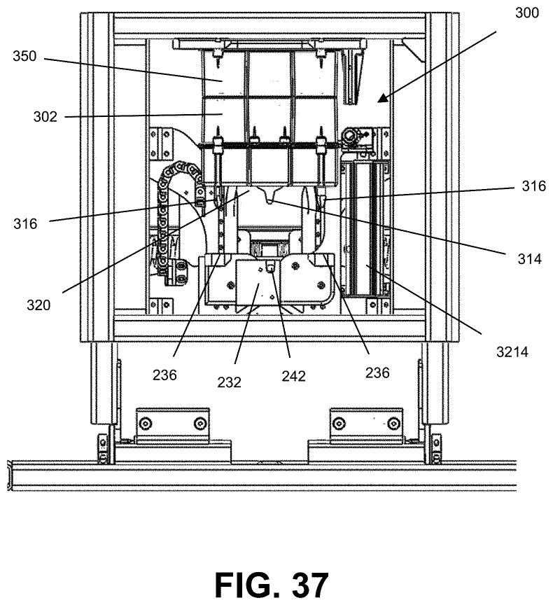

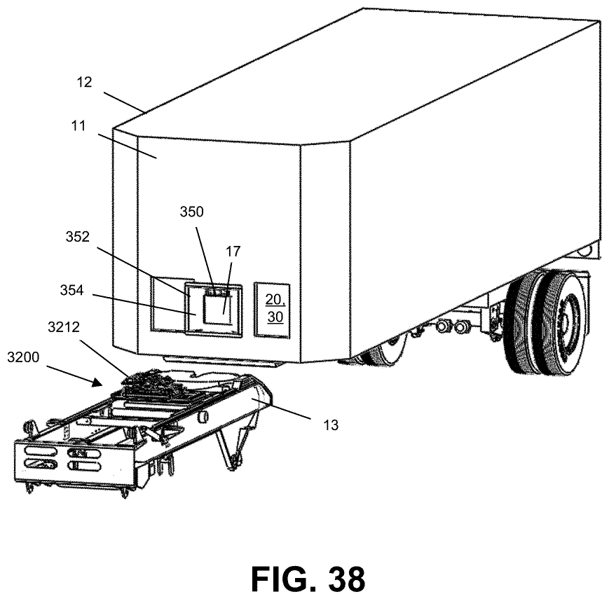

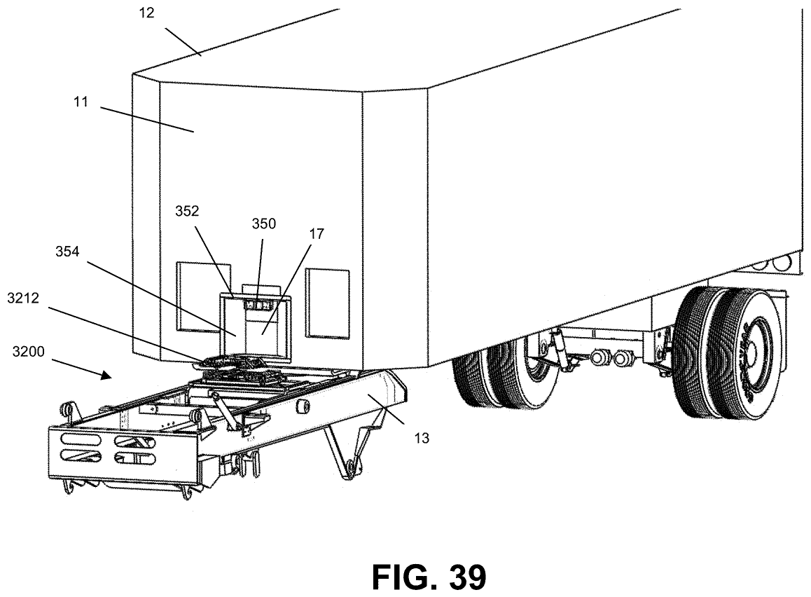

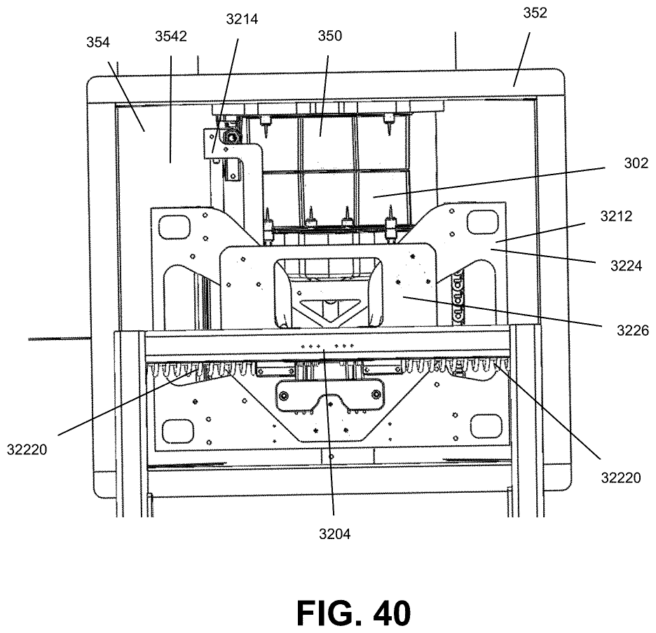

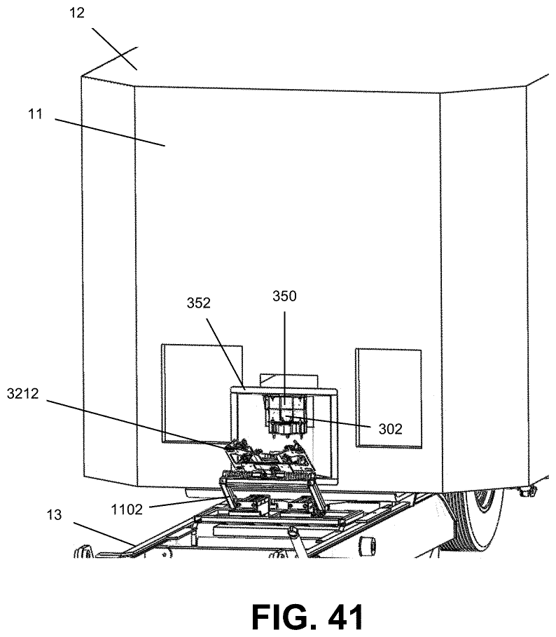

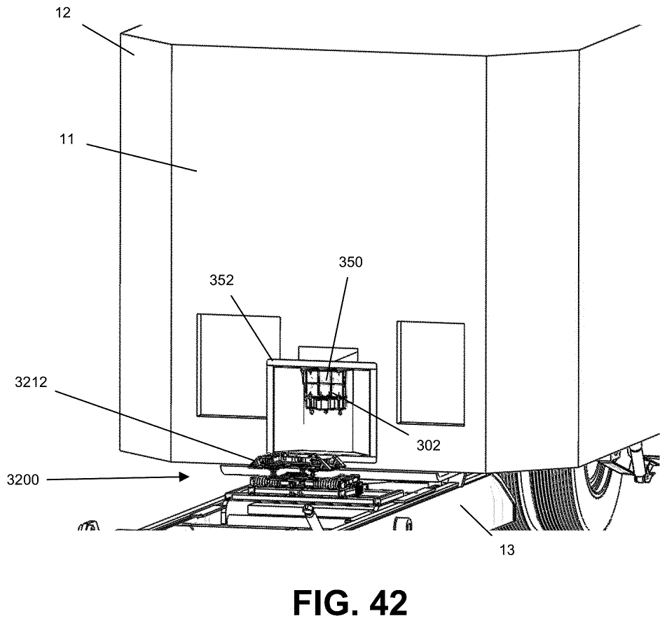

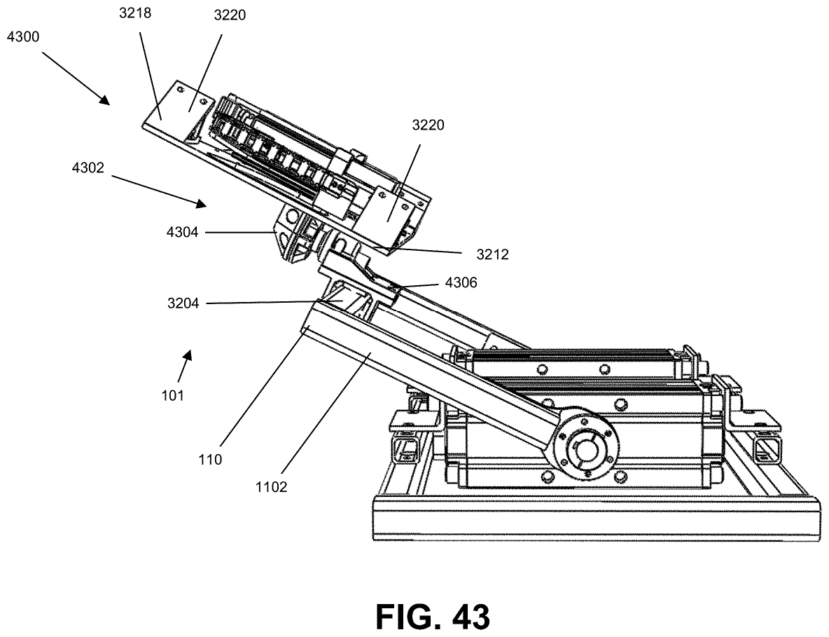

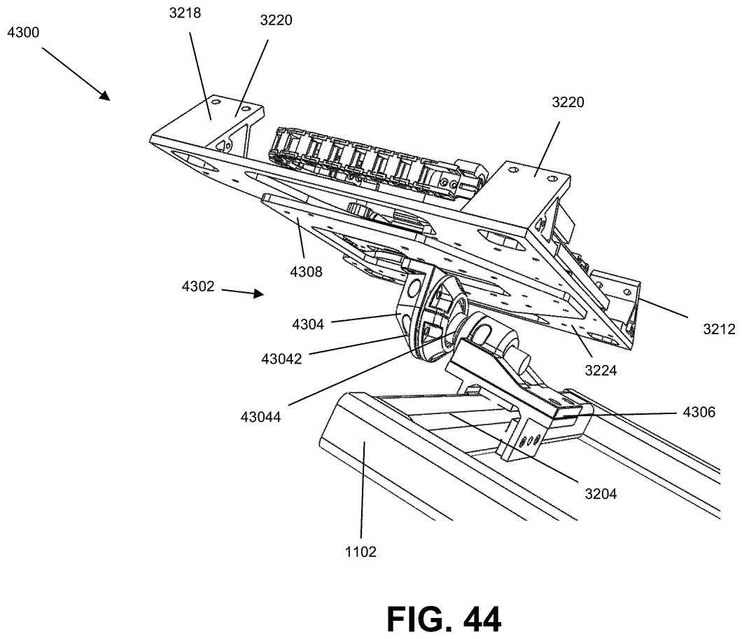

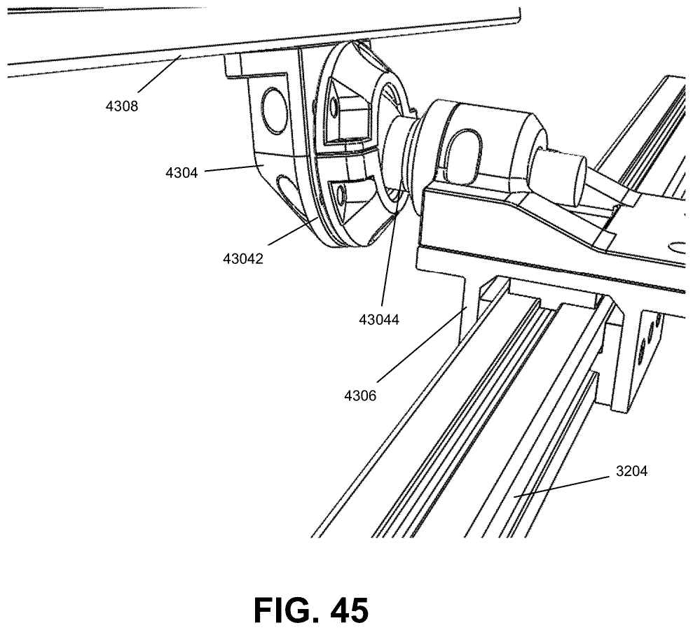

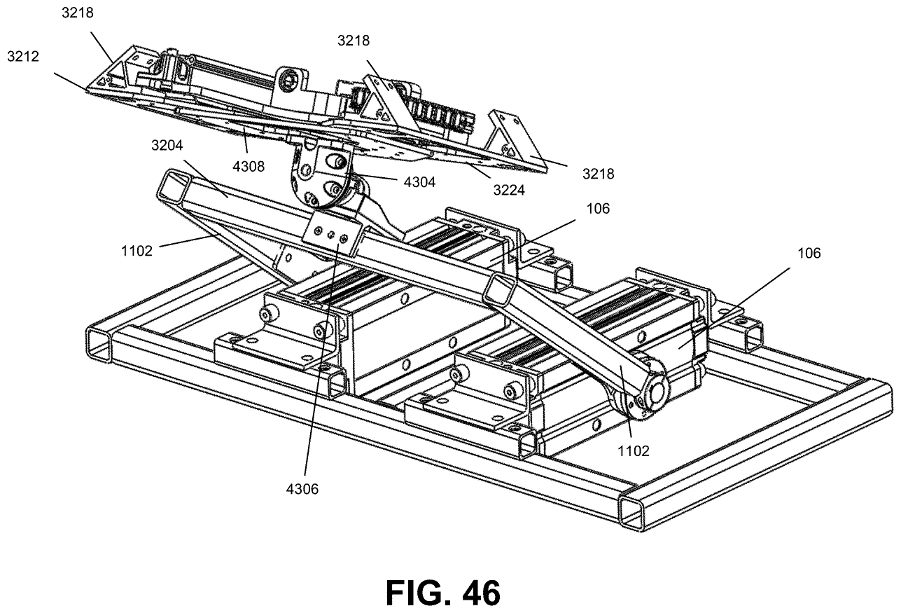

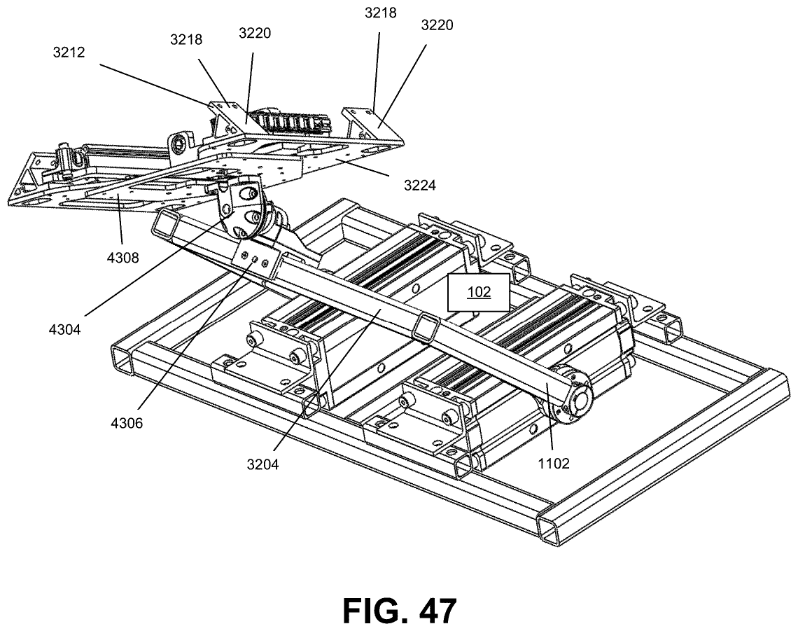

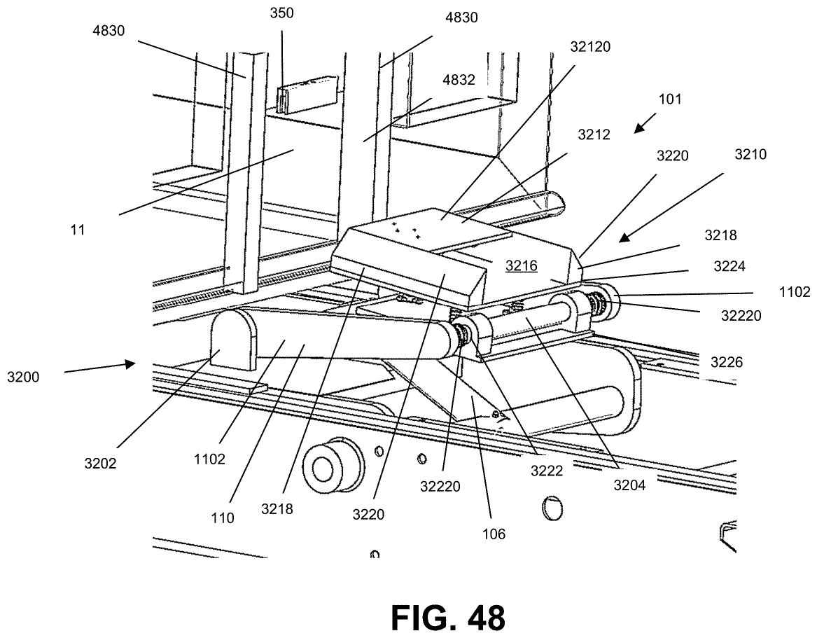

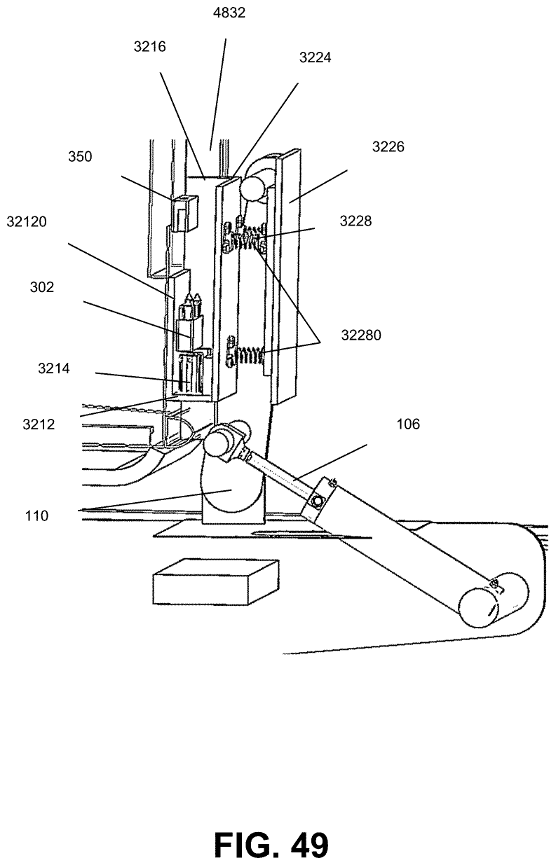

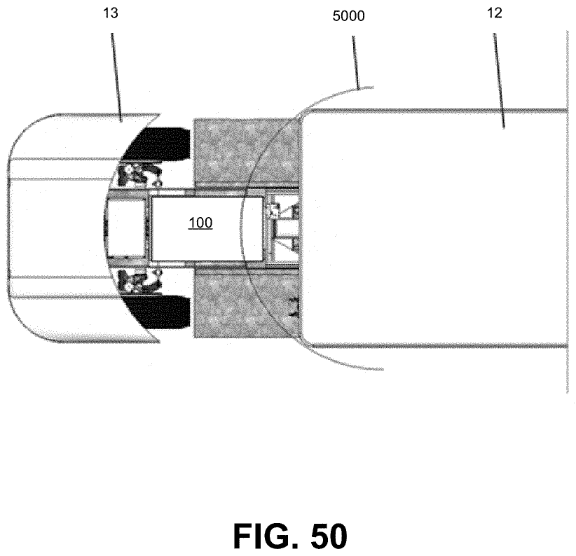

FIG. 10 is a perspective view of an alternate embodiment of an apparatus for connecting a first adapter counterpart to a second adapter counterpart, with the first adapter counterpart coupled to an end effector of the apparatus, the apparatus in the retracted position;

FIG. 11 is a perspective view of the apparatus of FIG. 10, the apparatus displacing the first adapter counterpart towards the second adapter counterpart;

FIG. 12 is a perspective view of the apparatus of FIG. 10, the apparatus coupling the first adapter counterpart and the second adapter counterpart;

FIG. 13 is a perspective view of the apparatus of FIG. 10, the apparatus displacing away from the second adapter counterpart after the first adapter counterpart and the second adapter counterpart are coupled;

FIG. 14 is a perspective view of the apparatus of FIG. 10, the apparatus in the retracted position after coupling the first adapter counterpart and the second adapter counterpart;

FIG. 15 is a side view of an embodiment of an end effector and gripper of the apparatus;

FIG. 16 is a perspective view of the end effector and gripper of FIG. 15;

FIG. 17 is a perspective view of the end effector and gripper of FIG. 15, the gripper coupled to a first adapter counterpart;

FIG. 18 is a perspective view of the end effector and gripper of FIG. 15, the gripper coupled to the first adapter counterpart, displaced from a center position;

FIG. 19 is a perspective view of the end effector and gripper of FIG. 15, coupled to the first adapter counterpart, a first frame of the end effector rotated relative to a second frame;

FIG. 20 is a perspective view of an alternate embodiment of an end effector and gripper of the apparatus, coupled to a first adapter counterpart;

FIG. 21 is a perspective view of the end effector of FIG. 20, coupled to the first adapter counterpart, the gripper and first adapter counterpart displaced from a center position;

FIG. 22 is a top view of the apparatus of FIG. 7, displacing the first adapter counterpart towards the second adapter counterpart;

FIG. 23 is a top view of a funnel of a guide displacing the first adapter counterpart towards a channel of the guide;

FIG. 24 is a top view of the first adapter counterpart and the second adapter counterpart disposed in alignment;

FIG. 25 is a side elevation view of an alternate embodiment of an apparatus for connecting a first adapter counterpart to a second adapter counterpart, with the object manipulator disposed in an actuation-ineffective position, and the second adapter counterpart disposed in a retracted position;

FIG. 26 is a side elevation of the apparatus of FIG. 25, with the object manipulator disposed in an actuation-ready position, and the second adapter counterpart disposed in an extended position;

FIG. 27 is a perspective view of the apparatus of FIG. 25, with the object manipulator disposed in actuation-ready position, and the second adapter counterpart disposed in an extended position;

FIG. 28 is a perspective view of the apparatus of FIG. 25, with the robot arm of the object manipulator extended to couple the first adapter counterpart and the second adapter counterpart;

FIG. 29 is a perspective view of the apparatus of FIG. 25, with the robot arm retracted into the casing after effecting coupling of the first adapter counterpart and the second adapter counterpart;

FIG. 30 is a side elevation view of the towing vehicle and trailer after the coupling of the first adapter counterpart and the second adapter counterpart is effected, with the fifth wheel lifting boom actuated, and the second adapter counterpart in the extended position;

FIG. 31 is a side elevation of the towing vehicle and trailer after the coupling of the first adapter counterpart and the second adapter counterpart is effected, with the fifth wheel lifting boom actuated, and the second adapter counterpart in the retracted position;

FIG. 32 is a perspective view of the first adapter counterpart and the second adapter counterpart of the adapter, the first adapter counterpart connected to an actuator of an alternate embodiment of an apparatus for connecting the first adapter counterpart to the second adapter counterpart;

FIG. 33 is a perspective view of the apparatus that includes the actuator of FIG. 32, with the object manipulator disposed in an actuation-ineffective position;

FIG. 34 is the perspective view of the apparatus of FIG. 33, with the object manipulator in the actuation-ready position;

FIG. 35 is a perspective view of the apparatus of FIG. 33, with the first adapter counterpart connected to the second adapter counterpart;

FIG. 36 is a perspective view of the apparatus of FIG. 33, with the first adapter counterpart connected to the second adapter counterpart, and the object manipulator retracting to the actuation-ineffective position;

FIG. 37 is an elevation view of the apparatus of FIG. 33, with the first adapter counterpart connected to the second adapter counterpart;

FIG. 38 is a perspective view of a trailer and a towing vehicle, the towing vehicle including the apparatus of FIG. 33 mounted thereon, the trailer and the towing vehicle disposed in an interaction-ineffective configuration;

FIG. 39 is a perspective view of the trailer and the towing vehicle of FIG. 38, the trailer and the towing vehicle disposed in an interaction-effective configuration;

FIG. 40 is a perspective view of the first adapter counterpart connected to the second adapter counterpart disposed in operable communication, and the object manipulator disposed in the actuation-ready position;

FIG. 41 is a perspective view of the trailer and the towing vehicle of FIG. 38, with the first adapter counterpart connected to the second adapter counterpart, and the object manipulator transitioning from the actuation-ready position to the actuation-ineffective position;

FIG. 42 is a perspective view of the trailer and the towing vehicle of FIG. 41, with the object manipulator disposed in the actuation-ineffective position, such that the trailer is towable by the towing vehicle;

FIG. 43 is a side view of an alternate embodiment of the apparatus of FIG. 33;

FIG. 44 is a perspective view of the apparatus of FIG. 43;

FIG. 45 is a perspective view of the ball joint assembly of the apparatus of FIG. 43;

FIG. 46 is a perspective view of the apparatus of FIG. 43;

FIG. 47 is a perspective view of the apparatus of FIG. 43;

FIG. 48 is a perspective view of an alternate embodiment of an apparatus for connecting a first adapter counterpart to a second adapter counterpart, with the object manipulator in the actuation-ineffective position;

FIG. 49 is a perspective view of apparatus of FIG. 48, with the object manipulator in the actuation-ready position.

FIG. 50 is a top elevation view of a towing vehicle connected to a trailer, depicting the swing radius of the trailer.

### DETAILED DESCRIPTION

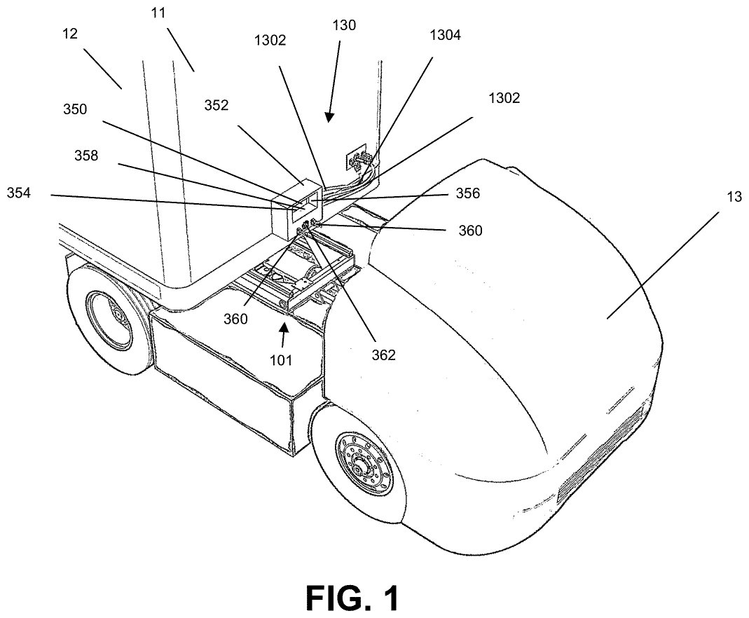

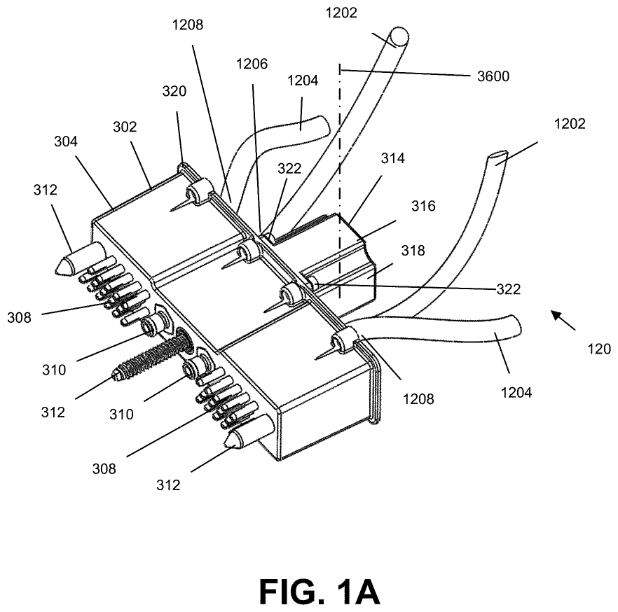

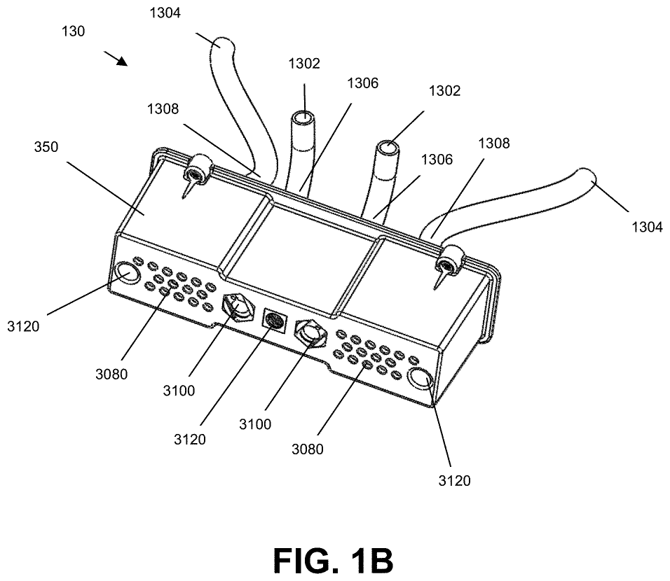

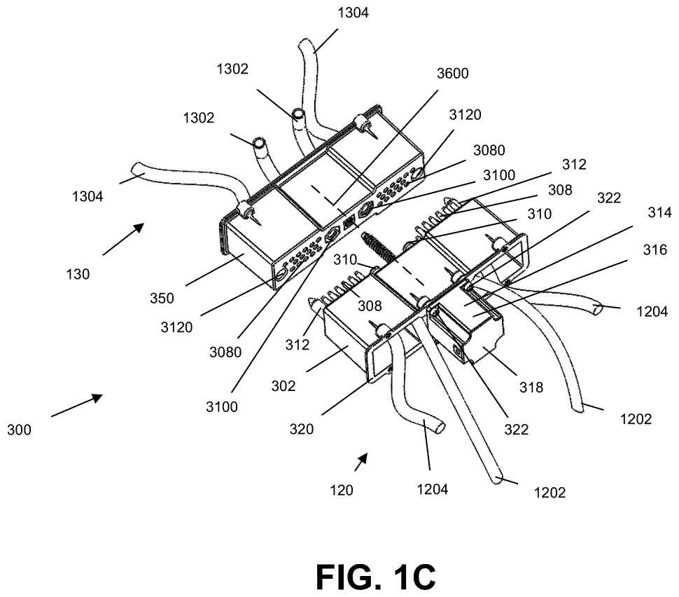

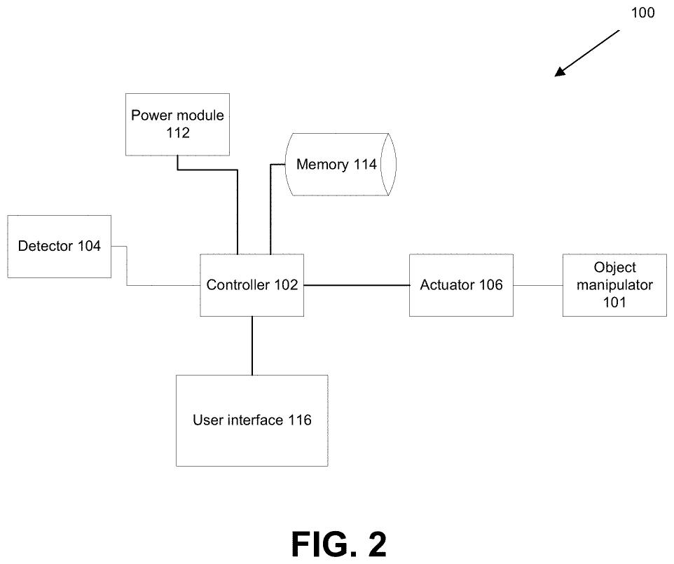

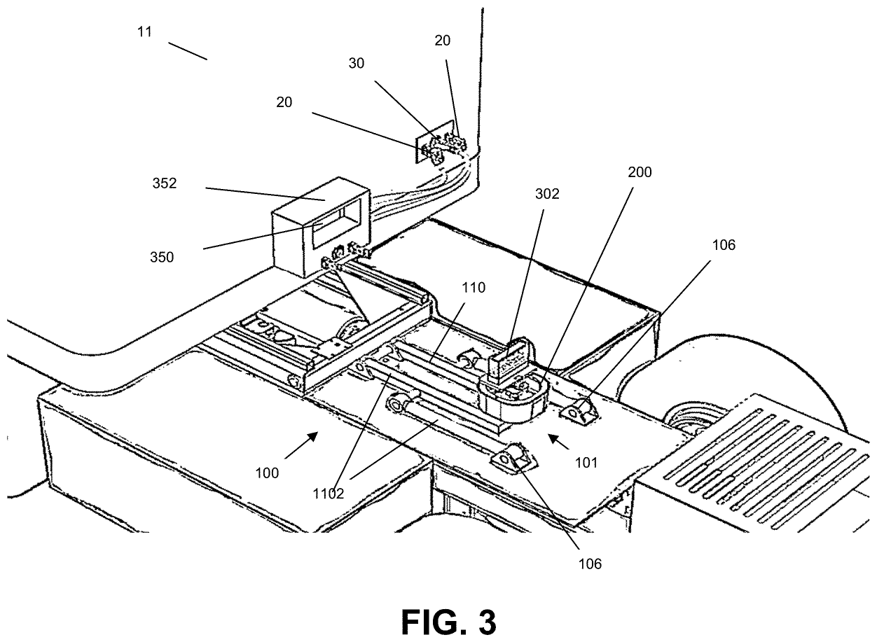

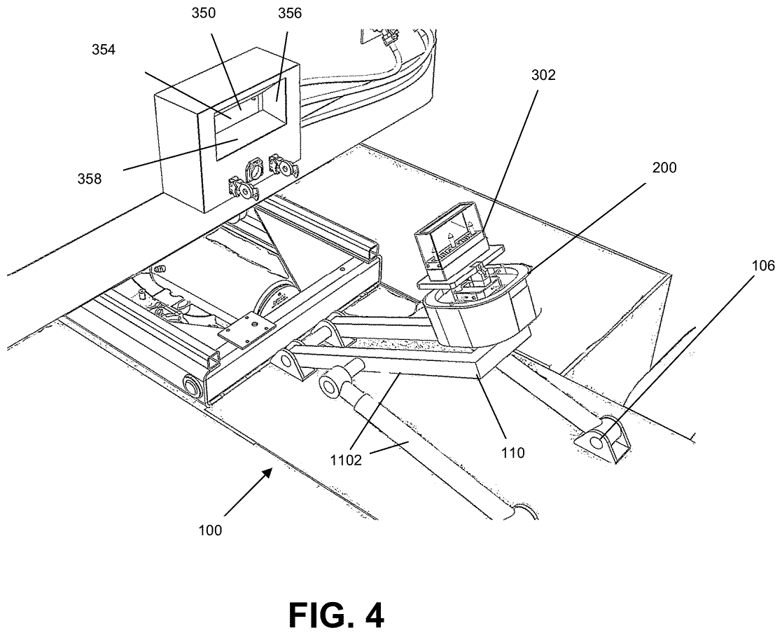

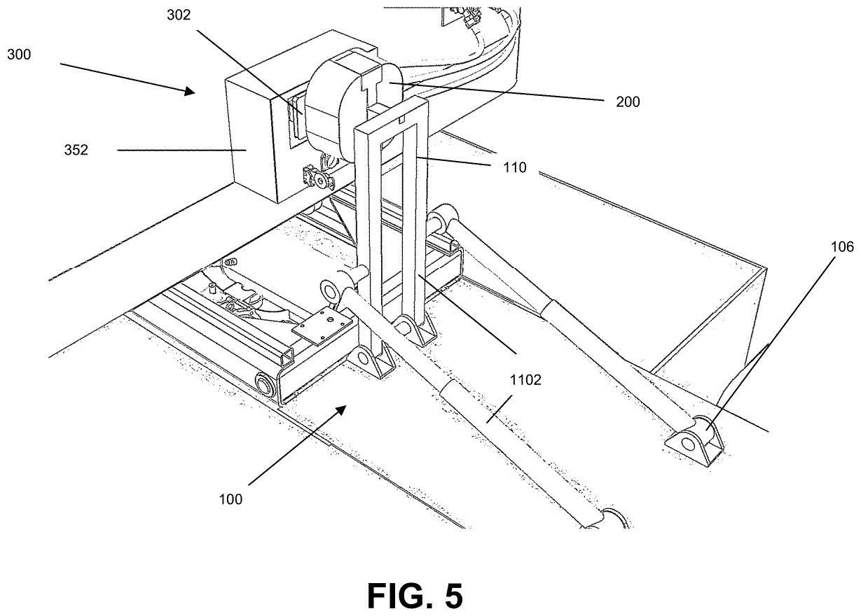

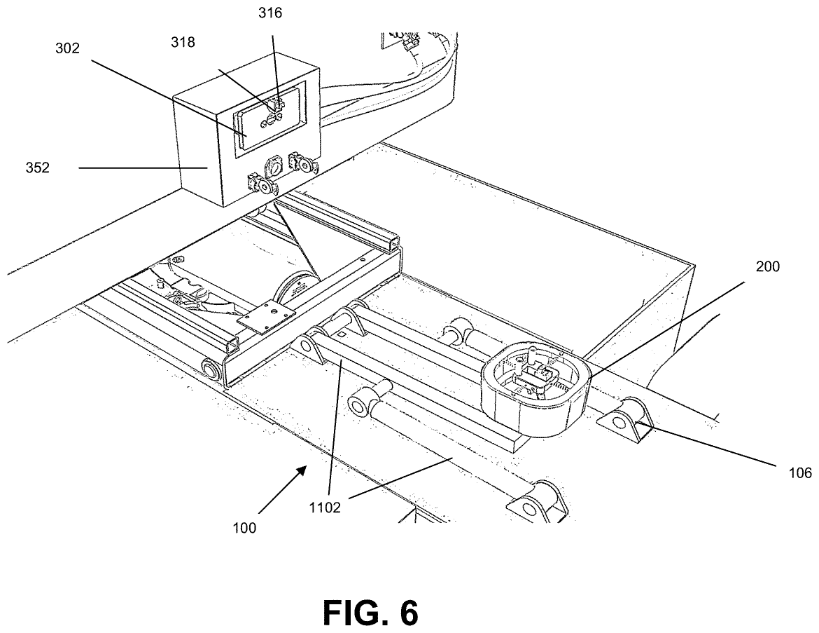

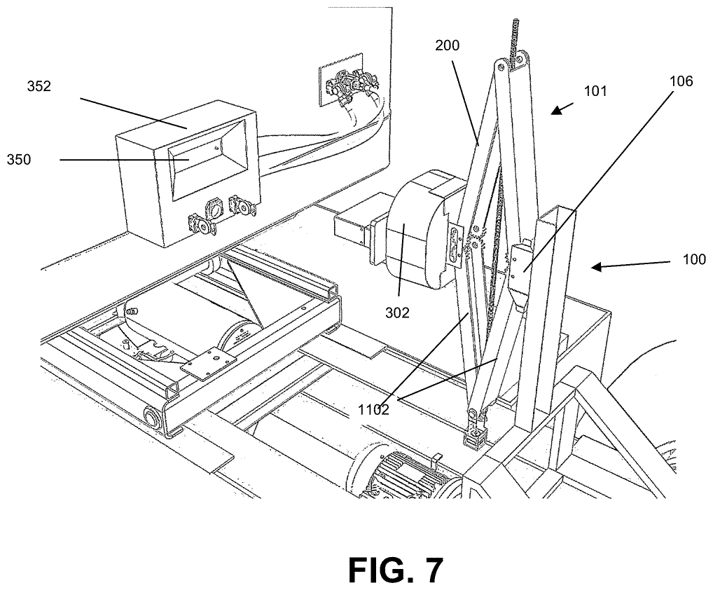

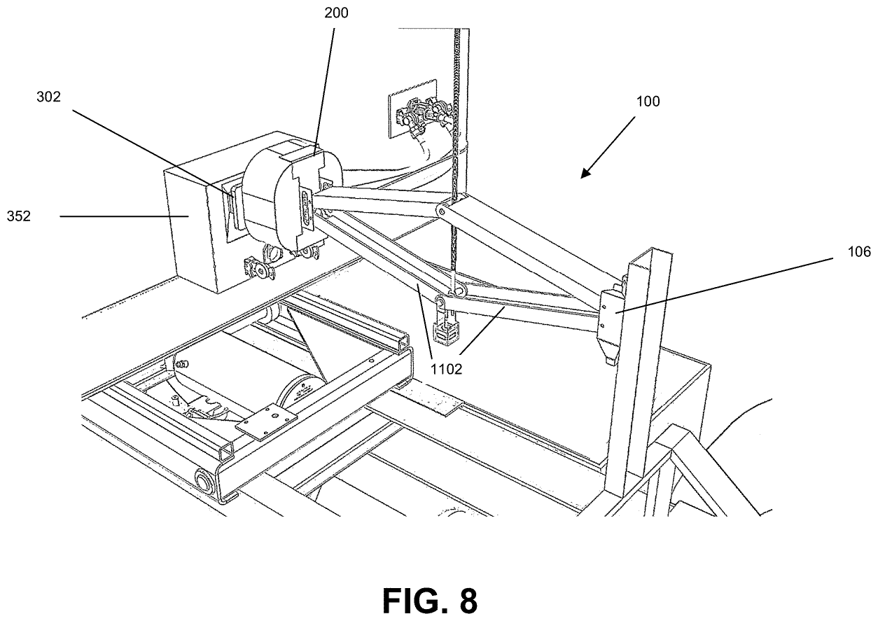

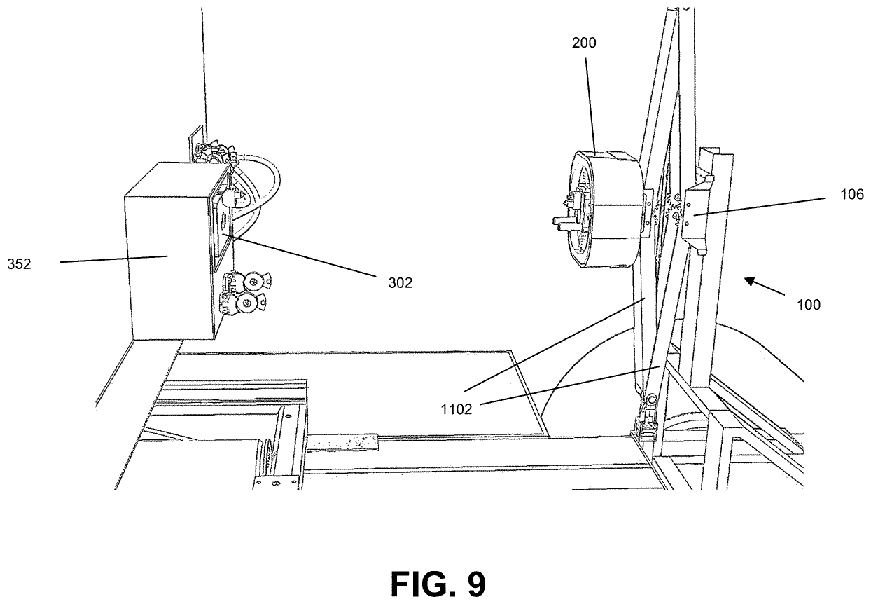

FIG. 1 depicts a towing vehicle 13 that is coupled to a trailer 12. The towing vehicle 13 is configured to tow the trailer 12. In some embodiments, for example, the towing vehicle 13 is a tractor, a yard shifter, or a converter dolly. In some embodiments, for example, the towing vehicle 13 is an autonomous vehicle, such as an autonomous tractor, yard shifter, or converter dolly. In some embodiments, for example, the towing vehicle 13 includes a fifth wheel coupling 15, configured for receiving, for example, slidably receiving, and coupling with a corresponding fifth wheel guiding counterpart or locking pin, or kingpin, (not shown) that extends from a bottom surface of the trailer 12 which is received within a corresponding slot formed in the coupling plate of the fifth wheel coupling 15, the trailer 12 resting and pivoting on the coupling plate about the locking pin, such that a fifth wheel coupling relationship is established. While a fifth wheel coupling has been described in connection with the coupling of the trailer 12 to the towing vehicle 13, it will be understood that various other couplings may be used provided the coupling between the towing vehicle 13 and the trailer 12 is such that the trailer 12 displaces with the towing vehicle 13 while the towing vehicle 13 is in motion and can pivot relative to the towing vehicle 13 via the coupling for maneuverability. In some embodiments, for example, while the towing vehicle 13 and the trailer 12 are coupled, for example, via the co-operative configuration of the locking pin and the fifth wheel 15, the towing vehicle 13 and the trailer 12 become disposed in an interaction-effective configuration, such that respective adapter counterparts 302 and 350 of the towing vehicle 13 and the trailer 12 are disposable in an alignment relationship for connection, for example, via a connection apparatus 100, as described in greater detail herein. In some embodiments, for example, while the towing vehicle 13 and the trailer 12 are decoupled, the towing vehicle 13 and the trailer 12 become disposed in an interaction-ineffective configuration, such that respective adapter counterparts 302 and 350 of the towing vehicle 13 and the trailer 12 are not connectible via the connection apparatus 100.

In some embodiments, for example, pneumatic air and electrical connections are established between the towing vehicle 13 and the trailer 12 for actuating a vehicular operation to operate a towing vehicle 13 to tow a trailer 12. The pneumatic air connection is established, for example, via a set of glad hands, to supply pneumatic air from a pneumatic air source (e.g. pneumatic air tank or reservoir) of the towing vehicle 13 to the pneumatic air system of the trailer 12, which includes, for example, the service and parking brakes of the trailer 12, and the electrical connection is established, for example, via a set of electrical connectors, to supply electrical energy from an electrical energy source (e.g. battery) of the towing vehicle 13 to the electrical system of the trailer 12, which includes, for example, the ABS brakes and turn signals of the trailer 12.

In this respect, in some embodiments, for example, as depicted in FIG. 1A to FIG. 1C, the towing vehicle 13 includes a towing vehicle-defined communicator or trailer communicator 120, and the trailer 12 includes a trailer-defined communicator or towing vehicle communicator 130. In some embodiments, for example, the trailer communicator 120 is compliant with an ISO 13044-2 standard. In some embodiments, for example, the trailer communicator 120 includes one or more flexible cables. In some embodiments, for example, the towing vehicle communicator 130 is compliant with an ISO 13044-2 standard. In some embodiments, for example, the towing vehicle communicator 130 includes one or more flexible cables.

In some embodiments, for example, the trailer communicator 120 includes a trailer communicator-defined connector counterpart, and the towing vehicle communicator 130 includes a towing vehicle communicator-defined connector counterpart. In some embodiments, for example, the trailer communicator-defined connector counterpart and the towing vehicle communicator-defined connector counterpart are co-operatively configured to effect the coupling of the trailer communicator 120 and the towing vehicle communicator 130 such that the trailer communicator 120 becomes disposed in the coupled relationship with the towing vehicle communicator 130. In some embodiments, for example, the trailer communicator-defined connector counterpart and the towing vehicle communicator-defined connector counterpart are co-operatively configured to effect the coupling of the trailer communicator 120 and the towing vehicle communicator 130 such that the trailer communicator 120 becomes disposed in operable communication, for example, fluid communication (for example, fluid pressure communication) and electrical communication, with the towing vehicle communicator 130.

In some embodiments, for example, the trailer communicator 120 includes a towing vehicle defined fluid communication counterpart or a trailer communicator-defined fluid communication counterpart 1206, and the towing vehicle communicator 130 includes a trailer-defined fluid communication counterpart or a towing vehicle communicator-defined fluid communication counterpart 1306. In some embodiments, for example, the trailer communicator-defined fluid communication counterpart 1206 and the towing vehicle communicator-defined fluid communication counterpart 1306 are co-operatively configured to effect fluid communication between the trailer communicator 120 and the towing vehicle communicator 130 such that while the trailer communicator-defined fluid communication counterpart 1206 and the towing vehicle communicator-defined fluid communication counterpart 1306 are disposed in communication, the trailer communicator 120 and the towing vehicle communicator 130 are disposed in fluid communication.

In some embodiments, for example, the trailer communicator 120 includes a towing vehicle-defined fluid conductor or a trailer communicator-defined fluid conductor 1202 that is disposed in fluid communication with the trailer communicator-defined fluid communication counterpart 1206, and the towing vehicle communicator 130 includes a trailer-defined fluid conductor or a towing vehicle communicator-defined fluid conductor 1302 that is disposed in fluid communication with the towing vehicle communicator-defined fluid communication counterpart 1306. In some embodiments, for example, the trailer communicator-defined fluid communication counterpart 1206, the towing vehicle communicator-defined fluid communication counterpart 1306, the trailer communicator-defined fluid conductor 1202, and the towing vehicle communicator-defined fluid conductor 1302 are co operatively configured such that while the trailer communicator-defined fluid communication counterpart 1206 and the towing vehicle communicator-defined fluid communication counterpart 1306 are disposed in fluid communication, the trailer communicator-defined fluid conductor 1202 and the towing vehicle communicator-defined fluid conductor 1302 are disposed in fluid communication.

In some embodiments, for example, the trailer communicator-defined fluid conductor 1202 and the towing vehicle communicator-defined fluid conductor 1302 include pneumatic air conductors (e.g. air hoses), and the trailer communicator-defined fluid communication counterpart 1206 and the towing vehicle communicator-defined fluid communication counterpart 1306 include glad hands.

In some embodiments, for example, the trailer communicator 120 includes a towing vehicle defined electrical communication counterpart or a trailer communicator-defined electrical communication counterpart 1208, and the towing vehicle communicator 130 includes a trailer defined electrical communication counterpart or a towing vehicle communicator-defined electrical communication counterpart 1308. In some embodiments, for example, the trailer communicator-defined electrical communication counterpart 1208 and the towing vehicle communicator-defined electrical communication counterpart 1308 are co-operatively configured to effect electrical communication between the trailer communicator 120 and the towing vehicle communicator 130 such that while the trailer communicator-defined electrical communication counterpart 1208 and the towing vehicle communicator-defined electrical communication counterpart 1308 are disposed in electrical communication, the trailer communicator 120 and the towing vehicle communicator 130 are disposed in electrical communication.

In some embodiments, for example, the trailer communicator 120 includes a towing vehicle-defined electrical conductor or a trailer communicator-defined electrical conductor 1204 that is disposed in electrical communication with the trailer communicator-defined electrical communication counterpart 1208, and the towing vehicle communicator 130 includes a trailer-defined electrical conductor or a towing vehicle communicator-defined electrical conductor 1304 that is disposed in electrical communication with the towing vehicle communicator-defined electrical communication counterpart 1308. In some embodiments, for example, the trailer communicator-defined electrical communication counterpart 1208, the towing vehicle communicator-defined electrical communication counterpart 1308, the trailer communicator-defined electrical conductor 1204, and the towing vehicle communicator-defined electrical conductor 1304 are co operatively configured such that while the trailer communicator-defined electrical communication counterpart 1208 and the towing vehicle communicator-defined electrical communication counterpart 1308 are disposed in electrical communication, the trailer communicator-defined electrical conductor 1204 and the towing vehicle communicator-defined electrical conductor 1304 are disposed in electrical communication.

In some embodiments, for example, the trailer communicator-defined electrical conductor 1204 and the towing vehicle communicator-defined electrical conductor 1304 include electrical conductors (e.g. electrical cables), and the trailer communicator-defined electrical communication counterpart 1208 and the towing vehicle communicator-defined electrical communication counterpart 1308 include electrical connectors (e.g. 7-pin electrical connectors).

In some embodiments, for example, as depicted in FIG. 1A, the trailer communicator 120 includes the trailer communicator-defined fluid conductor 1202 and the trailer communicator-defined electrical conductor 1204, and the trailer communicator 120 is defined as separate communicators, in particular, the trailer communicator-defined fluid conductor 1202 and the trailer communicator-defined electrical conductor 1204 are separate conductors. In some embodiments, for example, the trailer communicator 120 includes the trailer communicator-defined fluid conductor 1202 and the trailer communicator-defined electrical conductor 1204, and the trailer communicator 120 is defined as a single communicator, for example, as a single cable, wherein the trailer communicator-defined fluid conductor 1202 and the trailer communicator-defined electrical conductor 1204 are disposed in the communicator.

In some embodiments, for example, the trailer communicator-defined fluid conductor 1202 is disposed in fluid communication with the pneumatic air source of the towing vehicle 13, such that the trailer communicator-defined fluid communication counterpart 1206 is disposed in fluid communication with the pneumatic air source (e.g. pneumatic air tank or reservoir) of the towing vehicle 13 via the trailer communicator-defined fluid conductor 1202.

In some embodiments, for example, the trailer communicator-defined electrical conductor 1204 is disposed in electrical communication with the electrical energy source of the towing vehicle 13, such that the trailer communicator-defined electrical communication counterpart 1208 is disposed in electrical communication with the electrical source (e.g. battery) of the towing vehicle 13 via the trailer communicator-defined electrical conductor 1204.

In some embodiments, for example, the towing vehicle 13 includes more than one trailer communicator-defined fluid conductor 1202, for example, a plurality of trailer communicator-defined fluid conductors 1202 that are each, independently, disposed in fluid communication with the pneumatic air source of the towing vehicle 13.

In some embodiments, for example, the towing vehicle 13 includes more than one trailer communicator-defined fluid conductor 1202, for example, a plurality of trailer communicator-defined fluid conductors 1202 that are each, independently, disposed in fluid communication with a respective one of a plurality of pneumatic air sources of the towing vehicle 13.

In some embodiments, for example, the towing vehicle 13 includes more than one trailer communicator-defined electrical conductor 1204, for example, a plurality of trailer communicator-defined electrical conductors 1204 that are each, independently, disposed in electrical communication with the electrical energy source of the towing vehicle 13.

In some embodiments, for example, the towing vehicle 13includes more than one trailer communicator-defined electrical conductor 1204, for example, a plurality of trailer communicator-defined electrical conductors 1204 that are each, independently, disposed in electrical communication with a respective one of a plurality of electrical energy sources of the towing vehicle 13.

In some embodiments, for example, as depicted in FIG. 1B, the towing vehicle communicator 130 includes the towing vehicle communicator-defined fluid conductor 1302 and the towing vehicle communicator-defined electrical conductor 1304, and the towing vehicle communication 130 is defined as separate communicators, in particular, the towing vehicle communicator-defined fluid conductor 1302 and the towing vehicle communicator-defined electrical conductor 1304 are separate conductors. In some embodiments, for example, the towing vehicle communicator 130 includes the towing vehicle communicator-defined fluid conductor 1302 and the towing vehicle communicator-defined electrical conductor 1304, and the towing vehicle communicator 130 is defined as a single communicator, for example, as a single cable, wherein the towing vehicle communicator-defined fluid conductor 1302 and the towing vehicle communicator-defined electrical conductor 1304 are disposed in the communicator.

In some embodiments, for example, the towing vehicle communicator-defined fluid conductor 1302 is disposed in fluid communication with the pneumatic air system of the trailer 12, such that the towing vehicle communicator-defined fluid communication counterpart 1306 is disposed in fluid communication with the pneumatic air system of the trailer 12 via the towing vehicle communicator-defined fluid conductor 1302.

In some embodiments, for example, the towing vehicle communicator-defined electrical conductor 1304 is disposed in electrical communication with the electrical system of the trailer 12, such that the towing vehicle communicator-defined electrical communication counterpart 1308 is disposed in electrical communication with the electrical system of the trailer 12 via the towing vehicle communicator-defined electrical conductor 1304.

in some embodiments, for example, the trailer 12 includes more than one towing vehicle communicator-defined fluid conductor 1302, for example, a plurality of towing vehicle communicator-defined fluid conductors 1302 that are each, independently, disposed in fluid communication with the pneumatic air system (e.g. service brakes, parking brakes) of the trailer 12.

As depicted, in some embodiments, for example, the trailer 12 includes more than one towing vehicle communicator-defined fluid conductor 1302, for example, a plurality of towing vehicle communicator-defined fluid conductors 1302 that are each, independently, disposed in fluid communication with a respective one of a plurality of subsystems of the pneumatic air system (e.g. service brakes, parking brakes) of the trailer 12. As depicted in FIG. 1B, the trailer 12 includes two towing vehicle communicator-defined fluid conductors 1302. A first towing vehicle communicator-defined fluid conductor 1302 is disposed in fluid communication with the service brake, and a second towing vehicle communicator-defined fluid conductor 1302 is disposed in fluid communication with the supply brake.

In some embodiments, for example, the trailer 12 includes more than one towing vehicle communicator-defined electrical conductor 1304, for example, a plurality of towing vehicle communicator-defined electrical conductors 1304 that are each, independently, disposed in electrical communication with the electrical system (e.g. ABS brakes, turning signals) of the trailer 12.

In some embodiments, for example, the trailer 12 includes more than one towing vehicle communicator-defined electrical conductor 1304, for example, a plurality of towing vehicle communicator-defined electrical conductors 1304 that are each, independently, disposed in electrical communication with a respective one of a plurality of subsystems of the electrical system (e.g. ABS brakes, turning signals) of the trailer 12. As depicted in FIG. 1B, the trailer 12 includes two towing vehicle communicator-defined electrical conductors 1304. A first towing vehicle communicator-defined electrical conductors 1304 is disposed in electrical communication with the ABS brakes, and a second towing vehicle communicator-defined electrical conductors 1304 is disposed in fluid communication with the turning signals.

In some embodiments, for example, the towing communicator-defined fluid conductor 1302 is disposed in fluid communication with a glad hand 20 of the trailer 12, which is disposed in fluid communication with the pneumatic air system of the trailer 12 (e.g. service and parking brakes) of the trailer 12, such that the towing vehicle communicator-defined fluid communication counterpart 1306 is disposed in fluid communication with the pneumatic air system of the trailer 12 via the towing vehicle communicator-defined fluid conductor 1302 and the glad hand 20.

In some embodiments, for example, the towing communicator-defined electrical conductor 1304 is disposed in electrical communication with an electrical connector 30 of the trailer 12, which is disposed in electrical communication with the electrical system of the trailer 12 (e.g. ABS brakes and turning lights) of the trailer 12, such that the towing vehicle communicator-defined electrical communication counterpart 1308 is disposed in electrical communication with the electrical system of the trailer 12 via the towing vehicle communicator-defined electrical conductor 1304 and the electrical connector 30.

In some embodiments, for example, as depicted in FIG. 1A to FIG. 10 and FIG. 32, the connection between the trailer communicator 120 and the towing vehicle communicator 130 is effectible by an adapter 300. The adapter 300 is configured to reduce the complexity of the establishing of operable communication, for example, fluid communication and electrical communication, between the trailer communicator 120 and the towing vehicle communicator 130. The adapter 300 includes a towing vehicle-defined adapter counterpart or a towing vehicle-defined connection counterpart, for example, a first adapter counterpart 302 and a trailer-defined adapter counterpart or a trailer-defined connection counterpart, for example, a second adapter counterpart 350. The first adapter counterpart 302 is configured for connection, for example, coupling, to the second adapter counterpart 350.

In some embodiments, for example, the connection of the first adapter counterpart 302 and the second adapter counterpart 350 is with effect that communication between the towing vehicle 13 and the trailer 12 is established for actuating a vehicular operation.

In some embodiments, for example, the communication established between the towing vehicle 13 and the trailer 12, in response to the connection of the first adapter counterpart 302 and the second adapter counterpart 350, is fluid communication. In some embodiments, for example, the vehicular operation that is actuatable, in response to the establishment of communication between the towing vehicle 13 and the trailer 12, is actuation of service brakes of the trailer 12.In some embodiments, for example, the vehicular operation that is actuatable, in response to the establishment of communication between the towing vehicle 13 and the trailer 12, is actuation of parking brakes of the trailer.

In some embodiments, for example, the communication established between the towing vehicle 13 and the trailer 12, in response to the connection of the first adapter counterpart 302 and the second adapter counterpart 350, is electrical communication. In some embodiments, for example, the vehicular operation that is actuatable, in response to the establishment of communication between the towing vehicle 13 and the trailer 12, is actuation of ABS brakes of the trailer 12. In some embodiments, for example, the vehicular operation that is actuatable, in response to the establishment of communication between the towing vehicle 13 and the trailer 12, is actuation of turn signals of the trailer 12.

In some embodiments, for example, as depicted in FIG. 1A, the first adapter counterpart 302 (e.g. a male counterpart 302) is disposed in operable communication, for example, fluid communication and electrical communication, with the trailer communicator 120.

In some embodiments, for example, the first adapter counterpart 302 is disposed in fluid communication with the trailer communicator-defined fluid conductor 1202. In some embodiments, for example, the first adapter counterpart 302 is disposed in fluid communication with the trailer communicator-defined fluid conductor 1202 via the trailer communicator-defined fluid communication counterpart 1206. In this respect, in some embodiments, for example, the first adapter counterpart 302 and the pneumatic air source of the towing vehicle 13 are disposed in fluid communication via the trailer communicator-defined fluid conductor 1202.

In some embodiments, for example, the first adapter counterpart 302 is disposed in electrical communication with the trailer communicator-defined electrical conductor 1204. In some embodiments, for example, the first adapter counterpart 302 is disposed in electrical communication with the trailer communicator-defined electrical conductor 1204 via the trailer communicator-defined electrical communication counterpart 1208. In this respect, in some embodiments, for example, the first adapter counterpart 302 and the electrical energy source of the towing vehicle 13 are disposed in electrical communication via the trailer communicator-defined electrical conductor 1204.

In some embodiments, for example, as depicted in FIG. 1B, the second adapter counterpart 350 (e.g. a female counterpart 350) is disposed in operable communication, for example, fluid communication and electrical communication, with the towing vehicle communicator 130.

In some embodiments, for example, the second adapter counterpart 350 is disposed in fluid communication with the towing vehicle communicator-defined fluid conductor 1302. In some embodiments, for example, the second adapter counterpart 350 is disposed in fluid communication with the towing vehicle communicator-defined fluid conductor 1302 via the towing vehicle communicator-defined fluid communication counterpart 1306. In this respect, in some embodiments, for example, the second adapter counterpart 350 and the pneumatic air system of the trailer 12 are disposed in fluid communication via the towing vehicle communicator-defined fluid conductor 1302.

In some embodiments, for example, the second adapter counterpart 350 is disposed in electrical communication with the towing communicator-defined electrical conductor 1304. In some embodiments, for example, the second adapter counterpart 350 is disposed in electrical communication with the towing vehicle communicator-defined electrical conductor 1304 via the towing vehicle communicator-defined electrical communication counterpart 1308. In this respect, in some embodiments, for example, the second adapter counterpart 350 and the electrical system of the trailer 12 are disposed in electrical communication via the towing communicator-defined electrical conductor 1304.

In some embodiments, for example, the first adapter counterpart 302 and the second adapter counterpart 350 are configured to be disposed in operable communication, for example, fluid communication and electrical communication. In some embodiments, for example, the disposition of the first adapter counterpart 302 and the second adapter counterpart 350 in operable communication is effected by coupling of the first adapter counterpart 302 and the second adapter counterpart 350.

In some embodiments, for example, in response to disposition of the first adapter counterpart 302 and the second adapter counterpart 350 in operable communication, the trailer communicator 120 and the towing vehicle communicator 130 are disposed in operable communication via the adapter 300. In this respect, in some embodiments, for example, in response to disposition of the first adapter counterpart 302 and the second adapter counterpart 350, the towing vehicle 13 and the trailer 12 are disposed in operable communication via the adapter 300, the trailer communicator 120, and the towing vehicle communicator 130.

In some embodiments, for example, in response to disposition of the first adapter counterpart 302 and the second adapter counterpart 350 in operable communication, for example, fluid communication, the trailer communicator-defined fluid conductor 1202 and the towing vehicle communicator-defined fluid conductor 1302 are disposed in fluid communication via the adapter 300. In this respect, in some embodiments, for example, in response to disposition of the first adapter counterpart 302 and the second adapter counterpart 350 in fluid communication, the pneumatic air source of the towing vehicle 13 and the pneumatic air system of the trailer 12 are disposed in fluid communication via the adapter 300, the trailer communicator-defined fluid conductor 1202, and the towing vehicle communicator-defined fluid conductor 1302.

In some embodiments, for example, in response to disposition of the first adapter counterpart 302 and the second adapter counterpart 350 in operable communication, for example, electrical communication, the trailer communicator-defined electrical conductor 1204 and the towing vehicle communicator-defined electrical conductor 1304 are disposed in electrical communication via the adapter 300. In this respect, in some embodiments, for example, in response to disposition of the first adapter counterpart 302 and the second adapter counterpart 350 in electrical communication, the electrical energy source of the towing vehicle 13 and the electrical system of the trailer 12 are disposed in electrical communication via the adapter 300, the trailer communicator-defined electrical conductor 1204, and the towing vehicle communicator-defined electrical conductor 1304.

As depicted in FIG. 1A to 10 and FIG. 32, the first adapter counterpart 302 includes a housing 304. In some embodiments, for example, at least a portion of the housing 304 defines a receivable portion 306 that is receivable in a channel 354 of a guide 352, which is disposed in alignment with a second adapter counterpart 350. As depicted in FIG. 1A, the first adapter counterpart 302 includes one or more electrical communicators, for example, electrical connectors 308, for example, electrical connector pins, one or more fluid pressure communicators, for example, fluid connectors 310, for example, fluid connector pins, and one or more guide pins 312.In some embodiments, for example, the electrical connectors 308, the fluid connectors 310, and guide pins 312 extend from the housing 304. In some embodiments, for example, the electrical connectors 308, the fluid connectors 310, and guide pins 312 are housed in the housing 304. In some embodiments, for example, the first adapter counterpart 302 defines an electro-pneumatic interface, wherein the electro-pneumatic interface includes the one or more electrical connectors 308, the one or more fluid connectors 310, and the one or more guide pins 312. In some embodiments, for example, at least one of the one or more fluid connectors 310 are disposed in fluid communication with the trailer communicator-defined fluid conductor 1202. In some embodiments, for example, at least one of the one or more electrical connectors 308 are disposed in electrical communication with the trailer communicator-defined electrical conductor 1204.

In some embodiments, for example, as depicted in FIG. 17 to FIG. 19, the first adapter counterpart 302 includes a plate 320. The first adapter counterpart 302 includes a second connector counterpart 314 that is mounted on the plate 320. The second connector counterpart 314 is configured to co-operate with a first connector counterpart 232 of a fixture or gripper 230 of an object manipulator 101 of a connection apparatus 100 for releasably coupling the first adapter counterpart 302 and the gripper 230. The second connector counterpart 314 includes a guide pin 316 and a receiving port 318. The first connector counterpart 232 includes a guide pin 234 and a receiving port 236. The guide pin 316 of the second connector counterpart 314 is receivable in the receiving port 236 of the first connector counterpart 232, and the guide pin 234 of the first connector counterpart 232 is receivable in the receiving port 318 of the second connector counterpart 314. The first connector counterpart 232 is configured to releasably couple with second connector counterpart 314 The first connector counterpart 232 and the second connector counterpart 314 are co-operatively configured such that, in response to: i) insertion of the guide pin 316 of the second connector counterpart 314 into the receiving port 236 of the first connector counterpart 232, and (ii) insertion of the guide pin 234 of the first connector counterpart 232 into the receiving port 318 of the second connector counterpart 314, the first connector counterpart 232 is releasably coupled to the second connector counterpart 314, such that the gripper 230 is releasably coupled to the first adapter counterpart 302. In some embodiments, for example, the releasable coupling of the first connector counterpart 232 and the second connector counterpart 314 is effected by a latch, for example, one or more spring-loaded latches. In some embodiments, for example, the spring-loaded latch is disposed in one of the first connector counterpart 232 and the second connector counterpart 314, for example, the first connector counterpart 232. In some embodiments, for example, a spring-loaded latch is disposed in both of the first connector counterpart 232 and the second connector counterpart 314.

In some embodiments, for example, the plate 320 defines one or more guide ports 322 that are configured to receive the one or more prongs 240 of the gripper 230. The one or more guide ports 322 and the one or more prongs 240 are co-operatively configured to guide the relative displacement of the first adapter counterpart 302 and the gripper 230 to effect the releasable coupling of the first adapter counterpart 302 and the gripper 230. The one or more guide ports 322 and the one or more prongs 240 are co-operatively configured such that, while the one or more prongs 240 are received in the one or more guide ports 322, the first adapter counterpart 203 and the gripper 230 are disposed in alignment, for example, along an alignment axis.

As depicted in FIG. 1B and FIG. 10, the trailer 12 includes a second adapter counterpart 350. The second adapter counterpart 350 is mounted to the trailer 12, for example, the surface 11 (e.g. front surface 11) of the trailer 12. In some embodiments, for example, the second adapter counterpart 350 is mounted on the trailer 12, for example, the surface 11 of the trailer 12 that faces the towing vehicle 13, while the towing vehicle 13 and the trailer 12 are coupled. The second adapter counterpart 350 includes one or more electrical ports 3080, one or more fluid ports 3100, and one or more guide ports 3120. In some embodiments, for example, at least one of the one or more fluid ports 3100 are disposed in fluid communication with the towing communicator-defined fluid conductor 1302. As depicted in FIG. 1B, in some embodiments, for example, a first fluid port 3100 is disposed in fluid communication with a first towing communicator-defined fluid conductor 1302, and a second fluid port 3100 is disposed in fluid communication with a second towing communicator-defined fluid conductor 1302. In some embodiments, for example, at least one of the one or more electrical ports 3080 are disposed in electrical communication with the towing communicator-defined electrical conductor 1304. As depicted in FIG. 1B, in some embodiments, for example, a first electrical port 3080 is disposed in fluid communication with a first towing communicator-defined electrical conductor 1304, and a second fluid port 3080 is disposed in electrical communication with a second towing communicator-defined electrical conductor 1304. As depicted, in some embodiments, for example, while the second adapter counterpart 350 is mounted on the trailer 12, the electrical ports 3080, fluid ports 3100, and guide ports 3120 are facing a direction that is parallel to the normal axis defined by the surface 11. As depicted, in some embodiments, for example, while the second adapter counterpart 350 is mounted on the trailer 12, and while the towing vehicle 13 and the trailer 12 are coupled, the electrical ports 3080, fluid ports 3100, and guide ports 3120 are facing away from the trailer 12 and towards the towing vehicle 13.

The electrical connectors 308 of the first adapter counterpart 302 and the electrical ports 3080 of the second adapter counterpart 350 are co-operatively configured such that, in response to insertion of the electrical connectors 308 into the electrical ports 3080, the first adapter counterpart 302 and the second adapter counterpart 350 become disposed in electrical communication, with effect that the trailer communicator-defined electrical conductor 1204 and the towing vehicle communicator-defined electrical conductor 1304 become disposed in electrical communication. In this respect, in response to insertion of the electrical connectors 308 into the electrical ports 3080, the electrical energy source of the towing vehicle 13 becomes disposed in electrical communication with the electrical system of the trailer 12 via the adapter 300, the trailer communicator-defined electrical conductor 1204, and the towing vehicle communicator-defined electrical conductor 1304.

The fluid connectors 310 of the first adapter counterpart 302 and the fluid ports 3100 of the second adapter counterpart 350 are co-operatively configured such that, in response to insertion of the fluid connectors 310 into the fluid ports 3100, the first adapter counterpart 302 and the second adapter counterpart 350 become disposed in fluid communication, with effect that the trailer communicator-defined fluid conductor 1202 and the towing vehicle communicator-defined fluid conductor 1302 become disposed in fluid communication. In this respect, in response to insertion of the fluid connectors 310 into the fluid ports 3100, the pneumatic air source of the towing vehicle 13 becomes disposed in fluid communication with the pneumatic air system of the trailer 12 via the adapter 300, the trailer communicator-defined fluid conductor 1202, and the towing vehicle communicator-defined fluid conductor 1302.

In some embodiments, for example, disposition of the first adapter counterpart 302 and the second adapter counterpart 350 in alignment, for effecting operable communication between the first adapter counterpart 302 and the second adapter counterpart 350, is effected by insertion of the first adapter counterpart 302, for example, the receivable portion 306, into the channel 354.

In some embodiments, for example, disposition of the first adapter counterpart 302 and the second adapter counterpart 350 in operable communication is effected by establishment of: (I) electrical communication between the electrical connectors 308 and the electrical ports 3080, and (ii) fluid communication between the fluid connectors 310 and the fluid ports 3100. In some embodiments, for example, establishment of electrical communication between the electrical connectors 308 and the electrical ports 3080 is effected by insertion of the electrical connectors 308 into the electrical ports 3080. In some embodiments, for example, establishment of fluid communication between the fluid connectors 310 and the fluid ports 3100 is effected by insertion of the fluid connectors 310 into the fluid ports 3100.

In some embodiments, for example, the guide pins 312 of the first adapter counterpart 302 and the guide ports 3120 of the second adapter counterpart 350 are co-operatively configured to guide the relative displacement of the first adapter counterpart 302 and the second adapter counterpart 350 for effecting the coupling of the first adapter counterpart 302 and the second adapter counterpart 350, such that the first adapter counterpart 302 and the second adapter counterpart 350 become disposed in operable communication.

As depicted in FIG. 1 and FIG. 4, the trailer includes a guide 352. The guide is mounted to the surface 11 of the trailer 12. The guide 352 is mounted to the trailer 12 such that an alignment relationship-obtaining displacement of the first adapter counterpart 302, relative to the second adapter counterpart 350, is guidable, by the guide 352, wherein the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350.

As depicted in FIG. 1 and FIG. 4, the guide 352 defines a channel 354 that is configured to receive the first adapter counterpart 302, for example, the receivable portion 306 of the first adapter counterpart 302. As depicted in FIG. 22 to FIG. 24, the channel 354 is defined by channel walls 3542. As depicted in FIG. 1, the channel 354 has a rectangular shape. In some embodiments, the channel 354 has a round shape, such as a circle or an oval, or a three-sided shape, four-sided shape, or a shape with more than four sides. The channel walls 3542 are configured to guide the insertion of the first adapter counterpart 302into the channel 354 such that the first adapter counterpart 302 and the second adapter counterpart 350 become aligned for disposing the first adapter counterpart 302 and the second adapter counterpart 350 in operable communication.

As depicted in FIG. 1, in some embodiments, for example, the guide 352 includes one or more inclined walls 356, wherein each one of the one or more inclined walls 356, independently, defines a surface configuration counterpart. The one or more inclined walls 356 defines a funnel 358. As depicted in FIG. 1, the opening of the funnel 358 has a rectangular shape. In some embodiments, the opening of the funnel 358 has a round shape, such as a circle or an oval, or a three-sided shape, four-sided shape, or a shape with more than four sides. The funnel 358 is configured to guide the insertion of the first adapter counterpart 302 into the channel 354 for disposing the first adapter counterpart 302 and the second adapter counterpart 350 in operable communication.

In some embodiments, for example, the mounting of the second adapter counterpart 350 and the guide 352 to the trailer 12 is such that the second adapter 350 is disposed, relative to the guide 352, such that the one or more electrical ports 3080, one or more fluid ports 3100, and one or more guide ports 3120 are disposed in alignment with the channel 354, and between the inclined walls 356, of the guide 352.

In some embodiments, for example, the second adapter counterpart 350 includes a set of glad hands 360 and an electrical connector 362 to connect with the trailer communicator 120 for vehicles without the robotic apparatus 100 installed thereon. The electrical ports 3080 and the electrical connector 362 of the second adapter counterpart 350 are disposed in parallel connection with the towing vehicle communicator-defined electrical conductor 1304. The fluid ports 3100 and the glad hands connector 360 of the second adapter counterpart 350 are disposed in parallel connection with the towing vehicle communicator-defined fluid conductor 1302.

In some embodiments, for example, the first adapter counterpart 302 and the second adapter counterpart 350 are compliant with ISO 13044-2 standard.

FIG. 2 depicts a block diagram of an example embodiment of an apparatus 100 that is configured to operably communicate, for example, connect, the first adapter counterpart 302 and the second adapter counterpart 350 to effect operable communication of a trailer communicator 120 of the towing vehicle 13 and the towing vehicle communicator 130 of a trailer 12. As depicted, in some embodiments, for example, the apparatus 100 includes a controller 102, a detector 104, an actuator assembly 106, and an object manipulator 101 including a robot arm 110, a power module 112, and a memory 114, an end effector 200, and a fixture or gripper 230. In some embodiments, for example, the apparatus 100 further includes a user interface 116. The object manipulator 101 is configured to automatically connect the first adapter counterpart 302 and the second adapter counterpart 350 to establish operable communication between the first adapter counterpart 302 and the second adapter counterpart 350, thereby establishing operable communication between the trailer communicator 120 and towing vehicle communicator 130.

As depicted in FIG. 3 to FIG. 6, in some embodiments, for example, the apparatus 100 is a catapult-style apparatus. As depicted in FIG. 7 to FIG. 9, in some embodiments, for example, the apparatus 100 is a scissor-style apparatus. As depicted in FIG. 10 to FIG. 14, in some embodiments, for example, the apparatus 100 is a four-bar linkage-style apparatus.

As depicted in FIG. 3, FIG. 7, and FIG. 10, in some embodiments, for example, the apparatus 100 is disposed in a retracted position outside of, or below, a swing radius 5000 of the trailer 12, as depicted in FIG. 50, and is coupled with the first adapter counterpart 302. In some embodiments, for example, the apparatus 100 is disposed in such a position prior to coupling the first adapter counterpart 302 and the second adapter counterpart 350.

As depicted in FIG. 4, FIG. 8, and FIG. 11, in some embodiments, for example, the apparatus 100 is configured to displace the first adapter counterpart 302 towards the second adapter counterpart 350 for effecting an alignment relationship-obtaining displacement between the first adapter counterpart 302 and the second adapter counterpart 350, such that the first adapter counterpart 302 and the second adapter counterpart 350 become disposed in an alignment relationship, and for coupling the first adapter counterpart 302 and the second adapter counterpart 350. As depicted in FIG. 4, in some embodiments, for example, the displacement includes a rotational displacement about a pivot point of an arm segment 1102 of the apparatus 100. As depicted in FIG. 8, in some embodiments, for example, the displacement includes a displacement in a direction that is parallel to a longitudinal axis. As depicted in FIG. 11, in some embodiments, for example, the displacement is a combination of a rotational displacement and a displacement in a direction parallel to a longitudinal axis. In some embodiments, for example, the displacement includes a displacement in a vertical direction. In some embodiments, for example, the displacement is a combination of a rotational displacement and a displacement in a vertical direction.

As depicted in FIG. 5, FIG. 8, and FIG. 12, in some embodiments, for example, the apparatus 100 is configured to couple the first adapter counterpart 302 and the second adapter counterpart 350. In some embodiments, for example, the coupling of the first adapter counterpart 302 and the second adapter counterpart 350 is effected by insertion of the electrical and fluid connectors 308 and 310 of the first adapter counterpart 302 into the corresponding ports 3080 and 3100 of the second adapter counterpart 350.

As depicted in FIG. 6, FIG. 9, and FIG. 14, in some embodiments, for example, the apparatus 100 is disposed in a retracted position outside of a swing radius 5000 of the trailer 12, for example, outside or below the swing radius of the trailer 12, and is decoupled from the first adapter counterpart 302. In some embodiments, for example, the apparatus 100 is disposed in such a position after coupling the first adapter counterpart 302 and the second adapter counterpart 350, and then decoupling from the first adapter counterpart 302.

As depicted in FIG. 13, in some embodiments, for example, the apparatus 100 is configured to decouple from the first adapter counterpart 302, and displace away from the first adapter counterpart 302 and the second adapter counterpart 350 after effecting the coupling of the first adapter counterpart 302 and the second adapter counterpart 350. In some embodiments, for example, the displacement includes a rotational displacement about a pivot point of an arm segment 1102 of the apparatus 100, similar to the displacement depicted in FIG. 4. In some embodiments, for example, the displacement includes a displacement in a direction that is parallel to a longitudinal axis, similar to the displacement depicted in FIG. 8. As depicted in FIG. 13, in some embodiments, for example, the displacement is a combination of a rotational displacement and a displacement in a direction parallel to a longitudinal axis. In some embodiments, for example, the displacement includes a displacement in a vertical direction. In some embodiments, for example, the displacement is a combination of a rotational displacement and a displacement in a vertical direction.

In some embodiments, the controller 102 includes a processor or a central processing unit (CPU), a memory 114 such as a ROM, RAM, persistent memory, or flash memory for storing data, and input or output peripherals. In some embodiments, for example, the controller 102 acts as a central controller for controlling all of the communications of the apparatus 100, and between the apparatus 100 and an external server or user equipment, such as a computer, laptop, smart device, a control panel in a control room, a control panel in the towing vehicle 13, and the like.

The controller 102 communicates with the detector 104, the actuator assembly 106, the user interface 116, the power module 112, and the memory 114. In some embodiments, the controller 102 receives data, saves the data to a memory, and processes the received data. The data may be real time data or historical data. In some embodiments, the controller 102 or detector 104 processes the data by, for example, comparing data with one or more preset thresholds. In some embodiments, the controller 102 or detector 104 processes the data to, for example, determine whether the towing vehicle 13 and trailer 12 are coupled or decoupled, determine whether the first adapter counterpart 302 and the second adapter counterpart 350 are coupled or decoupled, determine whether the first adapter counterpart 302 and the second adapter counterpart 350 are disposed in operable communication, determine whether the gripper 230 and the first adapter counterpart 302 are coupled or decoupled, determine whether the object manipulator 101 is disposed outside a swing radius 5000 of the trailer 12, and determine the position or configuration of the object manipulator 101 for initiating the next step in the process for aligning and coupling the first adapter counterpart 302 and the second adapter counterpart 350 to establish operable communication between the first adapter counterpart 302 and the second adapter counterpart 350, or for decoupling the first adapter counterpart 302 and the second adapter counterpart 350 to defeat the operable communication between the first adapter counterpart 302 and the second adapter counterpart 350. Based on said determinations, in some embodiments, for example, the controller 102 is configured to activate the actuator assembly 106 to effect coupling of the gripper 230 of the object manipulator 101 with the first adapter counterpart 302, and to displace the first adapter counterpart 302 relative to the second adapter counterpart 350, to operably connect the first adapter counterpart 302 with the second adapter counterpart 350. In some embodiments, for example, the controller 102 determines that the towing vehicle 13 has stopped operating for a threshold period of time and that the towing vehicle 13 and the trailer 12 are coupled, and then the controller 102 is configured to activate the actuator assembly 106 to effect coupling of the gripper 230 with the first adapter counterpart 302, and to displace the first adapter counterpart 302 relative to the second adapter counterpart 350, to operably connect the first adapter counterpart 302 with the second adapter counterpart 350. Based on said determinations, in some embodiments, for example, the controller 102 is configured to activate the actuator assembly 106 to effect coupling of the gripper 230 with the first adapter counterpart 302 that is operably connected with the second adapter counterpart 350, and to displace the first adapter counterpart 302, relative to the second adapter counterpart 350, to operably disconnect from the second adapter counterpart 350, such that operable communication between the first adapter counterpart 302 and the second adapter counterpart 350 becomes defeated. In some embodiments, for example, the controller 102 determines that the towing vehicle 13 has stopped operating for a threshold period of time and that the towing vehicle 13 and the trailer 12 are coupled, and then the controller 102 is configured to activate the actuator assembly 106 to effect coupling of the gripper 230 and the first adapter counterpart 302 that is operably connected with the second adapter counterpart 350, and to displace the first adapter counterpart 302, relative to the second adapter counterpart 350, to operably disconnect from the second adapter counterpart 350, such that operable communication between the first adapter counterpart 302 and the second adapter counterpart 350 becomes defeated.

In some embodiments, the controller 102 is configured to control the functioning or operation of the apparatus 100. For example, based on the data from the detector 104 or the actuator assembly 106, the controller 102 sends a control command to the user interface 116 to render a graphic representative of the data, or sends a control command to the actuator assembly 106 to operate the object manipulator 101.

In some embodiments, for example, the controller 102 is mounted to the towing vehicle 13 such that the controller 102 is protected from the elements. In some embodiments, for example, the controller 102 is mounted under the cab of the towing vehicle 13.

In some embodiments, for example, the detector 104 is operably coupled to the controller 102, for example, via wired or wireless communication, to transmit the detected data to the controller 102. In some embodiments, for example, the detector 104 includes a sensor subsystem, which includes one or more sensors. In some embodiments, for example, the detector 104 is configured to detect, independently: (i) the coupling or decoupling of the towing vehicle 13 and the trailer 12, (ii) the coupling or decoupling of the gripper 230 and the first adapter counterpart 302, (iii) the coupling or decoupling of the first adapter counterpart 302 and the second adapter counterpart 350, and (iv) the establishment or defeating of operable communication of the first adapter counterpart 302 and the second adapter counterpart 350. In some embodiments, for example, the detector 104 is configured to detect whether the first adapter counterpart 302 and the second adapter counterpart 350 are disposed in operable communication. In some embodiments, for example, the detector 104 is configured to detect whether the gripper 230 and the first adapter counterpart 302 are releasably coupled, for example, via the first connector counterpart 232 and the second connector counterpart 314.

In some embodiments, one or more of the sensors of the detector 104 are wireless sensors that are configured for wireless communication with the controller 102.

In some embodiments, the apparatus 100 is configured to be in electrical communication with a power source, such as a battery or fuel cell. In some embodiments, the apparatus 100 is disposable in electrical communication with an external power source, such as a portable battery, portable generator, external battery, and the like. In some embodiments, for example, the apparatus 100 is wirelessly connectable to the external power source for wirelessly energizing the apparatus 100. In some embodiments, for example, the apparatus 100 is powered by the electrical energy source of the towing vehicle 13, such as the battery of the towing vehicle 13.

In some embodiments, the apparatus 100 includes a user interface 116 that is configured to enable the controller 102 to interconnect with one or more input devices, such as user equipment, a keyboard, mouse, camera, touch screen and a microphone, or with one or more output devices such as a display screen and a speaker. In some embodiments, the controller 102 is configured to send a control command to the user interface 116 for displaying a graphical representation of data that is detected or sensed by the detector 104. In some embodiments, the user interface 116, via input from a user, is configured to send a control command to the controller 102 for controlling the apparatus 100. In some embodiments, for example, a user can input a control command to the controller 102 to via the user interface 116 to begin or end operation of the apparatus 100.

In some embodiments, for example, the controller 102 sends a control command to the user interface 116 to generate a graphical representation of the operating status of the apparatus 100. In some embodiments, for example, the controller 102 sends a control command to the user interface 116 to generate a graphical representation of a menu of options, and the user can input a control command using the user interface 116 to select an option from the menu, and the user interface 116 sends the control command to the controller 102 to control the operation of the apparatus 100.

The apparatus 100 includes an actuator assembly 106 that is disposed in operable communication with the controller 102. In some embodiments, for example, the actuator assembly 106 includes one or more actuators. The actuator assembly 106 is activatable to displace the robot arm 110 and to effect releasable coupling and releasing of the first adapter counterpart 302 by the end effector 200 of the object manipulator 101. In some embodiments, while the gripper 230 and the first adapter counterpart 302 are coupled, the actuator assembly 106 is activatable to displace the first adapter counterpart 302 via the robot arm 110 and the end effector 200. In some embodiments, for example, the controller 102 is configured to activate one or more actuators of the actuator assembly 106 to coordinate the displacement of the robot arm 110 and to effect the releasable coupling and releasing of the first adapter counterpart 302 by the gripper 230.

In some embodiments, for example, the actuator assembly 106 includes a linear actuator. In some embodiments, for example, the actuator assembly 106 includes a rotating actuator. In some embodiments, for example, the actuator assembly 106 includes an electrical actuator. In some embodiments, for example, the actuator assembly 106 includes a pneumatic actuator. In some embodiments, for example, the actuator assembly 106 includes a hydraulic actuator. In some embodiments, for example, the displacement of the robot arm 110 via activation of the actuator assembly 106 includes extension, retraction, displacement, rotation, and pivoting of the robot arm 110.

In some embodiments, for example, each one of the actuators of the actuator assembly 106, independently, is configured to send data representative of its operational state (e.g. activated, deactivated, or degree of activation) to the controller 102 for the controller 102 to control the operation of the robot arm 110.

In some embodiments, for example, as depicted in FIG. 3 to FIG. 14, the actuators of the actuator assembly 106 of the apparatus 100 are mounted on the robot arm 110 and are disposed in operable communication with the robot arm 110.

The apparatus 100 includes an object manipulator 101, which includes a robot arm 110 that is disposed in operable communication with the actuator assembly 106.

In some embodiments, for example, the robot arm 110 includes a base. In some embodiments, for example, the base is mounted to the frame of the towing vehicle 13, such that the base is secured to the frame of the towing vehicle 13. In some embodiments, for example, the base is connected to the frame of the towing vehicle 13 such that the base is slidable, via the actuator assembly 106, along a direction that is parallel to a longitudinal axis of the towing vehicle 13 (e.g. axis extending from the front to back of the towing vehicle 13), a direction that is parallel to a lateral axis of the towing vehicle 13 (e.g. axis extending from one side of the towing vehicle 13 to the other), a direction that is parallel to a vertical axis, or a combination thereof.

In some embodiments, for example, the robot arm 110 is pivotable relative to the base about one or more degrees of freedom, for example, two or three degrees of freedom. In some embodiments, for example, the robot arm 110 is pivotable relative to the base about the longitudinal axis, the lateral axis, or the vertical axis, or a combination thereof.

In some embodiments, for example, as depicted in FIG. 3 to FIG. 14, the robot arm 110 includes one or more robot arm segments 1102. In some embodiments, for example, the robot arm 110 includes a first arm segment 1102 and a second arm segment 1102 that are operably connected, for example, pivotably connected.

In some embodiments, for example, the actuator assembly 106 is activatable to displace the first arm segment 1102 relative to the second arm segment 1102, for example, extension, retraction, rotation, or pivoting, for displacing the robot arm 110.

In some embodiments, for example, the actuator assembly 106 is activatable to control the apparatus 100, for: i) releasably coupling the first adapter counterpart 302 and the second adapter counterpart 350, ii) releasing the first adapter counterpart 302 after the first adapter counterpart 302 is releasably coupled to the second adapter counterpart 350, iii) coupling with the first adapter counterpart 302 while the first adapter counterpart 302 is releasably coupled to the second adapter counterpart 350, or while there is an absence of coupling between the first adapter counterpart 302 and the second adapter counterpart 350, and iv) decoupling the first adapter counterpart 302 and the second adapter counterpart 350.

In some embodiments, for example, the object manipulator 101 includes an end effector 200 that is connected to the robot arm 110, as depicted in FIG. 3 to FIG. 19. In some embodiments, for example, while the first adapter counterpart 302 is being displaced relative to the second adapter counterpart 350 for disposing the first adapter counterpart 302 and the second adapter counterpart 350 in operable communication, if there is misalignment between the first adapter counterpart 302 and the second adapter counterpart 350, the end effector 200 is configured to allow for displacement of the first adapter counterpart 302, relative to the second adapter counterpart 350, such that the first adapter counterpart 302 becomes aligned with the second adapter counterpart 350 for disposition of the first adapter counterpart 302 and the second adapter counterpart 350 in operable communication.

As depicted in FIG. 15 to FIG. 19, the end effector 200 includes a first frame 202, a second frame 204, a first spring assembly 210 comprising springs 212 for connecting the second frame 204to the fixture or gripper 230, a second spring assembly 220 comprising springs 222, and an actuator 242, for example, a linear actuator 242.

As depicted in FIG. 16, the first spring assembly 210 connects the second frame 204 to the gripper 230. As depicted, the first spring assembly 210 comprises one or more springs 210, for example, four springs 210. The spring assembly 210 biases the gripper 230 to a central position, as depicted in FIG. 15 to FIG. 17. As depicted, two springs 210 are disposed in the vertical orientation, and two springs 210 are disposed in the horizontal orientation. In response to a force applied to the gripper 230 in the vertical direction, the two springs 210 disposed in the vertical orientation allow for the gripper 230 and the frame 204 to displace relative to each other in the vertical direction, for example, upward or downward direction. In some embodiments, for example, the relative displacement is the displacement of the gripper 230 relative to the frame 204. In some embodiments, for example, the relative displacement is the displacement of the frame 204 relative to the gripper 230. In response to a force applied to the gripper 230 in the horizontal direction, the two springs 210 disposed in the horizontal orientation allow for the gripper 230 and the frame 204 to displace relative to each other in the horizontal direction. In some embodiments, for example, the relative displacement is the displacement of the gripper 230 relative to the frame 204. In some embodiments, for example, the relative displacement is the displacement of the frame 204 relative to the gripper 230. Accordingly, in some embodiments, for example, the spring assembly 210 allows for the gripper 230 to displace relative to the frame 202 about two degrees of freedom, for example, about a two-dimensional plane extending through the frame 204, as depicted in FIG. 18.

As depicted in FIG. 15, the second spring assembly 220 connects the first frame 202 and the second frame 204. As depicted, the second spring assembly 220 comprises one or more springs 222, for example, four springs 222. The spring assembly 220 biases the first frame 202 and the second frame 204 such that the first frame 202 and the second frame 204 are disposed in alignment, as depicted in FIG. 15 and FIG. 16. In response to a force applied to the gripper 230, the springs 222 allow the first frame 202 and the second frame 204 to rotate relative to each other, for example, rotate about a longitudinal axis (e.g. roll), a lateral axis (e.g. pitch), a vertical axis (e.g. yaw), or a combination thereof. In some embodiments, for example, the relative displacement is displacement of the first frame 202 relative to the second frame 204. In some embodiments, for example, the relative displacement is displacement of the second frame 204 relative to the first frame 202. In some embodiments, for example, the relative displacement is effected by displacement of both of the first frame 202 and the second frame 204. As depicted in FIG. 19, the second frame 204 is rotated relative to the first frame 202 about a lateral axis. Accordingly, in some embodiments, for example, the spring assembly 220 is configured to enable the gripper 230 to displace relative to the frame 204 about three degrees of freedom.

In some embodiments, for example, the end effector 200 is configured to enable the gripper 230, and the first adapter counterpart 302, while the first adapter counterpart 302 is releasably coupled to the gripper 230, to displace about five degrees of freedom. In some embodiments, for example, the apparatus 100 effects displacement of the end effector 200 along the longitudinal axis. Together, the apparatus 100 and the end effector 200 is configured to enable the gripper 230, and the first adapter counterpart 302, while the first adapter counterpart 302 is releasably coupled to the gripper 230, to displace about six degrees of freedom.

In some embodiments, for example, the coupling of the gripper 230 to the robot arm 110, for example, via the end effector 200, is with effect that the gripper 230 is displaceable relative to the robot arm 110, such that the coupling relationship between the gripper 230 and the robot arm 110 is a relative movement-permissive coupling relationship. In some embodiments, for example, the relative movement is permitted by the first spring assembly 210 and the second spring assembly 220.

In some embodiments, for example, the coupling of the gripper 230 to the end effector 200 is with effect that the gripper 230 is displaceable relative to the end effector 200, such that the coupling relationship between the gripper 230 and the end effector 200 is a relative movement-permissive coupling relationship. In some embodiments, for example, the relative movement is permitted by the first spring assembly 210 and the second spring assembly 220.

In some embodiments, for example, the gripper 230 is coupled to the end effector 200, and the gripper 230, the end effector 200, and the robot arm 110 are co-operatively configured such that: the displaceability of the gripper 230, relative to the robot arm 110, is effectuated via the displaceability of the end effector 200 relative to the robot arm 110.

In some embodiments, for example, the gripper 230 is coupled to the end effector 200, and the gripper 230, the end effector 200, and the robot arm 110 are co-operatively configured such that: the displaceability of the gripper 230, relative to the robot arm 110, is effectuated via the displaceability of the gripper 230 relative to the end effector 200.

The gripper 230 includes the first connector counterpart 232, which includes the guide pin 234 and the receiving port 236, that are co-operatively configured with the second connector counterpart 314, which includes the guide pin 316 and the receiving port 318, to releasably couple the gripper 230 and the first adapter counterpart 302.

In some embodiments, for example, the actuator assembly 106 includes the linear actuator 242. While the gripper 230 and the first adapter counterpart 302 are releasably coupled via the first connector counterpart 232 and the second connector counterpart 314, in response to activation of the linear actuator 242, for example, by the controller 102, the coupling of the first connector counterpart 232 and the second connector counterpart 314 is defeated, such that the coupling of the gripper 230 and the first adapter counterpart 302 is defeated.

FIG. 20 and FIG. 21 depict an alternate embodiment of the end effector 200. The end effector 200A depicted in FIG. 20 and FIG. 21 substantially corresponds to the end effector 200 depicted in FIG. 15 or FIG. 19, except the first spring assembly 210 of the end effector 200A does not include the two springs 212 disposed in the vertical orientation, and includes a plate 224. Due to the absence of the two springs 212 disposed in the vertical orientation, in response to a force applied to the gripper 230 in the vertical orientation, there is a substantial absence of vertical displacement of the gripper 230. In some embodiments, for example, the flexibility of the two springs 212 disposed in the horizontal orientation allows for limited vertical displacement of the gripper 230. In some embodiments, for example, the plate 224 is configured to prevent vertical displacement of the gripper 230, and permit horizontal displacement of the gripper 230. In some embodiments, for example, the end effector 200A allows the gripper 230 to displace about four degrees of movement, namely, displacement along a lateral axis (e.g. horizontal direction), and rotation about a longitudinal axis, a lateral axis, and a vertical axis.

In some embodiments, for example, while the gripper 230 is coupled to the first adapter counterpart 302, the first adapter counterpart 302 is coupled to the end effector 200, such that a coupled end effector 200 is established. In some embodiments, for example, while the gripper 230 is coupled to the gripper 230, a coupled object manipulator 101 is established. In some embodiments, for example, while the first adapter counterpart 302 is coupled to the gripper 230, the object manipulator 101 is configured to dispose the first adapter counterpart 302 and the second adapter counterpart 350 in an operable communication-effectible alignment, as depicted in FIG. 24, wherein the first adapter counterpart 302 and the second adapter counterpart 350 are disposed in an alignment relationship. In the aligned relationship, the first adapter counterpart 302 is disposed in alignment with the second adapter counterpart 350, for establishing connection between the first adapter counterpart and the second adapter counterpart 350, via displacement of the first adapter counterpart 302 towards the second adapter counterpart 350. Operable communication between the first adapter counterpart 302 and the second adapter counterpart 350 is effected in response to connection of the first adapter counterpart 302 and the second adapter counterpart 350. In some embodiments, for example, while first adapter counterpart 302 and the second adapter counterpart 350 are disposed in the operable communication-effectible alignment, the first adapter counterpart 302 and the second adapter counterpart 350 are aligned along an axis 3600. In some embodiments, for example, the axis 3600 is parallel to the central longitudinal axis of the trailer 12.

To couple the first adapter counterpart 302 and the second adapter counterpart 350, the detector 104 detects a signal for the apparatus 100 to initiate the coupling process, for example, a signal provided by an operator of the towing vehicle 13, or a signal representative of the coupling of the towing vehicle 13 and the trailer 12, or a signal representative of an absence of coupling between the first adapter counterpart 302 and the second adapter counterpart 350. The controller 102 sends a control command to the actuator assembly 106 to displace the gripper 230 via the robot arm 110, wherein the gripper 230 is coupled to the first adapter counterpart 302, such that the first adapter counterpart 302 is displaced towards the second adapter counterpart 350. With the towing vehicle 13 and the trailer 12 in alignment, the first adapter counterpart 302 is also aligned with the second adapter counterpart 350. Accordingly, in response to displacement of the first adapter counterpart 302 towards the second adapter counterpart 350, the receivable portion 306 of the first adapter counterpart 302 is received in the channel 354. The guide pins 312 of the first adapter counterpart 302 are received into the guide ports 3120 of the second adapter counterpart 350 to guide the displacement of the first adapter counterpart 302 relative to the second adapter counterpart. In response to further displacement of the first adapter counterpart 302 towards the second adapter counterpart 350, the receivable portion 306 is inserted into the channel 354, and the electrical connectors 308 are received in the electrical ports 3080, and the fluid connectors 310 are received in the fluid ports 3100, which effects: (i) electrical communication between the trailer communicator-defined electrical conductor 1204 and the towing vehicle communicator-defined electrical conductor 1304, and (ii) fluid communication between the trailer communicator-defined fluid conductor 1202 and the towing vehicle communicator-defined fluid conductor 1302. This effects establishment of: (i) electrical communication between the electrical source of the towing vehicle 13 and the electrical system of the trailer 12, and (ii) fluid communication between the pneumatic air source of the towing vehicle 13 and the pneumatic air system of the trailer 12.

In some embodiments, for example, the detector 104 is configured to detect a signal to initiate coupling of the first adapter counterpart 302 and the second adapter counterpart 350. In some embodiments, for example, the controller 102, the detector 104, the actuator assembly 106, the robot arm 110, the first adapter counterpart 302, the second adapter counterpart 350, the trailer communicator 120, and the towing vehicle communicator 130 are co operatively configured such that: (i) while the object manipulator 101 is disposed in the coupled relationship with the first adapter counterpart 302, for example, via the coupling of the first adapter counterpart 302 to the gripper 230, the controller 102 activates the actuator assembly 106 to actuate the robot arm 110 with effect that the first adapter counterpart 302 becomes emplaced in coupling proximity to the second adapter counterpart 350; and (ii) while the first adapter counterpart 302 is disposed in coupling proximity to the second adapter counterpart 350, the controller 102 activates the actuator assembly 106 to displace the first adapter counterpart 302 towards the second adapter counterpart 350, for effecting the coupling of the first adapter counterpart 302 and the second adapter counterpart 350, such that the first adapter counterpart 302 becomes disposed in operable communication with the second adapter counterpart 350. In some embodiments, for example, the robot arm 110 displaces the first adapter counterpart 302 such that the first adapter counterpart 302 is inserted in the channel 354 of the guide 352. In some embodiments, for example, the electrical connectors 308 are received in the electrical ports 3080, such that the trailer communicator-defined electrical conductor 1204 and the towing vehicle communicator-defined electrical conductor 1304 are disposed in electrical communication, and that the electrical system of the trailer 12 is disposed in electrical communication with the electrical energy source of the towing vehicle 13 via the adapter 300, the trailer communicator-defined electrical conductor 1204 and the towing vehicle communicator-defined electrical conductor 1304. In some embodiments, for example, the fluid connectors 310 are received in the fluid ports 3100, such that the trailer communicator-defined fluid conductor 1202 and the towing vehicle communicator-defined fluid conductor 1302 are disposed in fluid communication such that the trailer communicator 120 and the towing vehicle communicator 130 are disposed in fluid communication, and that the pneumatic air system of the trailer 12 is disposed in fluid communication with the pneumatic air source of the towing vehicle 13 via the adapter 300, the trailer communicator-defined fluid conductor 1202 and the towing vehicle communicator-defined fluid conductor 1302.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the linear actuator 242 to decouple the gripper 230 from the first adapter counterpart 302, and the controller 102 activates the actuator assembly 106 to displace the object manipulator 101 outside of a swing radius 5000 of the trailer 12.

In some embodiments, for example, the detector 104 detects a signal representative of the releasable coupling of the first adapter counterpart 302 and the second adapter counterpart 350, and, in response to the detection, the controller 102 stops further displacement of the gripper 230 towards the second adapter counterpart 350. Then, the controller 102 activates the linear actuator 242 to decouple the gripper 230 from the first adapter counterpart 302, and the controller 102 activates the actuator assembly 106 to displace the object manipulator 101 outside of a swing radius 5000 of the trailer 12.

In some embodiments, for example, after the first adapter counterpart 302 and the second adapter counterpart 350 are releasably coupled, and the gripper 230 is decoupled from the first adapter counterpart 302, the object manipulator 101 is displaced outside of a swing radius 5000 of the trailer 12. At this point, in some embodiments, for example, the towing vehicle 13 can tow the trailer 12. In some embodiments, for example, while the towing vehicle 13 and the trailer 12 are in a truck yard, the fifth wheel lifting boom 2504 is actuated, for example, by the controller 102, to raise the trailer 12, as depicted in FIG. 30 and FIG. 31, for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350, the detector 104 detects a signal for the apparatus 100 to initiate the decoupling process, for example, a signal provided by an operator of the towing vehicle 13, or a signal representative of the coupling of the towing vehicle 13 and the trailer 12, or a signal representative of the coupling between the first adapter counterpart 302 and the second adapter counterpart 350. The controller 102 second a control command to the actuator assembly 106 to displace the gripper 230 such that the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232, with effect that the gripper 230 is coupled to the first adapter counterpart 302. In some embodiments, for example, the displacement of the gripper 230, relative to the first adapter counterpart 302, is guided by the prongs 240 of the gripper 230 and the guide ports 322 of the first adapter counterpart 302. Then, the controller 102 sends a control command to the actuator assembly 106 to displace the gripper 230 away from the second adapter counterpart 350 to retract the robot arm 110 and displace the first adapter counterpart 302 away from the second adapter counterpart 350, with effect that the operable communication between the first adapter counterpart 302 and the second adapter counterpart 350 is defeated, and displace the object manipulator 101 outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, the towing vehicle 13 and the trailer 12 are not aligned, as depicted in FIG. 22 to FIG. 24. In some embodiments, for example, the first adapter counterpart 302 and the second adapter counterpart 350 are co-operatively disposed in a misaligned relationship, wherein, in the misaligned relationship, there is an absence of alignment between the first adapter counterpart 302 and the second adapter counterpart 350. In some embodiments, for example, the misalignment of the first adapter counterpart 302 and the second adapter counterpart 350 is due to the misalignment of the towing vehicle 13 and the trailer 12. While the first adapter counterpart 302 and the second adapter counterpart 350 are misaligned, to couple the first adapter counterpart 302 and the second adapter counterpart 350, in response to the detected signal to initiate the coupling process, the apparatus 100 displaces the gripper 230, via the robot arm 110, while the gripper 230 is coupled to the first adapter counterpart 302, such that the first adapter counterpart 302 is displaced towards the second adapter counterpart 350. Due to the misalignment of the towing vehicle 13 and the trailer 12, the displacement of the first adapter counterpart 302 towards the second adapter counterpart 350 is with effect that the first adapter counterpart, 302, for example, the receivable portion 306 of the housing 304, is disposed proximate to, or disposed in engagement with, the guide 352, for example, with the funnel 358, instead of being received in the channel 354. In some embodiments, for example, while the first adapter counterpart, 302, for example, the housing 304, is disposed proximate to, or disposed in engagement with, the guide 352, for example, with the funnel 358, the first adapter counterpart 302, for example, the housing 304, is disposed in a guiding-effective relationship with the guide 352, for example, with the funnel 358.

In some embodiments, for example, while the first adapter counterpart 302 is disposed in engagement with the guide 352, a surface configuration counterpart of the first adapter counterpart 302 is disposed in engagement with a second surface counterpart of the guide 352. In some embodiments, for example, the surface configuration counterpart of the first adapter counterpart 302 is defined by a surface of the first adapter counterpart 302, for example, by the receivable portion 306 of the housing 304. In some embodiments, for example, the surface configuration counterpart of the guide 352 is defined by a surface of one or more of the inclined walls 356 of the guide 352.

In response to further displacement of the first adapter counterpart 302 towards the second adapter counterpart 350 by the object manipulator 101, the first adapter counterpart 302, for example, the housing 304, applies a force on the funnel 358, and the funnel 358 applies a reaction force to the receivable portion 306. Due to the walls 356 of the funnel 358 that are inclined towards the channel 354, the reaction force applied by the funnel 358 on the receivable portion 306 has a direction towards the channel 354. In response to the reaction force from the funnel 358, the first adapter counterpart 302, the gripper 230, and the end effector 200 are co-operatively configured such that the first adapter counterpart 302 and the gripper 230 are displaced in the direction of the reaction force, namely, a direction towards the channel 354, as depicted in FIG. 23. In some embodiments, for example, the displacement is an alignment relationship-obtaining displacement of the gripper 230, relative to the second adapter counterpart 350, that is guidable, by the guide 352, for example, the funnel 358, wherein the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the displacement is vertical displacement, horizontal displacement, displacement along a longitudinal axis, rotation about the longitudinal axis, rotation about the lateral axis, rotation about the vertical axis, or a combination thereof. The displacement is effectible due to the spring assembly 210 and the spring assembly 220 of the end effector 200. In some embodiments, for example, the first surface configuration counterpart and the gripper 230 are co-operatively configured such that guiding of the displacement of the gripper 230 is effectible by co-operation between the first surface configuration counterpart and the second surface configuration counterpart defined by the guide 352 of the trailer 12.

In some embodiments, for example, in response to the displacement of the gripper 230 relative to the second adapter counterpart 350, the first adapter counterpart 302 is received in the channel 354, and the first adapter counterpart 302 and the second adapter counterpart 350 are disposed in alignment. In this respect, the displacement is an alignment relationship-obtaining displacement.

In some embodiments, for example, while the receivable portion 306 is received in the channel 354, the first adapter counterpart 302 and the second adapter counterpart 350 are not yet in alignment. Due to the misalignment of the first adapter counterpart 302 and the second adapter counterpart 350, the displacement of the first adapter counterpart 302 towards the second adapter counterpart 350 is with effect that the receivable portion 306 engages the channel wall 3542. In response to further displacement of the first adapter counterpart 302 towards the second adapter counterpart 350, the first adapter counterpart 302 applies a force on the channel wall 3542, and the channel wall 3542 applies a reaction force to the receivable portion 306. The reaction force applied by the channel wall 3542 on the receivable portion 306 has a direction towards the electrical ports 3080, fluid ports 3100, and guide ports 3120 of the second adapter counterpart 350. In response to the reaction force from the channel wall 3542, the first adapter counterpart 302 and the gripper 230 are co-operatively configured such that the first adapter counterpart 302 and the gripper 230 are displaced, relative to the robot arm 110, in the direction of the reaction force, namely, a direction towards the electrical ports 3080, fluid ports 3100, and guide ports 3120 of the second adapter counterpart 350, such that the receivable portion 306 becomes disposed in alignment with the channel 354, and the first adapter counterpart 302 is disposed in alignment with the second adapter counterpart 350, as depicted in FIG. 24. In some embodiments, for example, the displacement is vertical displacement, horizontal displacement, displacement along a longitudinal axis, rotation about the longitudinal axis, rotation about the lateral axis, rotation about the vertical axis, or a combination thereof. The displacement is effectible due to the spring assembly 210 and the spring assembly 220 of the end effector 200. In such embodiments, for example, the alignment relationship-obtaining displacement of the gripper 230 is defined by a first displacement and the second displacement, wherein the first displacement is the displacement of the gripper 230 effected by the funnel 358, and the second displacement is the displacement of the gripper 230 effected by the channel 354.

The first adapter counterpart 302 and the second adapter counterpart 350 are co-operatively configured such that, in response to emplacement of the first adapter counterpart 302 and the second adapter counterpart 350 in the alignment relationship, the first adapter counterpart 302 and the second adapter counterpart 350 become connected. In some embodiments, for example, the connection, obtained in response to the emplacement of the first adapter counterpart 302 and the second adapter counterpart 350 in the alignment relationship, is obtained autonomously. In some embodiments, for example, while the receivable portion 306 is received in the channel 354, the receivable portion 306 and the channel 354 are aligned, and the first adapter counterpart 302 and the second adapter counterpart 350 are disposed in operable communication in response to further displacement of the first adapter counterpart 302 towards the second adapter counterpart 350, for example, urging by the robot arm 110.

While the first adapter counterpart 302 and the second adapter counterpart 350 are disposed in alignment, in response to further displacement of the first adapter counterpart 302 towards the second adapter counterpart 350, the guide pins 312 of the first adapter counterpart 302 are received into the guide ports 3120 of the second adapter counterpart 350 to guide the displacement of the first adapter counterpart 302 towards the second adapter counterpart 350, and the receivable portion 306 is inserted into the channel 354, such that the electrical connectors 308 are received in the electrical ports 3080, and the fluid connectors 310 are received in the fluid ports 3100, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

At this point, the controller 102 stops further displacement of the gripper 230 towards the second adapter counterpart 350. Then, the controller 102 activates the linear actuator 242 to decouple the gripper 230 from the first adapter counterpart 302, and the controller 102 activates the actuator assembly 106 to displace the object manipulator 101 outside of a swing radius 5000 of the trailer 12. At this point, in some embodiments, for example, the trailer 12 is towable by the towing vehicle 13. In some embodiments, for example, the fifth wheel lifting boom 2504 is actuated to raise the trailer 12 for displacement of the trailer 12 by the towing vehicle 13 about a truck yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350 while the towing vehicle 13 and the trailer 12 are misaligned, the detector 104 detects a signal for the apparatus 100 to initiate the decoupling process. The controller 102 second a control command to the actuator assembly 106 to displace the gripper 230 towards the first adapter counterpart 302 (which is coupled to the second adapter counterpart 350), with effect that the gripper 230 engages the funnel 358 and the channel walls 3542, as described herein with respect to the first adapter counterpart 302. The funnel 358 and the channel walls 3542 apply reaction forces to the end effector 200 to effect alignment relationship-obtaining displacement of the gripper 230 such that the gripper 230 is aligned with the first adapter counterpart 302 that is received in the channel 354 and coupled with the second adapter counterpart 350. As a result of this alignment, in response to further displacement of the gripper 230 towards the second adapter counterpart 350, the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232, with effect that the gripper 230 is coupled to the first adapter counterpart 302. In some embodiments, for example, the displacement of the gripper 230, relative to the first adapter counterpart 302, is guided by the prongs 240 of the gripper 230 and the guide ports 322 of the first adapter counterpart 302. Then, the controller 102 sends a control command to the actuator assembly 106 to displace the gripper 230 away from the second adapter counterpart 350 to displace the first adapter counterpart 302 away from the second adapter counterpart 350, with effect that the operable communication between the first adapter counterpart 302 and the second adapter counterpart 350 is defeated, and displaces the object manipulator 101 outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, the apparatus 100 is connected to a particular position of the frame of a towing vehicle 13, and the second adapter counterpart 350 is connected to a particular position on a trailer 12, such that, while the towing vehicle 13 is coupled to the trailer 12, the relative position of the apparatus 100 and the second adapter counterpart 350 is the same across towing vehicles 13 of different models and trailers 12 of different models. This simplifies the design of the object manipulator 101 and the apparatus 100, as the movement of the object manipulator 101 to displace the first adapter counterpart 302 to the second adapter counterpart 350 is the same, for the apparatus 100 and the second adapter counterpart 350, despite being installed on towing vehicles 13 and trailers 12 of different models.

In some embodiments, for example, the first adapter counterpart 302 is displaced by the object manipulator 101 in a direction that is parallel to a longitudinal axis to insert the receivable portion 306 into the channel 354 and effect alignment of the first adapter counterpart 302 and the second adapter counterpart 350. In some embodiments, for example, the first adapter counterpart 302 is inserted into the second adapter counterpart 350 to effect disposition of the first adapter counterpart 302 and the second adapter counterpart 350 in operable communication. In some embodiments, for example, there is an absence of rotation of the first adapter counterpart 302 relative to the second adapter counterpart 350 to effect disposition of the first adapter counterpart 302 and the second adapter counterpart 350 in operable communication.

In some embodiments, for example, the alignment of the first adapter counterpart 302 relative to the second adapter counterpart 350 is not effected by adjustment in the disposition of the arm segments 1102 of the robot arm 110 prior to displacement of the first adapter counterpart 302 towards the second adapter counterpart 350, and also not effected by an adjustment in the displacement path of the end effector 200. Instead, in some embodiments, for example, the alignment of the first adapter counterpart 302 relative to the second adapter counterpart 350 is effected by the spring assemblies 210 and 220 of the end effector 200 and the funnel 358, channel walls 3542, and housing 304 of the first adapter counterpart 302, while the first adapter counterpart 302 is displaced towards the second adapter counterpart 350. This allows for simpler and more cost-effective design of the robot apparatus 100. In some embodiments, for example, the complexity of the movement of the robot apparatus 100 is reduced. In some embodiments, for example, the need for robot vision, fiducials that are detectable by sensors, and the like, to determine the positioning of the first adapter counterpart 302 and movement of the object manipulator 101 of the connection apparatus 100 is reduced. In some embodiments, for example, the movement of the object manipulator 101 for coupling the first adapter counterpart 302 to the second adapter counterpart 350 is substantially the same each time the coupling is to be effected. In some embodiments, for example, the movement of the object manipulator 101 for decoupling the first adapter counterpart 302 to the second adapter counterpart 350 is substantially the same each time the coupling is to be effected. In some embodiments, for example, the movement of the object manipulator 101 for coupling the first adapter counterpart 302 to the second adapter counterpart 350 is substantially the same as the movement of the object manipulator 101 for decoupling the first adapter counterpart 302 to the second adapter counterpart 350.

FIG. 25 to FIG. 31 depict an apparatus 2500 that is an alternate embodiment of the apparatus 100 for releasably coupling and decoupling the first adapter counterpart 302 and the second adapter counterpart 350. As depicted, in some embodiments, for example, the apparatus 2500 is a scissor-style apparatus. As depicted, the apparatus 2500 is similar to the apparatus 100 as described herein, except the apparatus 2500 is configured to align the first adapter counterpart 302 and the second adapter counterpart 350 along an axis that is parallel to a vertical axis, and further configured to displace the first adapter counterpart 302 in a vertical direction to releasably couple the first adapter counterpart 302 and the second adapter counterpart 350, such that the first adapter counterpart 302 and the second adapter counterpart 350 are disposed in operable communication. In some embodiments, for example, the end effector of the apparatus 2500 can be either the end effector 200 or the end effector 200A as described herein.

In some embodiments, for example, the apparatus 2500 includes a base 2502 that supports the object manipulator 101. In some embodiments, for example, the base 2502 is connected to the frame or to the fifth wheel lifting boom 2504 of the towing vehicle 13, such that the object manipulator 101 is slidable, via the actuator assembly 106, along a direction that is parallel to a longitudinal axis of the towing vehicle 13 (e.g. axis extending from the front to back of the towing vehicle 13). As depicted in FIG. 27, the base 2502 includes two guide rails 2506 to guide the sliding of the robot arm 110 in the longitudinal direction.

The object manipulator 101 is configurable, via the slidable connection of the base 2502 to the towing vehicle 13, such that the object manipulator 101 is displaceable, via the actuator assembly 106, between an actuation-ineffective position, as depicted in FIG. 25, and an actuation-ready position, as depicted in FIG. 26 and FIG. 27.

In some embodiments, for example, while the object manipulator 101 is disposed in the actuation-ineffective position, the object manipulator 101 is disposed outside the swing radius 5000 of the trailer 12. In some embodiments, for example, while the object manipulator 101 is disposed in the actuation-ineffective position, the object manipulator 101 is disposed at a first end of the base 2502 that is disposed relatively proximate to the towing vehicle 13 and relative distal from the trailer 12. While the object manipulator 101 is disposed in the actuation-ineffective position, alignment of the gripper 230 and the second adapter counterpart 350 for releasably coupling or decoupling of the first adapter counterpart 302 and the second adapter counterpart 350 is not effectible. While the first adapter counterpart 302 is releasably coupled to the gripper 230, and while the object manipulator 101 is disposed in the actuation-ineffective position, alignment of the first adapter counterpart 302 and the second adapter counterpart 350 for releasably coupling or decoupling of the first adapter counterpart 302 and the second adapter counterpart 350 is not effectible.

In some embodiments, for example, while the object manipulator 101 is disposed in the actuation-ready position, the object manipulator 101 is disposed at a second end of the base 2502 that is disposed relatively proximate to the trailer 12 and relative distal from the towing vehicle 13. While the object manipulator 101 is disposed in the actuation-ready position, the object manipulator 101 is disposed relative to the trailer 12 such that alignment of the gripper 230 and the second adapter counterpart 350 for releasably coupling or decoupling of the first adapter counterpart 302 and the second adapter counterpart 350 is effectible. While the first adapter counterpart 302 is releasably coupled to the gripper 230, and while the object manipulator 101 is disposed in the actuation-ready position, alignment of the first adapter counterpart 302 and the second adapter counterpart 350 for releasably coupling or decoupling of the first adapter counterpart 302 and the second adapter counterpart 350 is effectible.

In some embodiments, for example, the apparatus 2500 is mounted to a mounting-effective portion of a frame 2504 or fifth wheel lifting boom 2504 of the towing vehicle 13 is such that the relative position of the surface 11 and the mounting-effective portion for a given towing vehicle 13 and a given trailer 12 may vary. In some embodiments, for example, for a first towing vehicle 13, the fifth wheel coupling is positioned in a first position, and for a second towing vehicle 13, the fifth wheel coupling is positioned in a second position. In some embodiments, for example, for a first trailer 12, the kingpin is positioned in a first position, and for a second trailer 12, the kingpin is positioned in a second position. Accordingly, in some embodiments, for example, the mounting of the apparatus 2500 to the towing vehicle 13 is such that the relative position of the surface 11 and the mounting-effective portion of the frame 2504 or fifth wheel lifting boom 2504 is be different for: i) the first towing vehicle 13 coupled to the first trailer 12, i) the first towing vehicle 13 coupled to the second trailer 12, iii) the second towing vehicle 13 coupled to the first trailer 12, and iv) the second towing vehicle 13 coupled to the second trailer 12.

In some embodiments, for example, in order to dispose the object manipulator 101 in the actuation-ready position, despite potential differences in relative positioning of the surface 11 and the mounting-effective portion of the frame 2504 or fifth wheel lifting boom 2504, the detector 104 of the apparatus 2500 includes a proximity sensor 2510 or limit switch. As the object manipulator 101 is displaced from the actuation-ineffective position towards the surface 11, the sensor 2510 detects the proximity of the object manipulator 101 relative to the surface 11. In response to determination by the sensor 2510 or the controller 102 that a desired distance is established between the surface 11 and the object manipulator 101, the controller 102 sends a control command to the actuator assembly 106 to stop further displacement of the object manipulator 101 towards the trailer 12. At this point, the object manipulator 101 is disposed in the actuation-ready position for releasably coupling or decoupling the first adapter counterpart 302 and the second adapter counterpart 350.

In some embodiments, for example, as depicted in FIG. 29, the second adapter counterpart 350 is mounted to the guide 352, such that the second adapter counterpart 350 and the guide 352 are displaceable together. In some embodiments, for example, the mounting of the second adapter counterpart 350 to the guide 352 is such that the second adapter counterpart 350 is disposed within the guide 352. In some embodiments, for example, The second adapter counterpart 350 is mounted to the guide 352 such that an alignment relationship-obtaining displacement of the first adapter counterpart 302, relative to the second adapter counterpart 350, is guidable, by the guide 352, wherein the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350.

The second adapter counterpart 350is displaceable between a retracted position, as depicted in FIG. 25 and FIG. 31, and an extended position, as depicted in FIG. 26 to FIG. 30, via displacement of the guide 352. In some embodiments, for example, the releasable coupling of the first adapter counterpart 302 and the second adapter counterpart 350 is effective while the second adapter counterpart 350 is disposed in the retracted position, or while the second adapter counterpart 350 is disposed in the extended position. In some embodiments, for example, it is desirable to have certain clearance between the trailer 12 and the second adapter counterpart 350 to enable the releasably coupling the first adapter counterpart 302 and the second adapter counterpart 350. In such embodiments, for example, the second adapter counterpart 350 is displaced to the extended position prior to releasably coupling the first adapter counterpart 302 and the second adapter counterpart 350.

In some embodiments, for example, the apparatus 2500 includes an actuator 2520, one or more members 2522, and one or more frame members 2524, for displacing the second adapter counterpart 350 between the retracted position and the extended position. As depicted, the one or more frame members 2524 are connected to the guide 352, and the one or more members 2522 are connected to the frame members 2524 and the trailer 12, such that the second adapter counterpart 350 is connected to the trailer 12 via the one or more members 2522 and the one or more frame members 2524.

In some embodiments, for example, the actuator 2520 is activatable to displace the one or more members 2522 to displace the second adapter counterpart 350 between the retracted position and the extended position. In some embodiments, for example, the actuator 2520 is disposed in operable communication with the controller 102. In some embodiments, for example, the controller 102 is configured to activate the actuator 2520 to coordinate the displacement of the one or members 2522 and to effect the displacement of the second adapter counterpart 350 between the retracted position and the extended position. In some embodiments, for example, the actuator assembly 106 includes the actuator 2520.

In some embodiments, for example, the actuator 2520 includes a linear actuator. In some embodiments, for example, the actuator 2520 includes a rotating actuator. In some embodiments, for example, the actuator 2520 includes an electrical actuator. In some embodiments, for example, the actuator 2520 includes a pneumatic actuator. In some embodiments, for example, the actuator 2520 includes a hydraulic actuator. In some embodiments, for example, the displacement of the one or more members 2522 via activation of the actuator 2520 includes extension and retraction, displacement, rotation, and pivoting of the one or more members 2522.

In some embodiments, for example, the actuator 2520 is configured to send data representative of its operational state (e.g. activated, deactivated, or degree of activation) to the controller 102 for the controller 102 to control the operation of the one or more members 2522.

In some embodiments, for example, the actuator 2520 is mounted on the one or more members 2522 and are disposed in operable communication with the one or more members 2522.

In some embodiments, for example, the actuator 2520 is disposed in operable communication with a power source of the trailer 12.

In some embodiments, for example, the apparatus 2500 includes a casing 2530, and is disposable in a closed configuration, as depicted in FIG. 25 to FIG. 27 and FIG. 29, and an open configuration, as depicted in FIG. 28. In some embodiments, for example, the casing 2530 is pivotably coupled to the base 2502, and connected to the robot arm 110, for example, by a linkage. In such embodiments, for example, the casing 2530 is disposable in the closed configuration in response to retraction of the robot arm 110 to displace the end effector 200 towards the base 2520, and the casing 2530 is disposable in the open configuration in response to extension of the robot arm 110 to displace gripper 230 towards the second adapter counterpart 350. In some embodiments, for example, the casing 2530 has a first casing counterpart 2530A and a second casing counterpart 2530B. In some embodiments, for example, the first casing counterpart 2530A and the second casing counterpart 2530B are pivotably connected to a support 2532. In some embodiments, for example, in response to retraction of the robot arm 110 to displace the gripper 230 towards the base 2502, the first casing counterpart 2530A and the second casing counterpart 2530B pivot towards each to effect disposition of the casing 2530 in the closed configuration. In some embodiments, for example, in response to extension of the robot arm 110 to displace the gripper 230 towards the second adapter counterpart , the first casing counterpart 2530A and the second casing counterpart 2530B pivot away from each to effect disposition of the casing 2530 in the open configuration.

In some embodiments, for example, while the casing 2530 is disposed in the closed configuration, the object manipulator 101 received in the casing 2530. In some embodiments, for example, while the object manipulator 101 is received in the casing 2530, the casing 2530 protects the object manipulator 101 from the weather, the elements, dirt, and the like. In some embodiments, for example, while the object manipulator 101 is received in the casing 2530, the casing 2530 covers the object manipulator 101.

In some embodiments, for example, while the casing 2530 is disposed in the open configuration, the gripper 230 are displaceable towards the second adapter counterpart 350, for example, by extension of the robot arm 110, to effect releasable coupling or decoupling of the first adapter counterpart 302 and the second adapter counterpart 350.

To couple the first adapter counterpart 302 and the second adapter counterpart 350, the detector 104 detects a signal for the apparatus 2500 to initiate the coupling process, for example, a signal provided by an operator of the towing vehicle 13, or a signal representative of the coupling of the towing vehicle 13 and the trailer 12, or a signal representative of an absence of coupling between the first adapter counterpart 302 and the second adapter counterpart 350. While the object manipulator 101 is disposed in the actuation-ineffective position and releasably coupled with the first adapter counterpart 302 via the gripper 230, the controller 102 sends a control command to the actuator assembly 106 to displace the object manipulator 101, via the base 2502, towards the trailer 12. The sensor 2510 detects the distance between the object manipulator 101 and the surface 11 of the trailer 12. In response to detection that the object manipulator 101 is disposed relative to the surface 11 such that a desired distance is established between the object manipulator 101 and the surface, the controller 102 sends a control command to the actuator assembly 106 to stop displacement of the object manipulator 101. At this point, the object manipulator 101 is disposed in the actuation-ready position.

In some embodiments, for example, the controller 102 sends a control command to the actuator 2520 to displace the second adapter counterpart 350, via the one or more members 2522, from the retracted position to the extended position.

In some embodiments, for example, while the object manipulator 101 is disposed in the actuation-ready position, and the second adapter counterpart 350 is disposed in the extended position, the first adapter counterpart 302 is disposed below the second adapter counterpart 350. In some embodiments, for example, while the object manipulator 101 is disposed in the actuation-ready position, and the second adapter counterpart 350 is disposed in the extended position, the first adapter counterpart 302 and the second adapter counterpart 350 are disposed in alignment, for example, along an axis that is parallel to a vertical axis, for effecting releasable coupling of the first adapter counterpart 302 and the second adapter counterpart 350. In some embodiments, for example, while the object manipulator 101 is disposed in the actuation-ready position, and the second adapter counterpart 350 is disposed in the extended position, the receivable portion 306 of the first adapter counterpart 302 is disposed in alignment, for example, along an axis that is parallel to a vertical axis, with the channel 354.

At this point, in response to vertical displacement of the first adapter counterpart 302 towards the second adapter counterpart 350 by extension of the robot arm 110, the casing 2530 becomes disposed in the open configuration, and the receivable portion 306 is received in the channel 354, as depicted in FIG. 28. The guide pins 312 of the first adapter counterpart 302 are received into the guide ports 3120 of the second adapter counterpart 350 to guide the displacement of the first adapter counterpart 302 relative to the second adapter counterpart 350. In response to further vertical displacement of the first adapter counterpart 302 towards the second adapter counterpart 350 the receivable portion 306 is inserted into the channel 354, such that the electrical connectors 308 are received in the electrical ports 3080, and the fluid connectors 310 are received in the fluid ports 3100, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

In some embodiments, for example, the detector 104 is configured to detect a signal to initiate coupling of the first adapter counterpart 302 and the second adapter counterpart 350. In some embodiments, for example, the controller 102, the detector 104, the actuator assembly 106, the robot arm 110, the first adapter counterpart 302, the second adapter counterpart 350, the trailer communicator 120, and the towing vehicle communicator 130 are co operatively configured such that: (i) while the object manipulator 101 is disposed in the coupled relationship with the first adapter counterpart 302, for example, via the coupling of the first adapter counterpart 302 to the gripper 230, the controller 102 activates the actuator assembly 106 to actuate the robot arm 110, for example, extend the robot arm 110, with effect that the first adapter counterpart 302 becomes emplaced in coupling proximity to the second adapter counterpart 350; and (ii) while the first adapter counterpart 302 is disposed in coupling proximity to the second adapter counterpart 350, the controller 102 activates the actuator assembly 106 to displace the first adapter counterpart 302 towards the second adapter counterpart 350, for effecting the coupling of the first adapter counterpart 302 and the second adapter counterpart 350, such that the first adapter counterpart 302 becomes disposed in operable communication with the second adapter counterpart 350. In some embodiments, for example, the robot arm 110 displaces the first adapter counterpart 302 such that the first adapter counterpart 302 is inserted in the channel 354 of the guide 352. In some embodiments, for example, the electrical connectors 308 are received in the electrical ports 3080, such that the trailer communicator-defined electrical conductor 1204 and the towing vehicle communicator-defined electrical conductor 1304 are disposed in electrical communication, and that the electrical system of the trailer 12 is disposed in electrical communication with the electrical energy source of the towing vehicle 13 via the adapter 300, the trailer communicator-defined electrical conductor 1204 and the towing vehicle communicator-defined electrical conductor 1304. In some embodiments, for example, the fluid connectors 310 are received in the fluid ports 3100, such that the trailer communicator-defined fluid conductor 1202 and the towing vehicle communicator-defined fluid conductor 1302 are disposed in fluid communication such that the trailer communicator 120 and the towing vehicle communicator 130 are disposed in fluid communication, and that the pneumatic air system of the trailer 12 is disposed in fluid communication with the pneumatic air source of the towing vehicle 13 via the adapter 300, the trailer communicator-defined fluid conductor 1202 and the towing vehicle communicator-defined fluid conductor 1302.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the linear actuator 242 to decouple the gripper 230 from the first adapter counterpart 302, and the controller 102 activates the actuator assembly 106 to retract the robot arm 110 such that the end effector 200 and gripper 230 are displaced towards the base 2502. The retraction of the robot arm 110 is with effect that the casing 2530 becomes disposed in the closed configuration, and the object manipulator 101 is received in the casing 2530, as depicted in FIG. 29. At this point, the controller 102 activates the actuator assembly 106 to displace the object manipulator 101, via the base 2502, away from the trailer 12, such that the object manipulator 101 is disposed in the actuation-ineffective position, outside of a swing radius 5000 of the trailer 12.

In some embodiments, for example, the detector 104 detects a signal representative of the releasable coupling of the first adapter counterpart 302 and the second adapter counterpart 350, and the controller 102 stops the displacement of the end effector 200 towards the second adapter counterpart 350. Then, the controller 102 activates the linear actuator 242 to decouple the gripper 230 from the first adapter counterpart 302, and the controller 102 activates the actuator assembly 106 to retract the robot arm 110 and displace the object manipulator 101 to the actuation-ineffective position, outside of a swing radius 5000 of the trailer 12.

In some embodiments, for example, after the first adapter counterpart 302 and the second adapter counterpart 350 are releasably coupled, and the gripper 230 is decoupled from the first adapter counterpart 302, the robot arm 110 is retracted and the object manipulator 101 is displaced to the actuation-ineffective position, the controller 102 sends a control command to the actuator 2520 to displace the second adapter counterpart 350 to the retracted position. At this point, in some embodiments, for example, the towing vehicle 13 can tow the trailer 12. In some embodiments, for example, while the towing vehicle 13 and the trailer 12 are in a truck yard, the fifth wheel lifting boom 2504 is actuated, for example, by the controller 102, to raise the trailer 12, as depicted in FIG. 30 and FIG. 31, for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350, the detector 104 detects a signal for the apparatus 2500 to initiate the decoupling process, for example, a signal provided by an operator of the towing vehicle 13, or a signal representative of the coupling of the towing vehicle 13 and the trailer 12, or a signal representative of the coupling between the first adapter counterpart 302 and the second adapter counterpart 350. The object manipulator 101 is displaced from the actuation-ineffective position to the actuation-ready position, and the second adapter counterpart 350 is displaced from the retracted position to the extended position. The robot arm 110 displaces the gripper 230 such that the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232, with effect that the gripper 230 is coupled to the first adapter counterpart 302. In some embodiments, for example, the displacement of the gripper 230, relative to the first adapter counterpart 302, is guided by the prongs 240 of the gripper 230 and the guide ports 322 of the first adapter counterpart 302. Then, the controller 102 sends a control command to the actuator assembly 106 to retract the robot arm 110 and displace the gripper 230 away from the second adapter counterpart 350 to displace the first adapter counterpart 302 away from the second adapter counterpart 350, with effect that the operable communication between the first adapter counterpart 302 and the second adapter counterpart 350 is defeated. At this point, the controller 102 sends a control command to the actuator 2520 to displace the second adapter counterpart 350 to the retracted position, and sends control command to the actuator assembly 106 to displace the object manipulator 101 to the actuation-ineffective position, outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, while the robot arm 110 is disposed in the actuation-ready position, and the second adapter counterpart 350 is disposed in the extended position, the first adapter counterpart 302 and the second adapter counterpart 350 are disposed in the misaligned relationship. In some embodiments, for example, the misalignment is due to misalignment of the towing vehicle 13 and the trailer 12 while the towing vehicle 13 and the trailer 12 are coupled together, for example, via the fifth wheel 15 and the kingpin.

In such embodiments, for example, in response to vertical displacement of the first adapter counterpart 302 towards the second adapter counterpart 350 by the object manipulator 101, the casing 2530 becomes disposed in the open configuration, and the first adapter counterpart 302 is displaced towards the second adapter counterpart 350. Due to the misalignment of the first adapter counterpart 302 and the second adapter counterpart 350, the displacement of the first adapter counterpart 302 towards the second adapter counterpart 350 is with effect that the receivable portion 306 is disposed in the guiding-effective relationship with the funnel 358, instead of being received in the channel 354. In response to further displacement of the first adapter counterpart 302 towards the second adapter counterpart 350, a reaction force is applied by the funnel 358 to the first adapter counterpart 302. In response to the reaction force from the funnel 358, the first adapter counterpart 302, the gripper 230, and the end effector 200 are co-operatively configured such that the first adapter counterpart 302 and the gripper 230 are displaced by the alignment relationship-obtaining displacement, such that the first adapter counterpart 302 and the second adapter counterpart 350become disposed in alignment, as described herein with respect to the apparatus 100.

While the first adapter counterpart 302 and the second adapter counterpart 350 disposed in alignment, in response to further displacement of the first adapter counterpart 302 towards the second adapter counterpart 350, the guide pins 312 of the first adapter counterpart 302 are received into the guide ports 3120 of the second adapter counterpart 350 to guide the displacement of the first adapter counterpart 302 towards the second adapter counterpart 350, and the receivable portion 306 is inserted into the channel 354, such that the electrical connectors 308 are received in the electrical ports 3080, and the fluid connectors 310 are received in the fluid ports 3100, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

At this point, the controller 102 stops further displacement of the gripper 230 towards the second adapter counterpart 350. Then, the controller 102 activates the linear actuator 242 to decouple the gripper 230 from the first adapter counterpart 302, and the controller 102 activates the actuator assembly 106 to retract the robot arm 110 and displace the object manipulator 101 to the actuation-ineffective position, and activates the actuator 2520 to displace the second adapter counterpart 350 to the retracted position. At this point, in some embodiments, for example, the trailer 12 is towable by the towing vehicle 13. In some embodiments, for example, the fifth wheel lifting boom 2504 is actuated to raise the trailer 12 for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350 while the first adapter counterpart 302 and the second adapter counterpart 350 are misaligned, the detector 104 detects a signal for the apparatus 100 to initiate the decoupling process. The controller 102 sends a control command to the actuator assembly 106 to displace the object manipulator 101 to the actuation-ready position, and sends a control command to the actuator 2520 to displace the second adapter counterpart 350 to the extended position. Then, the controller 102 sends a control command to the actuator assembly 106 for the object manipulator 101 to displace the gripper 230 towards the first adapter counterpart 302 (which is coupled to the second adapter counterpart 350), with effect that the gripper 230 engages the funnel 358 and the channel walls 3542, as described herein with respect to the first adapter counterpart 302. The funnel 358 and the channel walls 3542 apply reaction forces to the gripper 230 to effect alignment relationship-obtaining displacement of the gripper 230 such that gripper 230 is aligned with the first adapter counterpart 302 that is received in the channel 354 and coupled with the second adapter counterpart 350. As a result of this alignment, in response to further displacement of the gripper 230 towards the second adapter counterpart 350, the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232, with effect that the gripper 230 is coupled to the first adapter counterpart 302. In some embodiments, for example, the displacement of the gripper 230, relative to the first adapter counterpart 302, is guided by the prongs 240 of the gripper 230 and the guide ports 322 of the first adapter counterpart 302. Then, the controller 102 sends a control command to the actuator assembly 106 to displace the gripper 230 away from the second adapter counterpart 350 to displace the first adapter counterpart 302 away from the second adapter counterpart 350, with effect that the operable communication between the first adapter counterpart 302 and the second adapter counterpart 350 is defeated, retract the robot arm 110 such that the object manipulator 101 is received in the casing 2530, and displace the object manipulator 101 to the actuation-ineffective position outside of the swing radius 5000 of the trailer 12. Then, the controller 102 sends a control command to the actuator 2520 to displace the second adapter counterpart 350 to the retracted position. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

FIG. 32 to FIG. 37 depict an apparatus 3200 that is an alternate embodiment of the apparatus 100 for releasably coupling and decoupling the first adapter counterpart 302 and the second adapter counterpart 350. As depicted, in some embodiments, for example, the apparatus 3200 is a catapult-style apparatus. The apparatus 3200 is similar to the apparatus 100 as described herein, except the apparatus 3200 is configured to displace the first adapter counterpart 302 in an arcuate path, and then in a vertical direction, to releasably couple the first adapter counterpart 302 and the second adapter counterpart 350, such that the first adapter counterpart 302 and the second adapter counterpart 350 are disposed in operable communication.

The object manipulator 101, which includes the robot arm 110, and the base 3202 are co-operatively configured such that, while the towing vehicle 13 is releasably coupled to the trailer 12 via the fifth wheel coupling and the locking pin 14, the object manipulator 101 is displaceable, via the actuator assembly 106, between an actuation-ineffective position, wherein the first adapter counterpart 302 and the second adapter counterpart 350 are co-operatively disposed in a misaligned relationship, as depicted in FIG. 33, and an actuation-ready position, wherein the first adapter counterpart 302 and the second adapter counterpart 350 are co-operatively disposed in an aligned relationship, as depicted in FIG. 34.

As depicted in FIG. 38 to FIG. 42, in some embodiments, for example, the guide 352 is mounted on the trailer 12, for example, the front surface 11 of the trailer 12, which faces the towing vehicle 13, while the towing vehicle 13 and the trailer 12 are coupled. As depicted, in some embodiments, for example, while the guide 352 is mounted on the trailer 12, an outermost surface of the guide 352 is aligned with the surface 11 of the trailer 12. In some embodiments, for example, while the guide 352 is mounted on the trailer 12, the outermost surface of the guide 352 is flush with the surface 11 of the trailer 12.

As depicted in FIG. 32 to FIG. 42, in some embodiments, for example, while the second adapter counterpart 350 is mounted on the trailer 12, the electrical ports 3080, fluid ports 3100, and guide ports 3120 are facing in a downward direction.

As depicted in FIGS. 33 to 36, the guide 352 defines the channel 354 that is configured to receive a housing 3212 of the connection apparatus 3200. As depicted, the channel 354 is defined by the inclined channel walls 3542. As depicted, the channel 354 has a rectangular shape. In some embodiments, the channel 354 has a round shape, such as a circle or an oval, or a three-sided shape, four-sided shape, or a shape with more than four sides. The inclined channel walls 3542 are configured to guide or funnel the insertion of the housing 3212 into the channel 354 such that the first adapter counterpart 302 and the second adapter counterpart 350 become aligned for disposing the first adapter counterpart 302 and the second adapter counterpart 350 in operable communication.

As depicted in FIG. 32 to FIG. 42, in some embodiments, for example, while the second adapter counterpart 350 is mounted on the trailer 12, the second adapter counterpart 350 is disposed between the inclined channel walls 3542 of the guide 352.

In some embodiments, for example, while the object manipulator 101 is disposed in the actuation-ineffective position, the object manipulator 101 is disposed outside the swing radius 5000 of the trailer 12. While the object manipulator 101 is disposed in the actuation-ineffective position, the housing 3212 and the second adapter counterpart 350 are not disposed in alignment, such that releasably coupling or decoupling of the first adapter counterpart 302 and the second adapter counterpart 350 is not effectible. While the first adapter counterpart 302 is releasably coupled to the housing 3212, and while the object manipulator 101 is disposed in the actuation-ineffective position, the first adapter counterpart 302 and the second adapter counterpart 350 are not disposed in alignment, such that releasably coupling or decoupling of the first adapter counterpart 302 and the second adapter counterpart 350 is not effectible.

In some embodiments, for example, while the object manipulator 101 is disposed in the actuation-ready position, the object manipulator 101 is disposed relative to the trailer 12 such that the housing 3212 and the second adapter counterpart 350 are disposed in alignment, such that releasably coupling or decoupling of the first adapter counterpart 302 and the second adapter counterpart 350 is effectible. While the first adapter counterpart 302 is releasably coupled to the housing 3212, and while the object manipulator 101 is disposed in the actuation-ready position, the first adapter counterpart 302 and the second adapter counterpart 350 are disposed in alignment, such that releasably coupling or decoupling of the first adapter counterpart 302 and the second adapter counterpart 350 is effectible. In some embodiments, for example, while the object manipulator 101 is disposed in the actuation-ready position, an outer surface 32120 of the housing 3212 is disposed in opposing relationship with the trailer 12. In some embodiments, for example, while the object manipulator 101 is disposed in the actuation-ready position, the outer surface 32120 is engaged with an inner surface 17 of the guide 352, wherein the inner surface 17 is disposed between the inclined channel walls 3542 of the channel 354. In some embodiments, for example, while the object manipulator 101 is disposed in the actuation-ready position, the outer surface 32120 of the housing 3212 is flush against the surface 17 of the guide 352.

In some embodiments, for example, the arm segments 1102 of the robot arm 110 of the object manipulator 101 of the apparatus 3200 are pivotably connected, at a first end, to a base 3202. In some embodiments, for example, the controller 102 is configured to send a control command to the actuator assembly 106 to displace the object manipulator 101, with effect that the arm segments 1102 pivot about the base 3202. In some embodiments, for example, the displacement of the object manipulator 101 from the actuation-ineffective position to the actuation-ready position is displacement of the object manipulator 101 towards the trailer 12. In some embodiments, for example, the displacement of the object manipulator 101 from the actuation-ready position to the actuation-ineffective position is displacement of the object manipulator 101 away from the trailer 12. In some embodiments, for example, the displacement of the object manipulator 101 is along an arcuate path.

The robot arm 110 of the object manipulator 101 of the apparatus 3200 includes a crossbar 3204 that connects the second ends of the arm segments 1102 of the robot arm 110. An end effector 3210 of the object manipulator 101 is connected to the crossbar 3204.

In some embodiments, for example, the end effector 3210 is configured to releasably couple with the first adapter counterpart 302, for example, via an actuator 3214 that is housed in a housing 3212, such that the first adapter counterpart 302 is releasably couplable to the second adapter counterpart 350 via the apparatus 3200. In some embodiments, for example, while the first adapter counterpart 302 is being displaced relative to the second adapter counterpart 350 for disposing the first adapter counterpart 302 and the second adapter counterpart 350 in operable communication, if there is misalignment between the first adapter counterpart 302 and the second adapter counterpart 350, the end effector 3210 and housing 3212 are co-operatively configured such that an alignment relationship-obtaining displacement of the first adapter counterpart 302, relative to the second adapter counterpart 350, is effectible, such that the first adapter counterpart 302 becomes aligned with the second adapter counterpart 350 for disposition in operable communication.

In some embodiments, for example, the object manipulator 101 of the apparatus 3200 includes a first adapter counterpart fixture, for example, a housing 3212, and the housing 3212 is coupled to the end effector 3210. As depicted in FIG. 33 to FIG. 36, the housing 3212 is configured to releasably couple with the first adapter counterpart 302 and to house the actuator 3214.

In some embodiments, for example, the actuator 3214 is mounted to the housing 3212. In some embodiments, for example, the actuator 3214 is mounted to the end effector 3210 via mounting to the housing 3212. In some embodiments, for example, the actuator 3214 is configured to releasably couple with the first adapter counterpart 302. In some embodiments, for example, the actuator 3214 includes the first connector counterpart 232 for releasably coupling with the first adapter counterpart 302.

In some embodiments, for example, as depicted in FIG. 32 and FIG. 37, the first adapter counterpart 302 includes the plate 320. The first adapter counterpart 302 includes the second connector counterpart 314 that is mounted on the plate 320. The second connector counterpart 314 is configured to co-operate with the first connector counterpart 232 of the actuator 3214 for releasably coupling the first adapter counterpart 302 and the actuator 3214. In some embodiments, for example, the second connector counterpart 314 includes guide pins 316 and receiving ports 318, and the first connector counterpart 232 of the actuator 3214 includes guide pins 234 and receiving ports 236. The guide pins 234 of the first connector counterpart 234 are receivable in the receiving ports 318 of the second connector counterpart 314, and guide pins 316 of the second connector counterpart 314 are receivable in the receiving ports 236 of the first connector counterpart 232. The first connector counterpart 232 and the second connector counterpart 314 are co-operatively configured such that, in response to: (i) insertion of the guide pins 316 of the second connector counterpart 314 into the receiving port 236 of the first connector counterpart 232, and (ii) insertion of the guide pins 234 of the first connector counterpart 232 into the receiving port 318 of the second connector counterpart 314, the first connector counterpart 232 is releasably coupled to the second connector counterpart 314, such that the actuator 3214 is releasably coupled to the first adapter counterpart 302. In some embodiments, for example, the releasable coupling of the first connector counterpart 232 and the second connector counterpart 314 is effected by a latch, for example, one or more spring-loaded latches. In some embodiments, for example, the spring-loaded latch is disposed in one of the first connector counterpart 232 and the second connector counterpart 314, for example, the first connector counterpart 232. In some embodiments, for example, a spring-loaded latch is disposed in both of the first connector counterpart 232 and the second connector counterpart 314.

In some embodiments, for example, the plate 320 defines one or more guide ports 322 that are configured to receive the one or more prongs 240 of the actuator 3214. The one or more guide ports 322 and the one or more prongs 240 are co-operatively configured to guide the relative displacement of the first adapter counterpart 302 and the actuator 3214 to effect the releasable coupling of the first adapter counterpart 302 and the actuator 3214. The one or more guide ports 322 and the one or more prongs 240 are co-operatively configured such that, while the one or more prongs 240 are received in the one or more guide ports 322, the first adapter counterpart 302 and the actuator 3214 are disposed in alignment, for example, along an alignment axis.

In some embodiments, for example, the actuator 3214 includes the linear actuator 242. While the actuator 3214 and the first adapter counterpart 302 are releasably coupled via the first connector counterpart 232 and the second connector counterpart 314, in response to activation of the linear actuator 242, for example, by the controller 102, the coupling of the first connector counterpart 232 and the second connector counterpart 314 is defeated, such that the coupling of the actuator 3214 and the first adapter counterpart 302 is defeated.

In some embodiments, for example, the actuator 3214 is configured to extend outward and retract inward. In some embodiments, for example, while the actuator 3214 is releasably coupled with the first adapter counterpart 302, the actuator 3214 is activatable to displace the first adapter counterpart 302, relative to the housing 3212, for example, out of the housing 3212 via extension of the actuator 3214, or into the housing 3212 via retraction of the actuator 3214. In some embodiments, for example, the actuator 3214 is a linear actuator.

In some embodiments, for example, the actuator 3214 is activatable to control the apparatus 3200, for: i) releasably coupling the first adapter counterpart 302 and the second adapter counterpart 350, ii) releasing the first adapter counterpart 302 after the first adapter counterpart 302 is releasably coupled to the second adapter counterpart 350, iii) coupling with the first adapter counterpart 302 while the first adapter counterpart 302 is releasably coupled to the second adapter counterpart 350, or while there is an absence of coupling between the first adapter counterpart 302 and the second adapter counterpart 350, and iv) decoupling the first adapter counterpart 302 and the second adapter counterpart 350.

In some embodiments, the housing 3212 defines an opening 3216. In some embodiments, for example, the actuator 3214 is extendible and retractable through the opening 3216 to effect, for example, the releasable coupling of the first adapter counterpart 302 and the second counterpart, the releasing of the first adapter counterpart 302 after the first adapter counterpart 302 is releasably coupled to the second adapter counterpart 350, the coupling with the first adapter counterpart 302 while the first adapter counterpart 302 is releasably coupled to the second adapter counterpart 350, or while there is an absence of coupling between the first adapter counterpart 302 and the second adapter counterpart 350, and the decoupling the first adapter counterpart 302 and the second adapter counterpart 350.

In some embodiments, for example, as depicted in FIG. 33, after the housing 3212 is displaced towards the trailer 12 and the object manipulator 101 is disposed in the actuation-ready position, the second adapter counterpart 350 is disposed in opposing relationship relative to the opening 3216, such that the releasable coupling of the first adapter counterpart 302 and the second adapter counterpart 350, the releasing of the first adapter counterpart 302 after the first adapter counterpart 302 is releasably coupled to the second adapter counterpart 350, the coupling with the first adapter counterpart 302, and the decoupling the first adapter counterpart 302 and the second adapter counterpart 350, is effectible.

In some embodiments, for example, while the robot arm 110 is displacing the housing 3212 towards the trailer 12, gravitational forces acting on the housing 3212 effect pivoting of the housing 3212 relative to the crossbar 3204, with effect that the opening 3216 is directed upwards. In some embodiments, for example, while the object manipulator 101 is in the actuation-ready position, the opening 3216 is facing upwards.

As depicted in FIG. 33 to FIG. 36, the end effector 3210 includes a first spring assembly 3222 comprising springs 32220 disposed between the crossbar 3204 and the arm segments 1102 and extending in a direction parallel to the crossbar 3204. As depicted, the spring assembly 3222 comprises one or more springs 210, for example, two springs 32220. The spring assembly 3222 biases the housing 3212 to a central position. As depicted, the two springs 32220 are disposed in the horizontal orientation. In response to a force applied to the housing 3212 in the horizontal direction, the two springs 3222 disposed in the horizontal orientation allow for the housing 3212 and the arm segments 1102 to displace relative to each other in the horizontal direction. In some embodiments, for example, the relative displacement is the displacement of the housing 3212 relative to the arm segments 1102. Accordingly, in some embodiments, for example, the spring assembly 3222 allows for the housing 3212 to displace relative to the arm segments 1102 about one degree of freedom, for example, in the horizontal direction (i.e. lateral direction).

As depicted in FIG. 35, the housing 3212 includes a first plate 3224 and the end effector 3210 includes a second plate 3226. As depict in FIG. 32, the second plate 3226 is coupled to the crossbar 3204, and pivotably coupled to the first plate 3224, such that pivoting of the housing 3212, relative to the crossbar 3204, is effectible. In some embodiments, for example, as the object manipulator 101 transitions from the actuation-ineffective positon to the actuation-ready position and the outer surface 32120 of the housing 3212 becomes disposed in engagement with the inner surface 17 of the guide 352, the outer surface 32120 of the housing 3212 applies a force to the inner surface 17. In response to application of the force by the outer surface 32120 of the housing 3212 to the inner surface 17 of the guide 352, the inner surface 17 applies a reaction force to the housing 3212. In response to said reaction force, the housing 3212 rotates, relative to the crossbar 3204, due to the pivotable coupling of the housing 3212 relative to the crossbar 3204, such that the opening 3216 becomes disposed in opposing relationship with the second adapter counterpart 350, for example, for effecting coupling of the second adapter counterpart 350 and the first adapter counterpart 302. Accordingly, in some embodiments, for example, the pivotable coupling of the housing 3212 relative to the crossbar 3204 is such that the displacement of the housing 3212,relative to the crossbar 3204 about one degree of freedom, for example, rotation about an axis extending in a lateral direction, is effectible.

As depicted in FIG. 34 and FIG. 35, the end effector 3210 includes a second spring assembly 3228 for connecting the end effector 3210 and the housing 3212. In some embodiments, for example, the second spring assembly 3228 connects the first plate 3224 and the second plate 3226. As depicted, the second spring assembly 3228 comprises one or more springs 32280, for example, three springs 32280. In some embodiments, for example, the springs 32280 extend between the first plate 3224 and the second plate 3226. While two springs 32280 are depicted, in some embodiments, for example, the third spring 32280 is disposed at a bottom end and middle of the housing 3212, between the first plate 3224 and the second plate 3226. The spring assembly 3228 biases the first plate 3224 and the second plate 3226 such that the first plate 3224 and the second plate 3226 are disposed in alignment, as depicted in FIG. 34 and FIG. 35. In response to a force applied to the housing 3212, the springs 32280 allow the first plate 3224 and the second plate 3226 to rotate relative to each other, for example, rotate about a longitudinal axis (e.g. roll), a lateral axis (e.g. pitch), a vertical axis (e.g. yaw), or a combination thereof. In some embodiments, for example, the relative displacement is displacement of the first plate 3224 relative to the second plate 3226. In some embodiments, for example, the relative displacement is displacement of the second plate 3226 relative to the first plate 3224. In some embodiments, for example, the relative displacement is effected by displacement of both of the first plate 3224 and the second plate 3226. Accordingly, in some embodiments, for example, the spring assembly 3228 allows for the housing 3212 to displace relative to the arm segments 1102 about three degrees of freedom. In some embodiments, for example, the springs 32280 are sufficiently displaceable such that the springs 32280 such that they permit displacement of the housing 3212 with six degrees of freedom, for example, displacement in a direction parallel to the longitudinal axis, the lateral axis, or the vertical axis, or rotation about the longitudinal axis, the lateral axis, or the vertical axis.

In some embodiments, for example, the end effector 3210 allows the housing 3212, and the first adapter counterpart 302, while the first adapter counterpart 302 is releasably coupled to the actuator 3214, to displace about four degrees of freedom, via the spring assembly 3222 and the spring assembly 3228. In some embodiments, for example, the robot arm 110 effects displacement of the end effector 3210 about one degree of freedom, namely, towards and away from the trailer 12. In some embodiments, for example, the actuator 3214 effects displacement of the first adapter counterpart 302 about one degree of freedom, namely, vertical displacement of the first adapter counterpart 302. Together, the apparatus 3200 allows the first adapter counterpart 302 to displace about six degrees of freedom.

In some embodiments, for example, the coupling of the end effector 3210 to the robot arm 110 is with effect that the end effector 3210 is displaceable relative to the robot arm 110, such that the coupling relationship between the end effector 3210 and the robot arm 110 is a relative movement-permissive coupling relationship. In some embodiments, for example, the relative movement is permitted by the first spring assembly 3222 and the second spring assembly 3228.

In some embodiments, for example, the coupling of the housing 3212 to the end effector 3210 is with effect that the housing 3212 is displaceable relative to the end effector 3210, such that the coupling relationship between the housing 3212 and the end effector 3210 is a relative movement-permissive coupling relationship. In some embodiments, for example, the relative movement is permitted by the first spring assembly 3222 and the second spring assembly 3228.

In some embodiments, for example, the housing 3212 is coupled to the end effector 3210, and the housing 3212, the end effector 3214, and the robot arm 110 are co-operatively configured such that the displaceability of the housing 3212, relative to the robot arm 110, is effectuated via the displaceability of the end effector 3210 relative to the robot arm 110.

In some embodiments, for example, the housing 3212 is coupled to the end effector 3210, and the housing 3212, the end effector 3214, and the robot arm 110 are co-operatively configured such that the displaceability of the housing 3212, relative to the robot arm 110, is effectuated via the displaceability of the housing 3212 relative to the end effector 3210.

In some embodiments, for example, the apparatus 3200 is configured to align the first adapter counterpart 302 and the second adapter counterpart 350 to effect releasably coupling of the first adapter counterpart 302 and the second adapter counterpart 350 such that the first adapter counterpart 302 and the second adapter counterpart 350 are disposed in operable communication. In this respect, in some embodiments, for example, the housing 3212 includes a first surface configuration counterpart, for example, two side walls 3218, wherein each of the side walls 3218, independently, includes an inclined surface 3220, and the guide 352, for example, the channel 354, includes a second surface configuration counterpart, for example, inclined channel walls 3542, each inclined channel wall 3542 defining an inclined surface.

In some embodiments, for example, the first surface configuration counterpart and the housing 3212 are co-operatively configured such that guiding of the alignment relationship-obtaining displacement of the housing 3212 is effectible by co-operation between the first surface configuration counterpart defined by the housing 3212 and the second surface configuration counterpart defined by the guide 352 of the trailer 12.

As depicted in FIG. 33 to FIG. 36, the inclined surfaces 3220 of the side walls 3218 incline away from the center of the housing 3212, and the inclined surfaces of the channel walls 3542 are inclined towards the female adapter counterpart 350. In some embodiments, for example, the inclined surfaces 3220 of the side walls 3218 and the inclined surfaces of the channel walls 3542 are co-operatively configured to align the housing 3212 and the second adapter counterpart 350, for example, along a vertical axis, to effect, for example, the releasable coupling of the first adapter counterpart 302 and the second adapter counterpart 350. In some embodiments, for example, the inclined surfaces 3220 of the side walls 3218 and the inclined surfaces of the channel walls 3542 are co-operatively configured to align the first adapter counterpart 302 and the second adapter counterpart 350, for example, along a vertical axis, to effect, for example, the releasable coupling of the first adapter counterpart 302 and the second adapter counterpart 350. In some embodiments, for example, the inclined surfaces 3220 of the side walls 3218 and the inclined surfaces of the channel walls 3542 are co-operatively configured to center the housing 3212 and the second adapter counterpart 350, to effect, for example, the releasable coupling of the first adapter counterpart 302 and the second adapter counterpart 350. In some embodiments, for example, the inclined surfaces 3220 of the side walls 3218 and the inclined surfaces of the channel walls 3542 are co-operatively configured to center the first adapter counterpart 302 and the second adapter counterpart 350 to effect, for example, the releasable coupling of the first adapter counterpart 302 and the second adapter counterpart 350.

In some embodiments, for example, the towing vehicle 13 and the trailer 12 are disposed in alignment. In such embodiments, for example, to couple the first adapter counterpart 302 and the second adapter counterpart 350, the detector 104 detects a signal for the apparatus 3200 to initiate the coupling process, for example, a signal provided by an operator of the towing vehicle 13, or a signal representative of the coupling of the towing vehicle 13 and the trailer 12, or a signal representative of an absence of coupling between the first adapter counterpart 302 and the second adapter counterpart 350. While the object manipulator 101 is disposed in the actuation-ineffective position and releasably coupled with the first adapter counterpart 302 via the housing 3212, wherein the first adapter counterpart 302 and the second adapter counterpart 350 are co-operatively disposed in the misaligned relationship, the controller 102 sends a control command to the actuator assembly 106 to pivot the robot arm 110, via the base 3202, towards the trailer 12, until the outer surface 32120 of the housing 3212 engages the surface 17 of the guide 352. The detector 104 detects that the outer surface 32120 of the housing 3210 is engaged to the surface 17. In response to detection that the outer surface 32120 is engaged to the surface 17, the controller 102 sends a control command to the actuator assembly 106 to stop further displacement of the object manipulator 101. At this point, the object manipulator 101 is disposed in the actuation-ready position.

In some embodiments, for example, in response to disposition of the object manipulator 101 in the actuation-ready position, the housing 3212 is disposed between the channel walls 3542, and the first adapter counterpart 302 is disposed below the second adapter counterpart 350. In some embodiments, for example, while the object manipulator 101 is disposed in the actuation-ready position, the first adapter counterpart 302 and the second adapter counterpart 350 are disposed in alignment for effecting releasable coupling of the first adapter counterpart 302 and the second adapter counterpart 350 for establishing connection between the first adapter counterpart 302 and the second adapter counterpart 350. In some embodiments, for example, the first adapter counterpart 302 and the second adapter counterpart 350 are disposed in alignment along the axis 3600. In some embodiments, for example, the axis 3600 is parallel to a vertical axis.

At this point, the controller 102 sends a control command to the actuator 3214 to displace upwardly for urging connection of the first adapter counterpart 302 and the second adapter counterpart 350. In response to vertical displacement of the first adapter counterpart 302 towards the second adapter counterpart 350 by the actuator 3214, the guide pins 312 of the first adapter counterpart 302 are received into the guide ports 3210 of the second adapter counterpart 350 to guide the displacement of the first adapter counterpart 302 towards the second adapter counterpart 350. In response to further vertical displacement of the first adapter counterpart 302 towards the second adapter counterpart 350, the electrical connectors 308 become disposed in the electrical ports 3080, and the fluid connectors 310 become disposed in the fluid ports 3100, as depicted in FIG. 35 and FIG. 37, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the actuator 3214 to decouple from the first adapter counterpart 302, and the controller 102 activates the actuator assembly 106 to retract the actuator 3214 downward such that the actuator 3214 is displaced towards the housing 3212. The retraction of the actuator 3214 is with effect that the actuator 3214 is received in the housing 3212. At this point, as depicted in FIG. 36, the controller 102 activates the actuator assembly 106 to pivot the robot arm 110, via the base 3202, away from the trailer 12, such that the object manipulator 101 is disposed in the actuation-ineffective position, outside of a swing radius 5000 of the trailer 12.

In some embodiments, for example, the detector 104 detects a signal representative of the releasable coupling of the first adapter counterpart 302 and the second adapter counterpart 350, and, in response to the detection, the controller 102 stops further displacement of the actuator 3214 towards the second adapter counterpart 350. Then, the controller 102 activates the linear actuator 242 to decouple the actuator 3214 from the first adapter counterpart 302, and the controller 102 activates the actuator assembly 106 to retract the actuator 3214 and displace the object manipulator 101 to the actuation-ineffective position and outside of the swing radius 5000 of the trailer 12.

In some embodiments, for example, after the first adapter counterpart 302 and the second adapter counterpart 350 are releasably coupled, the actuator 3214 is retracted and the object manipulator 101 is displaced to the actuation-ineffective position and outside of the swing radius 5000 of the trailer 12, the trailer 12 can be towed by the towing vehicle 13. In some embodiments, for example, while the towing vehicle 13 and the trailer 12 are in a truck yard, the fifth wheel lifting boom 2504 is actuated, for example, by the controller 102, to raise the trailer 12, as depicted in FIG. 30 and FIG. 31, for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350, the detector 104 detects a signal for the apparatus 3200 to initiate the decoupling process, for example, a signal provided by an operator of the towing vehicle 13, or a signal representative of the coupling of the towing vehicle 13 and the trailer 12, or a signal representative of the coupling between the first adapter counterpart 302 and the second adapter counterpart 350. The robot arm 110 is pivoted to transition the object manipulator 101 from the actuation-ineffective position to the actuation-ready position, wherein the actuator 3214 is aligned with the first adapter counterpart 302, which is coupled to the second adapter counterpart 350. The controller 102 sends a control command to the actuator 3214 to displace the actuator 3214 towards the first adapter counterpart 302, such that the guide pins 316 of the second connector counterpart 314 are inserted into the receiving ports 236 of the first connector counterpart 232, thereby actuating the spring-loaded latch, with effect that the actuator 3214 is coupled to the first adapter counterpart 302. In some embodiments, for example, the displacement of the actuator 3214, relative to the first adapter counterpart 302, is guided by the prongs 240 of the actuator 3214 and the guide ports 322 of the first adapter counterpart 302. Then, the controller 102 sends a control command to the actuator 3214 to displace the actuator 3214 away from the second adapter counterpart 350 to displace the first adapter counterpart 302 away from the second adapter counterpart 350, with effect that the operable communication between the first adapter counterpart 302 and the second adapter counterpart 350 is defeated, and with further effect that the first adapter counterpart 302 is received in the housing 3212. At this point, the controller 102 sends a control command to the actuator assembly 106 to d the robot arm 110 to transition the object manipulator 101 to the actuation-ineffective position, outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, while the towing vehicle 13 is releasably coupled to the trailer 12, the towing vehicle 13 and the trailer 12 are misaligned.

In such embodiments, for example, in response to pivoting of the robot arm 110 towards the trailer 12 to transition the object manipulator 101 from the actuation-ineffective position to the actuation-ready position, due to the misalignment of the towing vehicle 13 and the trailer 12, the displacement of the object manipulator 101 towards the trailer 12 is with effect that one of the side walls 3218 of the housing 3212 becomes disposed proximate to, or becomes disposed in engagement with, a corresponding inclined surface of one of the channel walls 3542, instead of the housing 3212 being received between the channel walls 3542 of the guide 352. In some embodiments, for example, while the housing 3212 becomes disposed proximate to, or becomes disposed in engagement with, the guide 352, for example, the channel 354, the housing 3212 is disposed in a guiding-effective relationship with the guide 352.

In some embodiments, for example, while the housing 3212 is disposed in engagement with the guide 352, a surface configuration counterpart of the housing 3212 is disposed in engagement with a second surface counterpart of the guide 352. In some embodiments, for example, the surface configuration counterpart of the housing 3212 is defined by a surface of the housing 3212, for example, by the inclined surfaces 3220 of the side walls 3218. In some embodiments, for example, the surface configuration counterpart of the guide 352 is defined by a surface of one or more of the inclined surfaces of the channel wall 3542.

In response to further displacement of the object manipulator 101 towards the trailer 12, the inclined surface 3220 of the side wall 3218, applies a force on the inclined surface of the channel wall 3542, and the inclined surface of the channel wall 3542 applies a reaction force to the inclined surface 3220. Due to the inclination of the inclined surface 3220 of the side wall 3218 that are inclined away from the center of the housing 3212, and the inclination of the inclined surface of the channel wall 3542 that are inclined towards the second adapter counterpart 350, the reaction force applied by the inclined surface of the channel wall 3542 on the inclined surface 3220 has a direction towards the second adapter counterpart 350. In response to the reaction force from the inclined surface of the channel wall 3542, the housing 3212 is displaced in the direction of the reaction force, namely, a direction towards the second adapter counterpart 350. In some embodiments, for example, the displacement is an alignment relationship-obtaining displacement of the housing 3212, relative to the second adapter counterpart 350. In some embodiments, for example, the displacement is guidable, by the guide, 352 for example, the channel 354. In some embodiments, for example, the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the displacement includes vertical displacement, horizontal displacement, displacement along a longitudinal axis, rotation about the longitudinal axis, rotation about the lateral axis, rotation about the vertical axis, or a combination thereof. The alignment relationship-obtaining displacement is effectible due to the spring assembly 3222 and the spring assembly 3228 of the end effector 3210. In some embodiments, for example, the first surface configuration counterpart and the housing 3212 are co-operatively configured such that guiding of the alignment relationship-obtaining displacement of the housing 3212 is effectible by co-operation between the first surface configuration counterpart and the second surface configuration counterpart defined by the guide 352 of the trailer 12.

In response to the alignment relationship-obtaining displacement of the housing 3212, the object manipulator 101 becomes disposed in the actuation-ready position, wherein the housing 3212 is received between the channel walls 3542, the housing 3212 is disposed in engagement with the surface 17, and the first adapter counterpart 302 and the second adapter counterpart 350 are disposed in alignment. In some embodiments, for example, the first adapter counterpart 302 and the second adapter counterpart 350 are disposed in alignment along the axis 3600. In some embodiments, for example, the axis 3600 is parallel to a vertical axis.

In some embodiments, for example, while the housing 3212 is disposed in a guiding-effective relationship with the channel 354, the alignment relationship-obtaining displacement of the housing 3212 relative to the second adapter connection counterpart 350, is effectuated in response to urging by the robot arm 110.

While the housing 3212 is received between the channel walls 3542, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 3214.

In some embodiments, for example, the first adapter counterpart 302 and the second adapter counterpart 350 are co-operatively configured such that, in response to emplacement of the first adapter counterpart 302 and the second adapter counterpart 350 in the alignment relationship, the first adapter counterpart 302 and the second adapter counterpart 350 become connected. In some embodiments, for example, the connection, obtained in response to the emplacement of the first adapter counterpart 302 and the second adapter counterpart 350 in the alignment relationship, is obtained autonomously.

In some embodiments for example, the actuator 3214, the first adapter counterpart 302, and the second adapter counterpart 350 are co-operatively configured such that, in response to emplacement of the first adapter counterpart 302 and the second adapter counterpart 350 in the alignment relationship, the actuator 3214 urges connection of the first adapter counterpart 302 and the second adapter counterpart 350. In some embodiments for example, the connection is obtained autonomously.

While the first adapter counterpart 302 and the second adapter counterpart 350 are disposed alignment, in response to further displacement of the first adapter counterpart 302 towards the second adapter counterpart 350, for example, via the actuator 3214, the guide pins 312 of the first adapter counterpart 302 are received into the guide ports 3120 of the second adapter counterpart 350 to guide further displacement of the first adapter counterpart 302 towards the second adapter counterpart 350, such that the electrical connectors 308 are received in the electrical ports 3080, and the fluid connectors 310 are received in the fluid ports 3100, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

At this point, the controller 102 stops further displacement of the actuator 3214 towards the second adapter counterpart 350. Then, the controller 102 activates the actuator 3214 to decouple from the first adapter counterpart 302 and retract into the housing 3212, and the controller 102 activates the actuator assembly 106 to pivot the robot arm 110 to transition the object manipulator 101 to the actuation-ineffective position outside of the swing radius 5000 of the trailer 12. At this point, in some embodiments, for example, the trailer 12 is towable by the towing vehicle 13. In some embodiments, for example, the fifth wheel lifting boom 2504 is actuated to raise the trailer 12 for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350 while the towing vehicle 13 and the trailer 12 are misaligned, the detector 104 detects a signal for the apparatus 100 to initiate the decoupling process. The controller 102 sends a control command to the actuator assembly 106 to pivot the robot arm 110 to transition the object manipulator 101 to the actuation-ready position. The channel walls 3542 and the side walls 3218 are co-operatively configured to effect alignment relationship-obtaining displacement of the housing 3212 to dispose the housing 3212 between the channel walls 3542 and align the actuator 3214 and the first adapter counterpart 302 (which is coupled to the second adapter counterpart 350). Then, the controller 102 sends a control command to the actuator 3214 to displace the actuator 3214 towards the first adapter counterpart 302. In response to further displacement of the actuator 3214 towards the first adapter counterpart 302, the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232 , with effect that the actuator 3214 is coupled to the first adapter counterpart 302. In some embodiments, for example, the displacement of the actuator 3214, relative to the first adapter counterpart 302, is guided by the prongs 240 of the actuator 3214 and the guide ports 322 of the first adapter counterpart 302. Then, the controller 102 sends a control command to the actuator 3214 to displace the actuator 3214 away from the second adapter counterpart 350 to displace the first adapter counterpart 302 away from the second adapter counterpart 350, with effect that the operable communication between the first adapter counterpart 302 and the second adapter counterpart 350 is defeated, and with further effect that the first adapter counterpart 302 is received in the housing 3212. At this point, the controller 102 sends a control command to the actuator assembly 106 to pivot the robot arm 110 to transition the object manipulator 101 to the actuation-ineffective position, outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

As depicted in FIG. 38, an autonomous towing vehicle 13 can drive towards a parked trailer 12 to couple with the trailer 12, for example, via the fifth wheel coupling and kingpin. As depicted in FIG. 39, with the towing vehicle 13 coupled to the trailer 12, the first adapter counterpart 302 and the second adapter counterpart 350 are disposed in operable communication for actuating a vehicular operation, as depicted in FIG. 40, for example, by the apparatus 3200, such that (i) electrical communication between the electrical source of the towing vehicle 13 and the electrical system of the trailer 12 is established, for actuating a vehicular operation, and (ii) fluid communication between the pneumatic air source of the towing vehicle 13 and the pneumatic air system of the trailer 12 is established, for actuating a vehicular operation. After: (i) electrical communication between the electrical source of the towing vehicle 13 and the electrical system of the trailer 12 is established, and (ii) fluid communication between the pneumatic air source of the towing vehicle 13 and the pneumatic air system of the trailer 12 is established, the housing 3212 is decoupled from the first adapter counterpart 302, and the object manipulator 101 is transitioned from the actuation-ready position to the actuation-ineffective position, for effecting the disposition of the object manipulator 101 outside of the swing radius 5000 of the trailer 12, as depicted in FIG. 41. At this point, as depicted in FIG. 42, wherein the object manipulator 101 is disposed in the actuation-ineffective position, and the object manipulator 101 is disposed outside of the swing radius 5000 of the trailer 12, the towing vehicle 13 can tow the trailer 12, for example, about a truck yard. In some embodiments, for example, the towing of the trailer 12 by the towing vehicle 13 is effectible due to the establishment of electrical communication between the electrical source of the towing vehicle 13 and the electrical system of the trailer 12 and the establishment of fluid communication between the pneumatic air source of the towing vehicle 13 and the pneumatic air system of the trailer 12, as vehicular operation is actuatable. For example, during towing of the trailer 12 by the towing vehicle 13, the electrical system (e.g. ABS brakes and turn signals) and pneumatic air system (e.g. service brakes and parking brakes) are operable, to effect the towing of the trailer 12 by the towing vehicle 13, and to improve the safety of said towing.

In some embodiments, for example, after the towing vehicle 13 has towed the trailer 12 to a desired destination, the towing vehicle 13 can disconnect from the trailer 12 and drive elsewhere, for example, to tow another trailer 12. To do so, the object manipulator 101 is transitioned from the actuation-ineffective position to the actuation-ready position, and then the actuator 3214 is coupled with the first adapter counterpart 302. While the actuator 3214 is coupled to the first adapter counterpart 302, the actuator 3214 is retracted to decouple the first adapter counterpart 302 from the second adapter counterpart 350. Then, the object manipulator 101 is displaced to the actuation-ineffective position, such that the object manipulator 101 is disposed outside of the swing radius 5000 of the trailer 12. At this point, the controller 102 sends a control command to the fifth wheel coupling 15 to decouple from the kingpin. While the fifth wheel coupling 15 decoupled from the kingpin, such that the towing vehicle 13 is decoupled from the trailer 12, and while the first adapter counterpart 302 is decoupled from the second adapter counterpart 350 and coupled to the housing 3212, and the towing vehicle 13 can drive elsewhere.

FIG. 43 to FIG. 47 depict an apparatus 4300 that is an alternate embodiment of the apparatus 3200. The apparatus 4300 is similar to the apparatus 3200 as described herein, except, instead of the first spring assembly 3222, the second spring assembly 3228, and the second plate 3226, the end effector 3210 includes a ball joint assembly 4302 that is slidably connected to the crossbar 3204 to effect the displacement of the housing 3212, for example, the displacement relative to the robot arm 110, and to effect the alignment relationship-obtaining displacement of the housing 3212, relative to the second adapter counterpart 350.

As depicted, the ball joint assembly 4302 includes a ball joint 4304, a slider 4306, and a mounting bracket 4308.

As depicted in FIG. 45, the ball joint 4304 includes a head 43042 that is pivotably connected to a base 43044. As depicted in FIG. 43 to FIG. 47, the base 43044 is further connected to the slider 4306, which is slidably connected to the crossbar 3204, and the head 43042 is further connected to the mounting bracket 4308, which is connected to the housing 3212, for example, to the plate 3224 of the housing.

In response to a force applied to the housing 3212 in the horizontal direction, the ball joint assembly 4302, for example, the slider 4306, allows for the housing 3212 and the arm segments 1102 to displace relative to each other in the horizontal direction. In some embodiments, for example, the relative displacement is the displacement of the housing 3212 relative to the arm segments 1102. In some embodiments, for example, the relative displacement is sliding of the housing 3212 in a direction that is parallel to the longitudinal axis of the crossbar 3204. . In some embodiments, for example, the relative displacement is sliding of the housing 3212 along the crossbar 3204. Accordingly, in some embodiments, for example, the ball joint assembly 4302 allows for the housing 3212 to displace relative to the arm segments 1102 about one degree of freedom, for example, in the horizontal direction (i.e. lateral direction).

In response to a force applied to the housing 3212, the ball joint assembly 4302, for example, the mounting bracket 4308 that is connected to the housing 3212 and also connected to the pivoting head 43042, allow the housing 3212 and the robot arm 110 to rotate relative to each other, for example, rotate about a longitudinal axis (e.g. roll), a lateral axis (e.g. pitch), a vertical axis (e.g. yaw), or a combination thereof. In some embodiments, for example, the relative rotation is rotation of the housing 3212 relative to the robot arm 110. Accordingly, in some embodiments, for example, the ball joint assembly 4302 allows for the housing 3212 to rotate relative to the arm segments 1102 about three degrees of freedom. Accordingly, In some embodiments, for example, the ball joint assembly 4302 of the end effector 3210 allows the housing 3212, and the first adapter counterpart 302, while the first adapter counterpart 302 is releasably coupled to the actuator 3214, to displace about four degrees of freedom, in particular, sliding displacement relative to the crossbar 3204 along a lateral axis, and rotation about a longitudinal axis (e.g. roll), a lateral axis (e.g. pitch), and a vertical axis (e.g. yaw).

In some embodiments, for example, wherein the towing vehicle 13 and the trailer 12 are aligned, and the first adapter counterpart 302 is coupled to the actuator 3214, as the robot arm 110 transitions from the actuation-ineffective positon to the actuation-ready position and the outer surface 32120 of the housing 3212 becomes disposed in engagement with the inner surface 17 of the guide 352, the outer surface 32120 of the housing 3212 applies a force to the inner surface 17. In response to application of the force by the outer surface 32120 of the housing 3212 to the inner surface 17 of the guide 352, the inner surface 17 applies a reaction force to the housing 3212. In response to said reaction force, the housing 3212 slides, rotates, or a combination thereof, relative to the crossbar 3204, due to the coupling of the housing 3212 relative to the crossbar 3204 effected via the ball joint assembly 4302, such that the opening 3216 becomes disposed in opposing relationship with the second adapter counterpart 350, for example, for effecting alignment of the first adapter counterpart 302 and the second adapter counterpart 350 for coupling of the first adapter counterpart 302 and the second adapter counterpart 350.

In some embodiments, for example, while the towing vehicle 13 is releasably coupled to the trailer 12, the towing vehicle 13 and the trailer 12 are misaligned.

In such embodiments, for example, in response to displacement of the object manipulator 101 towards the trailer 12 from the actuation-ineffective position to the actuation-ready position, due to the misalignment of the towing vehicle 13 and the trailer 12, the displacement of the object manipulator 101 towards the trailer 12 is with effect that one of the side walls 3218 of the housing 3212 becomes disposed in the guiding effective relationship with a corresponding inclined surface of one of the channel walls 3542 instead of the housing 3212 being received between the channel walls 3542 of the guide 352. In response to further displacement of the object manipulator 101 towards the trailer 12, the inclined surface 3220 of the side wall 3218 applies a force on the inclined surface of the channel wall 3542, and the inclined surface of the channel wall 3542 applies a reaction force to the inclined surface 3220. Due to the inclination of the inclined surface 3220 of the side wall 3218 that are inclined away from the center of the housing 3212, and the inclination of the inclined surface of the channel wall 3542 that are inclined towards the second adapter counterpart 350, the reaction force applied by the inclined surface of the channel wall 3542 on the inclined surface 3220 has a direction towards the second adapter counterpart 350. In response to the reaction force from the inclined surface of the channel wall 3542, the housing 3212 is displaced in the direction of the reaction force, namely, a direction towards the second adapter counterpart 350. In some embodiments, for example, the displacement is the alignment relationship-obtaining displacement, and includes displacement along a lateral axis, rotation about the longitudinal axis, rotation about the lateral axis, rotation about the vertical axis, or a combination thereof. The alignment relationship-obtaining displacement is effectible due to the ball joint assembly 4302 of the end effector 3210.

In response to the alignment relationship-obtaining displacement of the housing 3212, the object manipulator 101 becomes disposed in the actuation-ready position, wherein the housing 3212 is received between the channel walls 3542 and disposed in alignment with the second adapter counterpart 350, and the first adapter counterpart 302 and the second adapter counterpart 350 are disposed in alignment.

In some embodiments, for example, while the housing 3212 is disposed in a guiding-effective relationship with the channel 354, the alignment relationship-obtaining displacement of the housing 3212 relative to the second adapter connection counterpart 350, is effectuated in response to urging by the robot arm 110.

As depicted in FIG. 46, the housing 3212 is pivoted to the left, relative to the crossbar 3204. As depicted in FIG. 47, relative to FIG. 46, the housing 3212 is pivoted further to the left, relative to the crossbar 3204.

While the housing 3212 is received between the channel walls 3542, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 3214.

In some embodiments, for example, while the towing vehicle 13 is releasably coupled to the trailer 12 and the towing vehicle 13 and the trailer 12 are misaligned, the housing 3212 and the actuator 3214 are aligned relative to the first adapter counterpart 302, via the ball joint assembly 4302, in the manner as described herein, to couple the actuator 3214 with the first adapter counterpart 302 for decoupling the first adapter counterpart 302 from the second adapter counterpart 350.

FIG. 48 and FIG. 49 depict an alternate embodiment of the guide 352, which is defined by two guide beams 4830. . As depicted, the second adapter counterpart 350 is mounted to the surface 11 of the trailer 12, with the electrical ports 3080, fluid ports 3100, and guide ports 3120 oriented in a downward direction, and the second adapter counterpart 350 is further disposed between two guide beams 4830 that are mounted to the surface 11 of the trailer 12. As depicted, each guide beam 4830, independently, defines an inclined surface 4832, and the second adapter counterpart 350 is disposed between the inclined surfaces 4832.

Similar to the inclined surfaces 3220 of the side walls 3218 and the inclined surfaces of the channel walls 3542, as depicted in FIG. 48 and FIG. 49, the inclined surfaces 3220 of the side walls 3218 incline away from the center of the housing 3212, and the inclined surfaces 4832 of the guide beams 4830 are inclined towards the female adapter counterpart 350. In some embodiments, for example, the inclined surfaces 3220 of the side walls 3218 and the inclined surfaces 4832 of the guide beams 4830 are co-operatively configured to align the housing 3212 and the second adapter counterpart 350, for example, along a vertical axis, to effect, for example, the releasable coupling of the first adapter counterpart 302 and the second adapter counterpart 350. In some embodiments, for example, the inclined surfaces 3220 of the side walls 3218 and the inclined surfaces 4832 of the guide beams 4830 are co-operatively configured to align the first adapter counterpart 302 and the second adapter counterpart 350, for example, along a vertical axis, to effect the releasable coupling of the first adapter counterpart 302 and the second adapter counterpart 350. In some embodiments, for example, the inclined surfaces 3220 of the side walls 3218 and the inclined surfaces 4832 of the guide beams 4830 are co-operatively configured to center the housing 3212 and the second adapter counterpart 350 to effect, for example, the releasable coupling of the first adapter counterpart 302 and the second adapter counterpart 350. In some embodiments, for example, the inclined surfaces 3220 of the side walls 3218 and the inclined surfaces 4832 of the guide beams 4830 are co-operatively configured to center the first adapter counterpart 302 and the second adapter counterpart 350 to effect, for example, the releasable coupling of the first adapter counterpart 302 and the second adapter counterpart 350.

In some embodiments, for example, the towing vehicle 13 and the trailer 12 are disposed in alignment. In such embodiments, for example, to couple the first adapter counterpart 302 and the second adapter counterpart 350, the detector 104 detects a signal for the apparatus 3200 to initiate the coupling process, for example, a signal provided by an operator of the towing vehicle 13, or a signal representative of the coupling of the towing vehicle 13 and the trailer 12, or a signal representative of an absence of coupling between the first adapter counterpart 302 and the second adapter counterpart 350. While the object manipulator 101 is disposed in the actuation-ineffective position and releasably coupled with the first adapter counterpart 302 via the housing 3212, wherein the first adapter counterpart 302 and the second adapter counterpart 350 are co-operatively disposed in the misaligned relationship, the controller 102 sends a control command to the actuator assembly 106 to pivot the robot arm 110, via the base 3202, towards the trailer 12, until the outer surface 32120 of the housing 3212 engages the surface 11 of the trailer 12 that is disposed between the guide beams 4830. The detector 104 detects that the outer surface 32120 of the housing 3210 is engaged to the surface 11 disposed between the guide beams 4830. In response to detection that the outer surface 32120 is engaged to the surface 11 disposed between the guide beams 4830, the controller 102 sends a control command to the actuator assembly 106 to stop further displacement of the object manipulator 101. At this point, the object manipulator 101 is disposed in the actuation-ready position.

In some embodiments, for example, in response to disposition of the object manipulator 101 in the actuation-ready position, the housing 3212 is disposed between the guide beams 4830, and the first adapter counterpart 302 is disposed below the second adapter counterpart 350. In some embodiments, for example, while the object manipulator 101 is disposed in the actuation-ready position, the first adapter counterpart 302 and the second adapter counterpart 350 are disposed in alignment for effecting releasable coupling of the first adapter counterpart 302 and the second adapter counterpart 350 for establishing connection between the first adapter counterpart 302 and the second adapter counterpart 350. In some embodiments, for example, the first adapter counterpart 302 and the second adapter counterpart 350 are disposed in alignment along the axis 3600. In some embodiments, for example, the axis 3600 is parallel to a vertical axis.

At this point, the controller 102 sends a control command to the actuator 3214 to displace upwardly for urging connection of the first adapter counterpart 302 and the second adapter counterpart 350. In response to vertical displacement of the first adapter counterpart 302 towards the second adapter counterpart 350 by the actuator 3214, the guide pins 312 of the first adapter counterpart 302 are received into the guide ports 3120 of the second adapter counterpart 350 to guide the displacement of the first adapter counterpart 302 towards the second adapter counterpart 350. In response to further vertical displacement of the first adapter counterpart 302 towards the second adapter counterpart 350, the electrical connectors 308 become disposed in the electrical ports 3080, and the fluid connectors 310 become disposed in the fluid ports 3100, as depicted in FIG. 35 and FIG. 37, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the actuator 3214 to decouple from the first adapter counterpart 302, and the controller 102 activates the actuator assembly 106 to retract the actuator 3214 downward such that the actuator 3214 is displaced towards the housing 3212. The retraction of the actuator 3214 is with effect that the actuator 3214 is received in the housing 3212. At this point, as depicted in FIG. 36, the controller 102 activates the actuator assembly 106 to pivot the robot arm 110, via the base 3202, away from the trailer 12, such that the object manipulator 101 is disposed in the actuation-ineffective position, outside of a swing radius 5000 of the trailer 12.

In some embodiments, for example, the detector 104 detects a signal representative of the releasable coupling of the first adapter counterpart 302 and the second adapter counterpart 350, and the controller 102 stops the displacement of the actuator 3214 towards the second adapter counterpart 350. Then, the controller 102 activates the linear actuator 242 to decouple the actuator 3214 from the first adapter counterpart 302, and the controller 102 activates the actuator assembly 106 to retract the actuator 3214 and displace the object manipulator 101 to the actuation-ineffective position and outside of the swing radius 5000 of the trailer 12.

In some embodiments, for example, after the first adapter counterpart 302 and the second adapter counterpart 350 are releasably coupled, the actuator 3214 is retracted and the object manipulator 101 is displaced to the actuation-ineffective position and outside of the swing radius 5000 of the trailer 1, the trailer 12 can be towed by the towing vehicle 13. In some embodiments, for example, while the towing vehicle 13 and the trailer 12 are in a truck yard, the fifth wheel lifting boom 2504 is actuated, for example, by the controller 102, to raise the trailer 12, as depicted in FIG. 30 and FIG. 31, for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350, the detector 104 detects a signal for the apparatus 3200 to initiate the decoupling process, for example, a signal provided by an operator of the towing vehicle 13, or a signal representative of the coupling of the towing vehicle 13 and the trailer 12, or a signal representative of the coupling between the first adapter counterpart 302 and the second adapter counterpart 350. The robot arm 110 is pivoted to transition the object manipulator 101 from the actuation-ineffective position to the actuation-ready position, wherein the actuator 3214 is aligned with the first adapter counterpart 302, which is coupled to the second adapter counterpart 350. The controller 102 sends a control command to the actuator 3214 to displace the actuator 3214 towards the first adapter counterpart 302, such that the guide pins 316 of the second connector counterpart 314 are inserted into the receiving ports 236 of the first connector counterpart 232, thereby actuating the spring-loaded latch, with effect that the actuator 3214 is coupled to the first adapter counterpart 302. In some embodiments, for example, the displacement of the actuator 3214, relative to the first adapter counterpart 302, is guided by the prongs 240 of the actuator 3214 and the guide ports 322 of the first adapter counterpart 302. Then, the controller 102 sends a control command to the actuator 3214 to displace the actuator 3214 away from the second adapter counterpart 350 to displace the first adapter counterpart 302 away from the second adapter counterpart 350, with effect that the operable communication between the first adapter counterpart 302 and the second adapter counterpart 350 is defeated, and with further effect that the first adapter counterpart 302 is received in the housing 3212. At this point, the controller 102 sends a control command to the actuator assembly 106 to transition the object manipulator 101 to the actuation-ineffective position, outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, while the towing vehicle 13 is releasably coupled to the trailer 12 the towing vehicle 13 and the trailer 12 are misaligned.

In such embodiments, for example, in response to displacement of the object manipulator 101 towards the trailer 12 from the actuation-ineffective position to the actuation-ready position, due to the misalignment of the towing vehicle 13 and the trailer 12, the displacement of the object manipulator 101 towards the trailer 12 is with effect that one of the side walls 3218 of the housing 3212 becomes disposed proximate to, or becomes disposed in engagement with, a corresponding inclined surface 4832 of one of the guide beams 4830 instead of the housing 3212 being received between the inclined surfaces 4832 of the guide beams 4830. In some embodiments, for example, while the housing 3212 becomes disposed proximate to, or becomes disposed in engagement with, the guide 352, for example, one of the guide beams 4830, the housing 3212 is disposed in the guiding-effective relationship with the guide 352.

In some embodiments, for example, while the housing 3212 is disposed in engagement with the guide 352, for example, one of the guide beams 4830, a surface configuration counterpart of the housing 3212 is disposed in engagement with a second surface counterpart of the guide 352. In some embodiments, for example, the surface configuration counterpart of the housing 3212 is defined by a surface of the housing 3212, for example, by the inclined surfaces 3220 of the side walls 3218. In some embodiments, for example, the surface configuration counterpart of the guide 352 is defined by an inclined surface 4832 of a guide beam 4830.

In response to further displacement of the object manipulator 101 towards the trailer 12, the inclined surface 3220 of the side wall 3218 applies a force on the inclined surface 4832 of the guide beam 4830, and the inclined surface 4832 of the guide beam 4830 applies a reaction force to the inclined surface 3220. Due to the inclination of the inclined surface 3220 of the side wall 3218 that are inclined away from the center of the housing 3212, and the inclination of the inclined surface 4832 of the guide beam 4830 that are inclined towards the second adapter counterpart 350, the reaction force applied by the inclined surface 4832 of the guide beam 4830 on the inclined surface 3220 has a direction towards the second adapter counterpart 350. In response to the reaction force from the inclined surface 4832 of the guide beam 4830, the housing 3212 is displaced in the direction of the reaction force, namely, a direction towards the second adapter counterpart 350. In some embodiments, for example, the displacement is an alignment relationship-obtaining displacement of the housing 3212, relative to the second adapter counterpart 350. In some embodiments, for example, the displacement is guidable, by the guide 352, for example, the guide beams 4830. In some embodiments, for example, the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the displacement includes vertical displacement, horizontal displacement along a lateral axis, displacement along a longitudinal axis, rotation about the longitudinal axis, rotation about the lateral axis, rotation about the vertical axis, or a combination thereof. The alignment relationship-obtaining displacement is effectible due to the spring assembly 3222 and the spring assembly 3228 of the end effector 3210. In some embodiments, for example, the first surface configuration counterpart and the housing 3212 are co-operatively configured such that guiding of the alignment relationship-obtaining displacement of the housing 3212 is effectible by co-operation between the first surface configuration counterpart and the second surface configuration counterpart defined by the guide beams 4830.

In response to the alignment relationship-obtaining displacement of the housing 3212, the object manipulator 101 becomes disposed in the actuation-ready position, wherein the housing 3212 is received between the guide beams 4830, the housing 3212 is disposed in engagement with the surface 17, and the first adapter counterpart 302 and the second adapter counterpart 350 are disposed in alignment. In some embodiments, for example, the first adapter counterpart 302 and the second adapter counterpart 350 are disposed in alignment along the axis 3600. In some embodiments, for example, the axis 3600 is parallel to a vertical axis.

In some embodiments, for example, while the housing 3212 is disposed in a guiding-effective relationship with the guide beam 4830, the alignment relationship-obtaining displacement of the housing 3212 relative to the second adapter connection counterpart 350, is effectuated in response to urging by the robot arm 110.

While the housing 3212 is received between the guide beams 4830, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 3214.

In some embodiments, for example, the first adapter counterpart 302 and the second adapter counterpart 350 are co-operatively configured such that, in response to emplacement of the first adapter counterpart 302 and the second adapter counterpart 350 in the alignment relationship, the first adapter counterpart 302 and the second adapter counterpart 350 become connected. In some embodiments, for example, the connection, obtained in response to the emplacement of the first adapter counterpart 302 and the second adapter counterpart 350 in the alignment relationship, is obtained autonomously.

In some embodiments for example, the actuator 3214, the first adapter counterpart 302, and the second adapter counterpart 350 are co-operatively configured such that, in response to emplacement of the first adapter counterpart 302 and the second adapter counterpart 350 in the alignment relationship, the actuator 3214 urges connection of the first adapter counterpart 302 and the second adapter counterpart 350. In some embodiments for example, the connection is obtained autonomously.

While the first adapter counterpart 302 and the second adapter counterpart 350 are disposed alignment, in response to further displacement of the first adapter counterpart 302 towards the second adapter counterpart 350, for example, via the actuator 3214, the guide pins 312 of the first adapter counterpart 302 are received into the guide ports 3120 of the second adapter counterpart 350 to guide further displacement of the first adapter counterpart 302 towards the second adapter counterpart 350, such that the electrical connectors 308 are received in the electrical ports 3080, and the fluid connectors 310 are received in the fluid ports 3100, which effects electrical communication between the trailer communicator-defined electrical conductor 1204 and the towing vehicle communicator-defined electrical conductor 1304, and effects fluid communication between the trailer communicator-defined fluid conductor 1202 and the towing vehicle communicator-defined fluid conductor 1302. This effects establishment of electrical communication between the electrical source of the towing vehicle 13 and the electrical system of the trailer 12, and establishment of fluid communication between the pneumatic air source of the towing vehicle 13 and the pneumatic air system of the trailer 12.

At this point, the controller 102 activates the actuator 3214 to decouple from the first adapter counterpart 302 and retract into the housing 3212, and the controller 102 activates the actuator assembly 106 to pivot the robot arm 110 to transition the object manipulator 101 to the actuation-ineffective position. In some embodiments, for example, the trailer 12 is towable by the towing vehicle 13. In some embodiments, for example, the fifth wheel lifting boom 2504 is actuated to raise the trailer 12 for displacement of the trailer 12 by the towing vehicle 13 about the yard.

In some embodiments, for example, the emplacement of the first adapter counterpart 302 and the second adapter counterpart 350 in the alignment relationship is obtained while the fifth wheel 15 is coupled to the fifth wheel guiding counterpart of the trailer (e.g. the kingpin), such that a fifth wheel coupling relationship is established.

To decouple the first adapter counterpart 302 from the second adapter counterpart 350 while the towing vehicle 13 and the trailer 12 are misaligned, the detector 104 detects a signal for the apparatus 100 to initiate the decoupling process. The controller 102 sends a control command to the actuator assembly 106 to pivot the robot arm 110 to transition the object manipulator 101 to the actuation-ready position. The guide beams 4830 and the side walls 3218 are co-operatively configured to effect alignment relationship-obtaining displacement of the housing 3212 to dispose the housing 3212 between the guide beams 4830 and align the actuator 3214 and the first adapter counterpart 302 (which is coupled to the second adapter counterpart 350). Then, the controller 102 sends a control command to the actuator 3214 to displace the actuator 3214 towards the first adapter counterpart 302. In response to further displacement of the actuator 3214 towards the first adapter counterpart 302, the guide pin 234 of the first connector counterpart 232 is inserted into the receiving port 318 of the second connector counterpart 314, and the guide pin 316 of the second connector counterpart 314 is inserted into the receiving port 234 of the first connector counterpart 232, with effect that the actuator 3214 is coupled to the first adapter counterpart 302. In some embodiments, for example, the displacement of the actuator 3214, relative to the first adapter counterpart 302, is guided by the prongs 240 of the actuator 3214 and the guide ports 322 of the first adapter counterpart 302. Then, the controller 102 sends a control command to the actuator 3214 to displace the actuator 3214 away from the second adapter counterpart 350 to displace the first adapter counterpart 302 away from the second adapter counterpart 350, with effect that the operable communication between the first adapter counterpart 302 and the second adapter counterpart 350 is defeated, and with further effect that first adapter counterpart 302 is received in the housing 3212. At this point, the controller 102 sends a control command to the actuator assembly 106 to pivot the robot arm 110 to transition the object manipulator 101 to the actuation-ineffective position, outside of the swing radius 5000 of the trailer 12. At this point, in some embodiments, for example, the connection between the fifth wheel coupling 15 and the kingpin is defeated, such that the towing vehicle 13 is decoupled from the trailer 12, and the towing vehicle 13 can be operated to displace away from the trailer 12.

In some embodiments, for example, a kit for modifying a towing vehicle 13 and a trailer 12 towing vehicle adaptor components and trailer adapter components. The towing vehicle adaptor components includes a towing vehicle-defined connection counterpart, for example, the first adapter counterpart 302, and a fixture, for example, the housing 3212, configured for releasably coupling with the towing vehicle-defined connection counterpart. The trailer adaptor components include a trailer-defined connection counterpart, for example, the second adapter counterpart 350, a guide, for example, the guide 352.

While: (i) the towing vehicle adaptor components are installed within a towing vehicle, with effect that a modified towing vehicle is established, such that the modified towing vehicle includes the towing vehicle-defined connection counterpart and the fixture, and (ii) the trailer adaptor components are installed within a trailer with effect that a modified trailer is established, such that the modified trailer includes the trailer-defined connection counterpart and the guide, the towing vehicle-defined connection counterpart is connectible to the trailer-defined connection counterpart, for example, as described with respect to the apparatuses disclosed herein.

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described for execution by a controller (or processor) is within the scope of a person of ordinary skill in the art having regard to the present disclosure. Machine readable code executable by one or more processors of one or more respective devices to perform the above-described method may be stored in a machine readable medium such as the memory of the data manager. The terms “software” and “firmware” are interchangeable within the present disclosure and comprise any computer program stored in memory for execution by a processor, comprising RAM memory, ROM memory, erasable programmable ROM (EPROM) memory, electrically EPROM (EEPROM) memory, and non-volatile RAM (NVRAM) memory. The above memory types are example only, and are thus not limiting as to the types of memory usable for storage of a computer program.

All values and sub-ranges within disclosed ranges are also disclosed. Also, although the systems, devices and processes disclosed and shown herein may comprise a specific plurality of elements/components, the systems, devices and assemblies may be modified to comprise additional or fewer of such elements/components. For example, although any of the elements/components disclosed may be referenced as being singular, the embodiments disclosed herein may be modified to comprise a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a data manager) to execute examples of the methods disclosed herein.

The term “processor” may comprise any programmable system comprising systems using micro- or nano-processors/controllers, reduced instruction set circuits (RISC), application specific integrated circuits (ASICs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

What is claimed is:

1. A towing vehicle, comprising:
a towing vehicle-defined connection counterpart; and
a fixture configured for releasably coupling with the towing vehicle-defined connection counterpart;
wherein:
the towing vehicle-defined connection counterpart is configured for connection to a trailer-defined connection counterpart of a trailer, the trailer further including a guide; and
the towing vehicle is configured to co-operate with trailer such that:
while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide:
an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

2. .The towing vehicle as claimed in claim 1;
the towing vehicle-defined connection counterpart and the trailer-defined connection counterpart are co-operatively configured such that, in response to emplacement of the towing vehicle-defined connection counterpart and the trailer-defined connection counterpart in the alignment relationship, the towing vehicle-defined connection counterpart and the trailer-defined connection counterpart become connected.

3. The towing vehicle as claimed in claim 2;
wherein:
the connection, obtained in response to the emplacement of the towing vehicle-defined connection counterpart and the trailer-defined connection counterpart in the alignment relationship, is obtained autonomously.

4. The towing vehicle as claimed in claim 1;
further comprising:
a first surface configuration counterpart;
wherein:
the first surface configuration counterpart and the fixture are co-operatively configured such that guiding of the alignment relationship-obtaining displacement of the fixture is effectible by co-operation between the first surface configuration counterpart and a second surface configuration counterpart defined by the guide of the trailer.

5. The towing vehicle as claimed in claim 1;
further comprising:
an object manipulator including:
a robot arm;
an end effector coupled to the robot arm;
wherein:
the coupling of the end effector to the robot arm is with effect that the end effector is displaceable relative to the robot arm, such that the coupling relationship between the end effector and the robot arm is a relative movement-permissive coupling relationship;
wherein:
the fixture is coupled to the end effector; and
the fixture, the end effector, and the robot arm are co-operatively configured such that:
the displaceability of the fixture, relative to the robot arm, is effectuated via the displaceability of the end effector relative to the robot arm; and
while the fixture is disposed in a guiding-effective relationship with the guide, the alignment relationship-obtaining displacement of the fixture, relative to the trailer-defined connection counterpart, is effectuated in response to urging by the robot arm.

6. The towing vehicle as claimed in claim 5;
wherein:
the object manipulator 101 further includes an actuator mounted to the end effector; and
the actuator, the towing vehicle-defined connection counterpart, and the trailer-defined connection counterpart are co-operatively configured such that, in response to emplacement of the towing vehicle-defined connection counterpart and the trailer-defined connection counterpart in the alignment relationship, the actuator urges connection of the towing vehicle-defined connection counterpart with the trailer-defined connection counterpart.

7. The towing vehicle as claimed in claim 6;
wherein:
the connection is obtained autonomously.

8. The towing vehicle as claimed in claim 5;
wherein:
the end effector defines a first surface configuration counterpart; and
the first surface configuration counterpart and the fixture are co-operatively configured such that guiding of the alignment relationship-obtaining displacement of the fixture is effectible by co-operation between the first surface configuration counterpart and a second surface configuration counterpart defined by the guide of the trailer.

9. The towing vehicle as claimed in claim 1;
wherein:
the connection is with effect that an electrical communication is established between the towing vehicle and the trailer for actuating a vehicular operation.

10. The towing vehicle as claimed in claim 1;
wherein:
the connection is with effect that a fluid pressure communication is established between the towing vehicle and the trailer for actuating a vehicular operation.

11. The towing vehicle as claimed in claim 1;
wherein:
the connection is with effect that communication is established between the towing vehicle and the trailer for actuating a vehicular operation.

12. The towing vehicle as claimed in claim 1;
further comprising:
a fifth wheel;
wherein:
the fifth wheel is configured for slidably receiving a fifth wheel guiding counterpart of the trailer such that a fifth wheel coupling relationship is established; and
the emplacement of the towing vehicle-defined connection counterpart and the trailer-defined connection counterpart in the alignment relationship is obtained while the fifth wheel coupling relationship is established.

13. A trailer comprising:
a guide; and
a trailer-defined connection counterpart;
wherein:
the trailer-defined connection counterpart is configured for connection to a towing vehicle-defined connection counterpart of a towing vehicle, with effect that communication between the towing vehicle and the trailer is established for actuating a vehicular operation;
the towing vehicle further includes:
a fixture configured for releasably coupling with the towing vehicle-defined connection counterpart;
the towing vehicle is configured to co-operate with trailer such that:
the guide is configured for guiding displacement of the fixture relative to the frame; and
while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide:
an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

14. A kit for modifying a towing vehicle and a trailer, comprising:
towing vehicle adaptor components including:
a towing vehicle-defined connection counterpart; and
a fixture configured for releasably coupling with the towing vehicle-defined connection counterpart;
trailer adaptor components including:
a trailer-defined connection counterpart; and
a guide;
wherein:
while: (i) the towing vehicle adaptor components are installed within a towing vehicle, with effect that a modified towing vehicle is established, such that the modified towing vehicle includes the towing vehicle-defined connection counterpart and the fixture, and (ii) the trailer adaptor components are installed within a trailer with effect that a modified trailer is established, such that the modified trailer includes the trailer-defined connection counterpart and the guide:
the towing vehicle-defined connection counterpart is connectible to the trailer-defined connection counterpart; and
the modified towing vehicle and the modified trailer are configured to co-operate such that while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of alignment between the towing vehicle-defined connection counterpart and the trailer-defined connection counterpart, and (iii) the fixture is disposed in a guiding-effective relationship with the guide:
an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

15. A system comprising:
a towing vehicle including:
a towing vehicle-defined connection counterpart; and
a fixture configured for releasably coupling with the towing vehicle-defined connection counterpart;
a trailer including:
a trailer-defined connection counterpart; and
a guide;
wherein:
the towing vehicle-defined connection counterpart is connectible to the trailer-defined connection counterpart; and
the towing vehicle and the trailer are configured to co-operate such that while: (i) the towing vehicle-defined connection counterpart is coupled to the fixture, (ii) the towing vehicle-defined connection counterpart and the trailer-defined connection counterpart are co-operatively disposed in a misaligned relationship, wherein, in the misaligned relationship, there is an absence of connection between the towing vehicle-defined connection counterpart and the trailer-defined connection counterpart, and (iii) the fixture is disposed in a guiding-effective relationship with the guide:
an alignment relationship-obtaining displacement of the fixture, relative to the trailer-defined connection counterpart, is guidable, by the guide, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.
